(19) United States
(12) Patent Application Publication
(10) Pub. No.: US 2026/0168222 A1
(43) Pub. Date: Jun. 18, 2026

(54) UNIVERSAL INTERNAL WATERWAY PLATFORM SYSTEM FOR SINGLE HANDLE WATER FAUCETS

(71) Applicant: Xiamen Lota International Co., Ltd., Xiamen (CN)

(72) Inventors: Chuanbao Zhu, Xiamen (CN); Liming Ye, Xiamen, Fujian (CN); Qiang Huang, Xiamen (CN); Yan Zhang, Xiamen (CN); Yanyan Wang, Xiamen (CN)

(21) Appl. No.: 19/431,545

(22) Filed: Dec. 23, 2025

Related U.S. Application Data
(63) Continuation of application No. PCT/CN2024/101275, filed on Jun. 25, 2024.
(60) Provisional application No. 63/511,017, filed on Jun. 29, 2023.
(60) Provisional application No. 63/607,619, filed on Dec. 8, 2023.
(60) Provisional application No. 63/552,220, filed on Feb. 12, 2024.
(60) Provisional application No. 63/558,166, filed on Feb. 27, 2024.
(60) Provisional application No. 63/640,935, filed on May 1, 2024.

(30) Foreign Application Priority Data
Jun. 25, 2023 (CN) 202310752636.0
Dec. 4, 2023 (CN) 202311652533.3
Feb. 4, 2024 (CN) 202410160396.X
Feb. 26, 2024 (CN) 202410210868.8
Apr. 22, 2024 (CN) 202410486947.1

(51) Int. Cl. E03C 1/04; F16K 31/60

(52) U.S. Cl. CPC E03C 1/0404; E03C 1/04; E03C 1/0401; E03C 1/0403; E03C 1/0412; F16K 31/60; F16K 31/602; F16K 31/605

(57) ABSTRACT

This disclosure relates to a universal internal waterway platform system for installation within a wide variety of top-mounted, single handle water faucets. The universal internal waterway platform system is modularly designed and configured to ensure fast, accurate and easy installation in multiple connection configurations found across numerous types of single handle water faucets, including bathroom faucets or kitchen faucets. The universal waterway platform system comprises: (i) a valve body assembly, (ii) a water inlet and outlet group, (iii) an arrangement of tubes, namely a water discharge tube, a faucet discharge tube, a water discharge tube, and a water discharge tube, (iv) a mixed water connector, and (v) water group coupler. These components enable the universal internal waterway platform system to be installed in more than 80% of the single handle kitchen and bathroom faucets, regardless of their variances in component geometry and layout.

### CROSS-REFERENCE TO RELATED APPLICATIONS

This application claims the benefit of and priority to U.S. Provisional Patent Application Nos. 63/511,017, 63/607,619, 63/552,220, 63/558,166, 63/640,935 and Chinese Invention Patent Application Nos. 202310752636.0, 202311652533.3, 202410160396.X, 202410210868.8, 202410486947.1, all of which are incorporated herein by reference in their entireties for all purposes.

### TECHNICAL FIELD

This disclosure relates to a universal internal waterway platform system for installation within a wide variety of top-mounted, single handle water faucets. The universal internal waterway platform system is modularly designed and configured to ensure fast, accurate and easy installation in multiple connection configurations found across numerous types of single handle water faucets, including bathroom faucets and kitchen faucets.

### BACKGROUND

Numerous manufacturers have been supplying and selling top-mounted, single handle water faucets for kitchen and bathroom installations for years. These single handle water faucets can be found in both residential and commercial settings and as a result, have widely varying designs, layouts and functionality. The significant variability in the design, layout and functionality of the single handle water faucets, including the configuration and form factor of their faucet housings, results in major distinctions in the structural design and layout of the internal waterways that provide discharge water flow through the faucet from hot and cold water sources.

For example, a first type of single handle water faucet having a large housing with a tall base and main body, as well as an elongated spout, requires the design and installation of a first internal waterway that is substantially different than a second internal waterway designed and installed in a second type of single handle water faucet having a smaller housing with a shorter base and main body, along with a standard length spout. As another example, the first internal waterway of the exemplary first single handle water faucet is substantially different than a third internal waterway designed and installed in a third type of single handle water faucet having a medium-sized, yet wide housing with a wide base and main body, as well as a standard length spout. These examples illustrate the significant variability between structurally different single handle water faucets which necessitate structurally different internal waterway systems and their components, such as the water mixing valve. That significant variability is multiplied across the numerous companies and suppliers that make and sell a multitude of models and types of single handle water faucets for kitchen and bathroom installations.

The significant variability of models and types across the multitude of single handle water faucets causes manufacturers and engineers to spend a massive amount of time designing and developing a multitude of internal waterway systems for installation within those multitude of single handle water faucets. Once the design of the internal waterway systems is finalized, the internal waterway systems must still be manufactured and inventoried before installation in the specific single handle water faucet in the field by an installer. The costly and time-consuming steps of designing and manufacturing internal waterway systems are multiplied across the numerous models and types of single handle water faucets.

Installation of the properly designed and sized internal waterway systems within the specific single handle water faucet can be very time consuming and prone to error, whether that installation occurs in a factory or in the field (e.g., in a kitchen or bathroom). For example, installation in the field typically requires the usage of tools to connect the water delivery lines extending from the water source lines to the mixing valve within the faucet. Mishandling or misuse of the tools can result in inaccurate installation of the internal waterway within the single handle water faucet, thereby compromising its operation and long-term durability. Thus, the multitude of conventional single handle water faucets and internal waterways suffer from a number of shortcomings and limitations.

The present invention is intended to solve the shortcomings and limitations of conventional single handle water faucets and internal waterways. Features and advantages of the present invention are described in the following Detailed Description section and the accompanying Figures.

### SUMMARY OF THE INVENTION

This disclosure generally provides a top-mounted, single handle water faucet having a universal waterway platform system. The single handle water faucet includes: (i) a faucet housing, (ii) a valve body assembly, (iii) a water group coupler, and (iv) a mixed water connector. The faucet housing is coupled to a mounting shank that is configured to extend through a support surface. The valve body assembly has a mixing cartridge and a valve body housing, wherein a majority of the valve body assembly is positioned within the faucet housing. The valve body housing includes: (i) a cartridge receiving extent with a cartridge receiver that receives a majority of the mixing cartridge in a secured state, and (ii) a water group receiver with: (i) a first collection of securing structures, and (ii) a second collection of securing structures. The water group coupler is configured to be selectively positioned in one of: (i) the first collection of securing structures to secure a first water inlet and outlet group type to the valve body housing, or (ii) the second collection of securing structures to secure a second water inlet and outlet group type to the valve body housing. The mixed water connector including: (i) a first coupler secured to a mixed water tube of the first and second water inlet and outlet group types, and (ii) a second coupler secured a water discharge tube, and wherein the mixed water connector has an outer diameter do that is greater than 85% of an inner diameter di of the mounting shank.

The disclosure also provides a single handle water faucet having: (i) a faucet housing, (ii) a water discharge tube, (iii) a water inlet and outlet group, and (iv) a mixed water connector. The faucet housing is coupled to a mounting shank and has the water discharge tube extending therethrough. The water inlet and outlet group includes: (i) a first water inlet line, (ii) a second water inlet line, and (iii) a mixed water tube. The mixed water connector is positioned within the mounting shank and has: (i) a first coupler that is secured to the mixed water tube, (ii) a second coupler that is secured to the water discharge tube, (iii) a first external recess formed in a first side of the mixed water connector, and (iv) a second external recess formed in the opposed second side of the mixed water connector. Wherein an extent of the first water inlet line is positioned within the first external recess of the mixed water connector, and an extent of the second water inlet line is positioned within the second external recess of the mixed water connector. And wherein the arrangement of (i) the first coupler and the second coupler and (ii) the first and second water inlet lines define an outer periphery of the mixed water connector, and wherein said outer periphery is greater than 85% of an inner periphery of the mounting shank.

The disclosure also provides a single handle water faucet having: (i) a valve body assembly with a mixing cartridge and a valve body housing, and (ii) water group coupler. Said valve body housing includes: (i) a cartridge receiving extent including a cartridge receiver that receives a majority of the mixing cartridge, (ii) a water group receiver with: (i) a first collection of securing structures, and (ii) a second collection of securing structures, and (iii) a base wall positioned between the cartridge receiving extent and the water group receiver. The water group coupler designed to secure at least one water inlet line and a mixed water tube to the valve body housing, wherein the water group coupler is configured to be selectively positioned in one of either of: (i) the first collection of securing structures, and (ii) the second collection of securing structures.

The disclosure also provides a single handle water faucet with: (i) a faucet housing, (ii) a valve body housing, and (iii) a lock nut. The faucet housing includes an internally threaded extent and internal step. And the valve body housing has: (i) a cartridge receiving extent including: (i) a cartridge receiver that receives a majority of a mixing cartridge, and (ii) an annular band having a beveled lower edge and an upper edge, (ii) a water group receiver, and (iii) a base wall positioned between the cartridge receiving extent and the water group receiver. The lock nut includes an externally threaded extent that is cooperatively dimensioned with the internally threaded extent of the faucet housing. And wherein in a secured position, said lock nut is configured to apply a downwardly directed force on the upper edge of the annular band thereby causing the beveled lower edge to interact with the internal step of the faucet housing.

The disclosure also provides a single handle water faucet with: (i) a faucet housing with a base portion, (ii) a water discharge tube 10410 extending through the faucet housing, (iii) a water inlet and outlet group, and (iv) a mixed water connector. The water inlet and outlet group comprising: (i) a first water inlet line with a first coupler, (ii) a second water inlet line with a second coupler, and (iii) a mixed water tube. The mixed water connector having a first external recess formed in a first side of the mixed water connector, a second external recess formed in the opposed second side of the mixed water connector, and wherein an extent of the first water inlet line is configured to be positioned within the first external recess of the mixed water connector, and an extent of the second water inlet line is configured to be positioned within the second external recess of the mixed water connector. And wherein an arrangement of (i) the first coupler and the second coupler and (ii) the first and second water inlet lines define an outer diameter D_{eff} of the mixed water connector, and wherein said outer diameter D_{eff} is greater than 85% of an inner diameter D_{base} of the base portion of the faucet housing.

The disclosure also provides a single handle water faucet with: (i) a faucet housing having a lower mounting shelf with a lower surface and a base portion, (ii) a water inlet and outlet group with a mixed water tube, and (iii) a mixed water connector having an upper surface and a connector inlet port that lacks threads. And wherein in an installed position, the connector inlet port receives an extent of the mixed water tube when the upper surface of the mixed water connector is adjacent to a lower surface of the lower mounting shelf.

The disclosure also provides a single handle water faucet with: (i) a water inlet and outlet group, (ii) a valve body assembly, (iii) a water group coupler. The water inlet and outlet group comprising: a first water inlet line, a second water inlet line, and a mixed water tube. The valve body assembly having: (i) a mixing cartridge, and (ii) a valve body housing including: (a) a cartridge receiving extent with a cartridge receiver that receives a majority of the mixing cartridge, (b) a frontal mounting slots, and (c) a rear mounting slot. And wherein the water group coupler having: (i) a first clip configured to be inserted into the frontal mounting slots and interact with an extent of the first and second water inlet lines, and (ii) a second clip configured to be inserted into the rear mounting slot and interact with an extent of the mixed water tube.

Other features and advantages of the inventive top-mounted, single handle water faucet having a universal waterway platform system are further described in the following Detailed Description section and the accompanying Figures.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a perspective view of a faucet system in an installed state S_{I},

FIG. 2 is a side view of the faucet system of FIG. 1 in the installed state S_{I};

FIG. 3 is an exploded view of the faucet system of FIG. 1, and showing a first embodiment of a faucet housing and a first embodiment of a single handle universal platform faucet system;

FIG. 4 is an exploded view of the first embodiment of the single handle universal platform faucet system of FIG. 3, and including: (i) a first embodiment of a valve body housing that receives a first embodiment of a water group coupler, (ii) a first embodiment of a mixed water connector, and (iii) a first water inlet and outlet group type;

FIG. 5 is a first portion of the valve body housing of FIG. 4;

FIG. 6 is a second portion of the value body housing of FIG. 4;

FIG. 7 is a rear perspective view of the valve body housing of FIG. 4;

FIG. 8 is a front perspective view of the valve body housing of FIG. 4;

FIG. 9 is a front view of the valve body housing of FIGS. 7 and 8;

FIG. 10 is a side view of the valve body housing of FIGS. 7 and 8;

FIG. 11 is a top view of the valve body housing of FIGS. 7 and 8;

FIG. 12 is a bottom view of the valve body housing of FIGS. 7 and 8;

FIG. 13 is a rear view of the valve body housing of FIGS. 7 and 8;

FIG. 14 is a zoomed-in view of a water group receiver of the valve body housing of FIG. 13, and wherein said water group receiver is designed to receive the water group coupler of FIG. 4 in a first position or a second position depending on the water inlet and outlet group type;

FIG. 15 is a perspective view of the valve body housing of FIGS. 7 and 8, shown as a valve body assembly including the mixing cartridge and retaining nut of FIG. 3;

FIG. 16 is a zoomed-in view of the water group receiver of FIG. 15;

FIG. 17 is a bottom perspective view of the valve body housing of FIGS. 7 and 8;

FIG. 18 is a zoomed-in view of the water group receiver of FIG. 17;

FIG. 19 is a rear view of the valve body housing of FIGS. 7 and 8;

FIG. 20 is a cross-sectional view of the valve body housing taken along line 20-20 of FIG. 19;

FIG. 21 is a zoomed-in view of the water group receiver of FIG. 20;

FIG. 22 is a perspective view of a first embodiment of the first water inlet and outlet group type and a portion of the mixed water connector;

FIG. 23 is a perspective view of a second embodiment of the first water inlet and outlet group type and a portion of the mixed water connector;

FIG. 24 is a perspective view of a first embodiment of a second water inlet and outlet group type and a portion of the mixed water connector;

FIG. 25 is a perspective view of a second embodiment of the second water inlet and outlet group type and a portion of the mixed water connector;

FIG. 26 is a perspective view of the water group coupler of FIG. 4;

FIG. 27 is a top view of the water group coupler of FIG. 26;

FIG. 28 is a side view of the water group coupler of FIG. 26;

FIG. 29 is a front view of the water group coupler of FIG. 26;

FIG. 30 is a perspective view of both: (i) the valve body housing and the water group coupler of FIG. 4 and (ii) the first water inlet and outlet group type of FIGS. 22-23 in a first partially assembled state S_{PA}, wherein a first force has been applied to said first water inlet and outlet group type to cause an extent of said first water inlet and outlet group type to be positioned within the valve body housing;

FIG. 31 is a perspective view of the valve body housing, the first water inlet and outlet group type, and the water group coupler of FIG. 30 in a first assembled state S_{A}, wherein a second force has been applied to said water group coupler to secure the first water inlet and outlet group type to the valve body housing;

FIG. 32 is a rear view of the single handle universal platform faucet system of FIG. 31 in said first assembled state S_{A};

FIG. 33 is a zoomed-in view of the water group receiver, the first water inlet and outlet group type, and the water group coupler of FIG. 32;

FIG. 34 is a perspective view of the single handle universal platform faucet system of FIG. 31 in said first assembled state S_{A};

FIG. 35 is a zoomed-in view of the water group receiver, the first water inlet and outlet group type, and the water group coupler of FIG. 34;

FIG. 36 is a rear view of the single handle universal platform faucet system of FIG. 31 in said first assembled state S_{A};

FIG. 37 is a cross-sectional view of the single handle universal platform faucet system taken along line 37-37 of FIG. 36;

FIG. 38 is a zoomed-in view of the water group receiver, the first water inlet and outlet group type, and the water group coupler of FIG. 37;

FIG. 39 is a side view of the single handle universal platform faucet system of FIG. 31 in said first assembled state S_{A};

FIG. 40 is a cross-sectional view of the single handle universal platform faucet system of FIG. 39;

FIG. 41 is a front view of the single handle universal platform faucet system of FIG. 31 in said first assembled state S_{A};

FIG. 42 is a cross-sectional view of the single handle universal platform faucet system taken along line 42-42 of FIG. 41;

FIG. 43 is a perspective view of both: (i) the valve body housing and the water group coupler of FIG. 4 and (ii) the second water inlet and outlet group type of FIGS. 24-25 in a second partially assembled state S_{PA}, wherein a first force has been applied to said second water inlet and outlet group type to cause an extent of said second water inlet and outlet group type to be positioned within the valve body housing;

FIG. 44 is a perspective view of the valve body housing, the water group coupler, and the second water inlet and outlet group type of FIG. 43 in a second assembled state S_{A}, wherein a second force has been applied to said water group coupler to secure the second water inlet and outlet group type to the valve body housing;

FIG. 45 is a rear view of the single handle universal platform faucet system of FIG. 44 in said second assembled state S_{A};

FIG. 46 is a zoomed-in view of the water group receiver, the second water inlet and outlet group type, and the water group coupler of FIG. 45;

FIG. 47 is a perspective view of the single handle universal platform faucet system of FIG. 44 in said second assembled state S_{A};

FIG. 48 is a zoomed-in view of the water group receiver, the first water inlet and outlet group type, and the water group coupler of FIG. 47;

FIG. 49 is a rear view of the single handle universal platform faucet system of FIG. 44 in said second assembled state S_{A};

FIG. 50 is a cross-sectional view of the single handle universal platform faucet system taken along line 50-50 of FIG. 49;

FIG. 51 is a zoomed-in view of the water group receiver, the second water inlet and outlet group type, and the water group coupler of FIG. 50;

FIG. 52 is a side view of the single handle universal platform faucet system of FIG. 44 in said second assembled state S_{A};

FIG. 53 is a cross-sectional view of the single handle universal platform faucet system taken along line 53-53 of FIG. 52;

FIG. 54 is a front view of the single handle universal platform faucet system of FIG. 44 in said second assembled state S_{A};

FIG. 55 is a cross-sectional view of the single handle universal platform faucet system taken along line 55-55 of FIG. 54;

FIG. 56 is a cross-sectional view of the first water inlet and outlet group type, the water group coupler, and the valve body housing in the first assembled state S_{A} and taken along line 56-56 of FIG. 39 and showing the securement of the water inlet and outlet group within the valve body housing via the water group coupler;

FIG. 57 is a cross-sectional view of the second water inlet and outlet group type, the water group coupler, and the valve body housing in the second assembled state S_{A} and taken along line 57-57 of FIG. 52 and showing the securement of the water inlet and outlet group within the valve body housing via the water group coupler;

FIG. 58 is a perspective view of the first embodiment of the mixed water connector that couples a mixed water tube to a water discharge tube of FIGS. 3 and 4;

FIG. 59 is a perspective view of the mixed water connector of FIG. 58 in a disconnected state S_{D}, and wherein said mixed water connector includes a first portion and a second portion;

FIG. 60 is a rear perspective view of the first connector of the mixed water connector of FIGS. 58-59;

FIG. 61 is a front view of the faucet system of FIG. 1 in the installed state S_{I},

FIG. 62 is a cross-sectional view of the faucet system taken along line 62-62 of FIG. 61 and showing the single handle universal platform faucet system residing within the faucet housing;

FIG. 63 is a zoomed-in view of the mixed water connector residing within a shank of the faucet housing of FIG. 62;

FIG. 64 is a top view of the faucet system of FIG. 1 in the shipped state Sₛ;

FIG. 65 is a partial cross-sectional view of the faucet system taken along line 65-65 of FIG. 64 and showing the mixed water connector residing within a shank of the faucet housing;

FIG. 66 is a cross-sectional view of the mixed water connector and the water inlet and outlet group taken along line 66-66 of FIG. 61;

FIG. 67 is a bottom view of the mixed water connector and the first embodiment of a second water inlet and outlet group type;

FIG. 68 is a zoomed-in view of the interface of the faucet housing, mixing cartridge, valve body housing, retaining nut, and lock nut of the faucet system of FIG. 62;

FIG. 69 is a side view of the faucet system of FIG. 1 in the shipped state Sₛ;

FIG. 70 is a cross-sectional view of the faucet system taken along line 70-70 of FIG. 69;

FIG. 71 is a zoomed-in view of FIG. 70 showing the engagement of teeth of the valve body housing engaged with an extent of a main body of the faucet housing;

FIG. 72 is a partial cross-sectional view the first embodiment of the single handle universal platform faucet system disposed within a first alternative embodiment of a faucet housing in the installed state S_{I};

FIG. 73 is a partial cross-sectional view the first embodiment of the single handle universal platform faucet system disposed within a second alternative embodiment of a faucet housing in the installed state S_{I},

FIG. 74 is a perspective view of a second embodiment of a valve body housing;

FIG. 75 is a perspective view of a third embodiment of a valve body housing having a first material composition;

FIG. 76 is a perspective view of a third embodiment of a valve body housing having a second material composition;

FIG. 77 is a perspective view of a third embodiment of a valve body housing having a third material composition;

FIG. 78 is a perspective view of a fourth embodiment of a valve body housing;

FIG. 79 is a perspective view of a fifth embodiment of a valve body housing;

FIG. 80 is a perspective view of a sixth embodiment of a valve body housing;

FIG. 81 is a perspective view of a seventh embodiment of a valve body housing;

FIG. 82 is a perspective view of an eighth embodiment of a valve body housing;

FIG. 83 is an exploded view of the faucet system having a fifth embodiment of a single handle universal platform faucet system including: (i) the fifth embodiment of the valve body housing of FIG. 79 that receives the first embodiment of the water group coupler, (ii) the first embodiment of the mixed water connector, and (iii) the first water inlet and outlet group type;

FIG. 84 is a perspective view of the fifth embodiment of the single handle universal platform faucet system of FIG. 83, wherein a fifth embodiment of the valve body housing includes at least one base anti-rotation rib extending from the base;

FIG. 85 is side view of faucet system of FIG. 83 in the shipped state S_{S};

FIG. 86 is a cross-sectional view of the faucet system taken along line 86-86 of FIG. 85 and showing the interaction between the faucet housing and the fifth embodiment of the valve body housing;

FIG. 87 is a cross-sectional view of the faucet system taken along line 87-87 of FIG. 85 and showing the interaction between the faucet housing and the fifth embodiment of the valve body housing;

FIG. 88 is an exploded view of the faucet system having a sixth embodiment of a single handle universal platform faucet system including: (i) the sixth embodiment of the valve body housing of FIG. 80 that receives the first embodiment of the water group coupler, (ii) the first embodiment of the mixed water connector, and (iii) the first water inlet and outlet group type;

FIG. 89 is a perspective view of the sixth embodiment of valve body housing of FIGS. 80 and 88;

FIG. 90 is a top view of the faucet system of FIG. 88 in the shipped state S_{S};

FIG. 91 is a cross-sectional view of the faucet system taken along the line 91-91 of FIG. 90;

FIG. 92 is a zoomed-in view of a portion of the cross-section of the faucet system in FIG. 91 and showing the interaction between the faucet housing and the sixth embodiment of the valve body housing;

FIG. 93 is an exploded view of the faucet system having a seventh embodiment of a single handle universal platform faucet system that lacks a mixed water connector, but including: (i) the seventh embodiment of the valve body housing of FIG. 81 that receives a second embodiment of a water group coupler, and (ii) a third embodiment of a first water inlet and outlet group type;

FIG. 94 is a perspective view of the seventh embodiment of the valve body housing of FIGS. 81 and 93;

FIG. 95 is a zoomed-in view of an extent of the valve body housing of FIG. 94;

FIG. 96 is a top view of the faucet system of FIG. 93 in the shipped state S_{S};

FIG. 97 is a cross-sectional view of the faucet system taken along the line 97-97 of FIG. 96;

FIG. 98 is a zoomed-in view of a portion of the cross-section of the faucet system in FIG. 97 and showing the interaction between the faucet housing and the seventh embodiment of the valve body housing;

FIG. 99 is an exploded view of the faucet system having an eighth embodiment of a single handle universal platform faucet system that lacks a mixed water connector, but including: (i) the eighth embodiment of the valve body housing of FIG. 82 that receives the first embodiment of a water group coupler, and (ii) the third embodiment of the first water inlet and outlet group type;

FIG. 100 is a perspective view of the eighth embodiment of the valve body housing of FIG. 99;

FIG. 101 is a perspective view of the eighth embodiment of a single handle universal platform faucet system of FIG. 99;

FIG. 102 is a top view of the faucet system of FIG. 99 in the shipped state S_{S};

FIG. 103 is a cross-sectional view of the faucet system taken along the line 103-103 of FIG. 102;

FIG. 104 is a zoomed-in view of a portion of the cross-section of the faucet system of FIG. 103 and showing the interaction between the faucet housing and the eighth embodiment of the valve body housing;

FIG. 105 is a second embodiment of the mixed water connector;

FIG. 106 is a third embodiment of the mixed water connector;

FIG. 107 is a fourth embodiment of the mixed water connector;

FIG. 108 is a fifth embodiment of the mixed water connector;

FIG. 109 is a sixth embodiment of the mixed water connector;

FIG. 110 is a seventh embodiment of the mixed water connector;

FIG. 111 is an eighth embodiment of the mixed water connector;

FIG. 112 is a perspective view the second embodiment of the mixed water connector of FIG. 105;

FIG. 113 is a bottom view of the mixed water connector of FIG. 112;

FIG. 114 is a top view of the mixed water connector of FIG. 112;

FIG. 115 is a rear view of the mixed water connector of FIG. 112;

FIG. 116 a cross-sectional view of the mixed water connector taken along line 116-116 of FIG. 115;

FIG. 117 is a perspective view of the third embodiment of the mixed water connector of FIG. 106 showing the water flow connector, an adapter, and coupler clip;

FIG. 118 is a perspective view of the coupler clip of FIG. 117;

FIG. 119 a cross-sectional view of the third embodiment of the mixed water connector taken along line 119-119 of FIG. 117;

FIG. 120 a cross-sectional view of the third embodiment of the mixed water connector taken along line 120-120 of FIG. 117 and shown within a mounting shank of the faucet system;

FIG. 121 a cross-sectional view of the alternative mixed water connector taken along line 121-121 of FIG. 117 and shown with a faucet system that includes a mounting bolt;

FIG. 122 is a perspective view of the fourth embodiment of the mixed water connector of FIG. 107;

FIG. 123 is a side view of the mixed water connector of FIG. 122;

FIG. 124 is a cross-sectional view of the mixed water connector taken along line 123-123 of FIG. 123;

FIG. 125 is an exploded view of the faucet system having a ninth embodiment of a single handle universal platform faucet system including: (i) a ninth embodiment of the valve body housing that receives a third embodiment of a water group coupler, (ii) a ninth embodiment of a mixed water connector, and (iii) a third water inlet and outlet group type;

FIG. 126 is a perspective view of the ninth embodiment of the valve body housing of FIG. 125;

FIG. 127 is a side view of the valve body housing of FIG. 126;

FIG. 128 is a perspective cross-sectional view of the valve body housing taken along line 128-128 of FIG. 127;

FIG. 129 is a top view of the third embodiment of a water group coupler of FIG. 125;

FIG. 130 are end portions of an inlet line and an outlet tube contained in the third water inlet and outlet group type of FIG. 125;

FIG. 131 is an exploded view of the valve body housing, the water group coupler, the water inlet and outlet group, and the mixed water connector of FIG. 125;

FIG. 132 is an assembled view the valve body housing, the water group coupler, the water inlet and outlet group, and the mixed water connector of FIG. 131;

FIG. 133 is a side view of the faucet system of FIG. 125 in a shipped state S_{S};

FIG. 134 is a cross-sectional view of the faucet system taken along line 134-134 of FIG. 133;

FIG. 135 is a zoomed-in view of a portion of the cross-section of the faucet system of FIG. 134, and showing the securement of the water inlet and outlet group within the valve body housing via the water group coupler;

FIG. 136 is a cross-sectional view of the faucet system taken along line 136-136 of FIG. 133 and showing the position of the ninth embodiment of a single handle universal platform faucet system within the faucet housing;

FIG. 137 is a zoomed-in view of a portion of the cross-section of the faucet system of FIG. 136 and showing the securement of the water inlet and outlet group within the valve body housing via the water group coupler;

FIG. 138 is a front view of the faucet system of FIG. 125 in a shipped state S_{S};

FIG. 139 is a perspective cross-sectional view of the faucet system along line 139-139 of FIG. 138, shown without the mixed water connector and inlet tubes of the water inlet and outlet group;

FIG. 140 is a zoomed-in view of a portion of the cross-section of the faucet system of FIG. 139 and showing the positioning of the ends of the mixed water tube and outlet tube in relationship to an internal lower mounting shelf of the faucet housing;

FIG. 141 is a cross-sectional view of the faucet system taken along line 141-141 of FIG. 138 and further showing the positioning of the mixed water tube and outlet tube within a set of recesses formed in the inner shelf of the faucet housing;

FIG. 142 is a perspective view of the ninth embodiment of the mixed water connector of FIG. 125;

FIG. 143 is a top view of the mixed water connector of FIG. 142;

FIG. 144 is a front view of the faucet system of FIG. 125 in the shipped state S_{S};

FIG. 145 is a perspective cross-sectional view of the faucet system taken along line 145-145 of FIG. 144, shown without the inlet tubes of water inlet and outlet group;

FIG. 146 is a zoomed-in view of a portion of the faucet system of FIG. 145 and showing the positional relationship of the mixed water connector, inner shelf of the faucet housing, and an extent of the water inlet and outlet group;

FIG. 147 is a front view of the faucet system of FIG. 125 in a shipped state S_{S};

FIG. 148 is a cross-sectional view of the faucet system taken along line 148-148 of FIG. 147 and showing the positional relationship of the inner shelf of the faucet housing and an extent of the water inlet and outlet group;

FIG. 149 is a front view of the faucet system of FIG. 125 in an installed state S_{I}, FIG. 150 is a cross-sectional view of the faucet system taken along line 150-150 of FIG. 149;

FIG. 151 is a perspective view of the tenth embodiment of a valve body housing;

FIG. 152 is a perspective view of the eleventh embodiment of a valve body housing;

FIG. 153 is a perspective view of the twelfth embodiment of a valve body housing;

FIG. 154 is a perspective view of the thirteenth embodiment of a valve body housing;

FIG. 155 is a perspective view of the fourteenth embodiment of a valve body housing;

FIG. 156 is an exploded view of the faucet system having a tenth embodiment of a single handle universal platform faucet system including: (i) the tenth embodiment of the valve body housing of FIG. 151 that receives a fourth embodiment of a water group coupler, (ii) a tenth embodiment of a mixed water connector, and (iii) the third water inlet and outlet group type;

FIG. 157 is a top view of a fourth embodiment of a water group coupler configured for use with the tenth embodiment of the valve body housing shown in FIGS. 151 and 156, and wherein said water group coupler is in an uncoupled position;

FIG. 158 is a top view of the fourth embodiment of the water group coupler of FIG. 157 in a coupled position;

FIG. 159 is an exploded view of a portion of the tenth embodiment of a single handle universal platform faucet system of FIG. 156;

FIG. 160 is a front view of the faucet system of FIG. 156 in a shipped state S_{S};

FIG. 161 is a cross-sectional view of the faucet system taken along line 161-161 of FIG. 160;

FIG. 162 is a zoomed-in view of a portion of the cross-section of the faucet system of FIG. 161, and showing the securement of the water inlet and outlet group within the valve body housing via the water group coupler;

FIG. 163 is an exploded view of the faucet system having an eleventh embodiment of a single handle universal platform faucet system including: (i) the eleventh embodiment of the valve body housing of FIG. 152 that receives a fifth embodiment of a water group coupler, (ii) the tenth embodiment of the mixed water connector, and (iii) the third water inlet and outlet group type;

FIG. 164 is a side view of the faucet system of FIG. 163 in a shipped state S_{S};

FIG. 165 is a cross-sectional view of the faucet system taken along line 165-165 of FIG. 164;

FIG. 166 is a zoomed-in view of a portion of the cross-section of the faucet system of FIG. 165, and showing the securement of the water inlet and outlet group within the valve body housing via the water group coupler;

FIG. 167 is an exploded view of the faucet system having a twelfth embodiment of a single handle universal platform faucet system including: (i) the twelfth embodiment of the valve body housing of FIG. 153 that receives a sixth embodiment of a water group coupler, (ii) the tenth embodiment of the mixed water connector, and (iii) the third water inlet and outlet group type;

FIG. 168 is a side view of the faucet system of FIG. 167 in the shipped state S_{S};

FIG. 169 is a cross-sectional view of the faucet system taken along line 169-169 of FIG. 168;

FIG. 170 is a zoomed-in view of a portion of the cross-section of the faucet system of FIG. 168, and showing the securement of the water inlet and outlet group within the valve body housing via the water group coupler;

FIG. 171 is an exploded view of the faucet system having a thirteenth embodiment of a single handle universal platform faucet system including: (i) the thirteenth embodiment of the valve body housing of FIG. 154 that receives a seventh embodiment of a water group coupler, (ii) the eleventh embodiment of the mixed water connector, and (iii) the second water inlet and outlet group type;

FIG. 172 is a perspective view of the fifth embodiment of the valve body housing and the sixth embodiment of a water group coupler of FIGS. 154 and 171;

FIG. 173 is a top view of the thirteenth embodiment of the valve body housing that receives a sixth embodiment of a water group coupler and the third water inlet and outlet group type of FIG. 171;

FIG. 174 is a cross-sectional view of the valve body housing, water group coupler, and water inlet and outlet group taken at line 174-174 of FIG. 173, showing the securement of the water inlet and outlet group within the valve body housing via the water group coupler;

FIG. 175 is a side view of the faucet system of FIG. 171 in the shipped state S_{S};

FIG. 176 is a cross-sectional view of the faucet system taken along line 176-176 of FIG. 175;

FIG. 177 is a zoomed-in view of a portion of the cross-section of the faucet system of FIG. 176, and showing the securement of the water inlet and outlet group within the valve body housing via the water group coupler;

FIG. 178 is an exploded view of the faucet system having a fourteenth embodiment of a single handle universal platform faucet system that lacks a water group coupler and a mixed water connector, but includes the fourteenth embodiment of the valve body housing of FIG. 155 and a fourth water inlet and outlet group type;

FIG. 179 is a front view of the faucet system of FIG. 178 in the shipped state S_{S};

FIG. 180A-B is a cross-sectional view of the faucet system taken at line 180-180 of FIG. 179;

FIG. 181 is a perspective view of the tenth embodiment of a mixed water connector of FIGS. 156, 163 and 167;

FIG. 182 is a perspective view of a twelfth embodiment of a mixed water connector;

FIG. 183 is a perspective view of a thirteenth embodiment of a mixed water connector;

FIG. 184 is a perspective bottom view of the mixed water connector of FIG. 181;

FIG. 185 is a top view of the mixed water connector of FIGS. 181 and 184;

FIG. 186 is a cross-sectional view of the mixed water connector taken at line 186-186 of FIG. 185;

FIG. 187 is an exploded view of the faucet system having a fifteenth embodiment of a single handle universal platform faucet system including: (i) the ninth embodiment of the valve body housing of FIGS. 125-128 that receives the eighth embodiment of the water group coupler, (ii) the twelfth embodiment of the mixed water connector, and (iii) the third water inlet and outlet group type;

FIG. 188 is a front view of the faucet system of FIG. 187 in the shipped state S_{S};

FIG. 189 is a cross-sectional view of the faucet system taken along line 189-189 of FIG. 190;

FIG. 190 is a zoomed-in view of an extent of the twelfth embodiment of the mixed water connector FIG. 191 and showing the positional relationship of the mixed water connector, water inlet and outlet group, and faucet housing;

FIG. 191 is a cross-sectional view of the faucet system taken along line 191-191 of FIG. 188 and showing the mixed water connector, water inlet and outlet group, and faucet housing;

FIG. 192 is a perspective view of the twelfth embodiment of the mixed water connector of FIGS. 182 and 187;

FIG. 193 is a side view of the mixed water connector of FIGS. 182, 187, and 192;

FIG. 194 is a cross-sectional view of the mixed water connector taken along line 194-194 of FIG. 193;

FIG. 195 is an exploded view of the faucet system having a sixteenth embodiment of a single handle universal platform faucet system including: (i) the ninth embodiment of the valve body housing of FIGS. 125-128 that receives the third embodiment of the water group coupler, (ii) the thirteenth embodiment of the mixed water connector, and (iii) the third water inlet and outlet group type;

FIG. 196-197 are perspective views of a tube clip for the thirteenth embodiment of the mixed water connector of FIG. 195;

FIG. 198 is a perspective view of the thirteenth embodiment of the mixed water connector of FIG. 195;

FIG. 199 is a portion of a cross-sectional view of the faucet system taken along line 199-199 of FIG. 200 and showing how the tube clip retains the fifth water inlet and outlet group type within the thirteenth embodiment of the mixed water connector;

FIG. 200 is a front view of the faucet system of FIG. 195 in the shipped state S_{S};

FIG. 201 is a cross-sectional view of the faucet system of FIG. 200 taken along line 201-201 and showing the positional relationship of the valve body housing within the faucet housing; and

FIG. 202 is a zoomed-in view the cross-section of the faucet system of FIG. 201 and showing thirteenth embodiment of the mixed water connector in relation to the faucet housing and the support surface.

### DETAILED DESCRIPTION

While this disclosure includes several details and embodiments in many different forms, there are shown in the drawings and will herein be described in detail particular embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations, and several details are capable of being modified, all without departing from the scope of the disclosed methods and systems. For example, one or more of the following embodiments, in part or whole, may be combined consistent with the disclosed methods and systems. As such, one or more steps of assembly may be selectively omitted and/or combined consistent with the disclosed methods and systems. Accordingly, the drawings, flow charts and detailed description are to be regarded as illustrative in nature, not restrictive or limiting.

### I. Benefits of the Single Handle Faucet With Universal Waterway Platform

This disclosure relates to a top-mounted, single handle faucet system (10, 1010, 2010, 4010, 5010, 6010, 7010, 10010, 11010, 12010, 13010, 14010, 15010, 16010, 17010) with a universal internal waterway platform faucet system or a universal waterway platform system (90, 4090, 5090, 6090, 7090, 10090, 11090, 12090, 13090, 14090, 15090, 16090, 17090) that is designed and configured to facilitate fast, easy, and accurate installation within numerous types of top-mounted, single handle faucets having a variety of layouts and connection configurations. The universal waterway system is designed with modularity concepts to fit more than 80% of the top-mounted, single handle kitchen and lavatory faucets, regardless of variances in geometry. Therefore, while the universal waterway platform system is shown in the Figures as being installed within a lavatory or bathroom faucet system, it should be understood that the principles and components described herein can apply to other single handle faucet systems, including those used in kitchens, as well as commercial and industrial applications (e.g., utility water faucets with single handles). Likewise, while the Figures show a bathroom faucet housing with a curved spout shape, the inventive universal waterway platform system can be included or installed in faucet housings having various shapes and sizes including, but not limited to a linear or rectilinear spout.

One reason why the inventive universal waterway platform system can be accurately and efficiently installed within more than 80% of the single handle faucets is because the mixing cartridge is not directly secured to or does not come into direct contact with: (i) the main body of the faucet housing, (ii) the inlet lines, or (iii) the mixed water tube. Instead, structures (i)-(iii) are coupled to a separate and distinct component—namely, the valve body housing. This allows numerous types of mixing cartridges to be used in the universal waterway platform system across numerous types of single handle faucets. If necessary, only the valve body housing needs to be switched to allow the universal waterway platform system to be installed within different types of single handle faucets having different configurations. This modularity aspect provides numerous benefits to the inventive universal waterway platform system, including considerable manufacturing efficiencies; cost reductions in terms of both material costs and assembly times; improved supply chain flow and reduced disruptions thereto; accurate and efficient installation of the universal water platform in the various single handle faucet types; and increases reliability and operating life of the single handle faucet.

Another reason why the inventive universal waterway platform system can be accurate and efficiently installed in more than 80% of the single handle faucets is because, in most embodiments, the fluid connection between the mixed water discharge tube and the faucet outlet tube is via a mixed water connector that is positioned below a mid-height of the main body of the faucet housing. Specifically, the mixed water connector is configured to couple the mixed water outlet line and the faucet outlet water tube (that extends through the faucet spout for discharge from the spout) and the mixed water connector is positioned within the mounting shank, which is typically located within an extent of the countertop or support surface to which the single handle faucet is installed and secured to. This positional relationship between the mixed water connector and the remaining system helps ensure that the integrity of the faucet outlet water tube is not compromised (e.g., pinched, kinked or restricted) when the universal waterway platform system is installed in a faucet with a short main body and/or spout positioned near the countertop's mounting surface. Accordingly, the inventive universal waterway platform system can be used in faucets with spouts positioned almost anywhere along the length of the main body of the faucet.

Another reason why the inventive universal waterway platform system is so versatile is that it can accommodate different types or configurations of water inlet lines found in at least 80% of single handle faucets without the need for new or specialized parts. In particular, water inlet lines made from different materials (e.g., polyethylene of raised temperature resistance (PERT), cross-linked polyethylene (PEX), copper, nylon braided, or other materials that include polymers), inlet lines having different diameters (e.g., ½ inch or ⅜ inch), or inlet lines having different connectors (e.g., threaded, pluggable, or coupled together) can be easily coupled within the inventive universal platform system without the need to obtain different connectors or additional connector parts. The versatility of the inventive system reduces the installation burden on the manufacturer (and the installer in certain circumstances), by allowing the manufacturer to reduce the number of parts and components the manufacturer needs to procure, fabricate and stock, reduce the number of different SKUs for parts and components, and simplifies the faucet production and any after-sale servicing or maintenance.

Another significant benefit of the inventive universal waterway platform is that the internal couplers within the mixed water connector cannot become dislodged or separated after being installed and during normal use of the single handle faucet because they occupy substantially the entire diameter of the mounting shank. In this manner and as described below, the mounting shank abuts the mixed water connector and provides no space for it to become dislodged or separated and potentially leak water. Additionally, in certain embodiments, the effective outer diameter of the combination of the mixed water connector and the inlet tubes will be sustainably equal to the inner diameter of the mounting shank. These configurations increase the reliability of the faucet, reduce the unwanted vibration and noise (e.g., “chattering” of the inlet tubes), and minimize the possibility of incorrect installations.

Another benefit of the inventive universal waterway platform is that: (i) except for a lower extent of the inlet lines, the single handle universal platform faucet system is concealed within the faucet body and (ii) the fluid (e.g., water) that flows through the assemblies and system is isolated from the faucet housing until the water is dispensed from the outlet adapter of the faucet outlet tube. In other words, fluid (e.g., water) does not come into contact with the faucet housing 20. This design allows the faucet to achieve a simple, clean look, while increasing the durability of the faucet because the fluid does not come into contact with the housing until the water is dispensed from the outlet adapter of the faucet outlet tube that resides at the discharge end of the spout. An additional benefit of separating the fluid flow from the faucet housing is that the housing of the single handle faucet can be made from alternative materials and is not limited to solid brass for specific designs. This significantly reduces material prices and manufacturing costs, increases the available designs, and simplifies logistics and supply chain issues, and allows for the production of small quantities of unique designs or rapid production of large quantities of a single design of an inventive single handle faucet featuring the novel internal waterway platform system.

When installed in a single handle water faucet, the inventive universal waterway platform system offers a modularized water flow pathway or waterway with standardized connections that are non-metallic (e.g. flexible PERT or other material that is safe for drinkable water). The non-metallic waterway enables the inventive universal waterway platform to comply with global certifications, including those focusing on lower lead and brass levels in drinking water being contemplated for future implementation in the European Union. Furthermore, the inventive universal waterway platform's modularized solution allows for the use of different faucet housings, mixing cartridges, valve body housings, water discharge tubes, mixed water connectors, and the like, which provides the inventive universal waterway platform with immense utility and value when installed in a multitude of single handle water faucets. Thus, this application discloses several embodiments of the inventive universal waterway platform where its components can be interchanged with one another to meet a customer's desired configuration without the need to design new components, build new tools, and adjust the supply chain to satisfy the customer's design and performance specifications. Thus, the inventive universal waterway platform system significantly reduces the engineering time and tooling investment that would be required for multiple new waterway designs, while the inventive system can be adjusted to existing faucet housings without costly and time-consuming revisions or modifications.

A further benefit of the inventive universal waterway platform system is that it can be manufactured separately and shipped independently from the faucet housing, which increase the value and utility of the inventive system. This separability provides manufacturing efficiencies, reduces cost and supply chain disruptions, and allows for manufacturing specialization, such as manufacturing of the waterway platform system in a first factory located in a first country, while manufacturing the actual single handle faucet in a second factory located in a second country).

### II. First Type of Universal Waterway Platform System

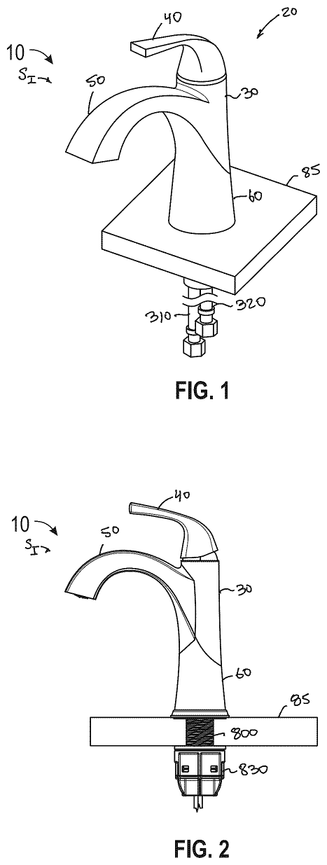

FIGS. 1-4 show a single handle faucet system 10 that includes: (i) a faucet housing 20 and (ii) a universal internal waterway platform faucet system or a universal waterway platform (“SHUP”) system 90. The SHUP system 90 is comprised of: (i) a valve body assembly 110, (ii) a water inlet and outlet group 300, (iii) a water discharge tube, faucet discharge tube, water discharge tube, or water discharge tube 410, (iv) a mixed water connector 500, and (v) water group coupler 600. This multi-component configuration of the SHUP system 90 provides the above-described capabilities of said system 90, including the ability to use said system 90 in more than 80% of the single handle faucets.

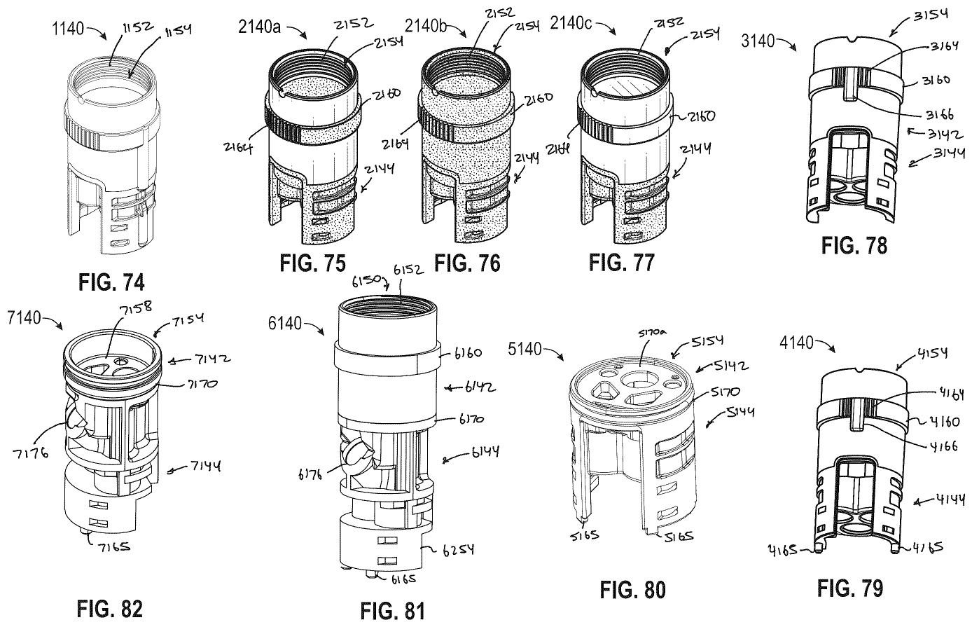

This widespread use of the SHUP system 90 is primarily possible due to the configuration of the valve body assembly 110, which includes: (i) the valve body housing 140, (ii) the mixing cartridge 130, and (iii) the retaining nut 120. In particular, the valve body housing 140 of the valve body assembly 110 is designed to be positioned between an extent of the mixing cartridge 130 and the faucet housing 20 and is configured to: (i) receive different mixing cartridges 130 (e.g., 25 mm-35 mm), (ii) be coupled to different water inlet and outlet group types 300 (e.g., shown as group types 340, 370), and (iii) be positioned in different faucet housings 20. Further, as shown in FIGS. 74-82, the valve body housing 1140, 2140, 3140, 4140, 5140, 6140, 7140 may also have different configurations. Additional details about the valve body housing 140 are disclosed in detail below.

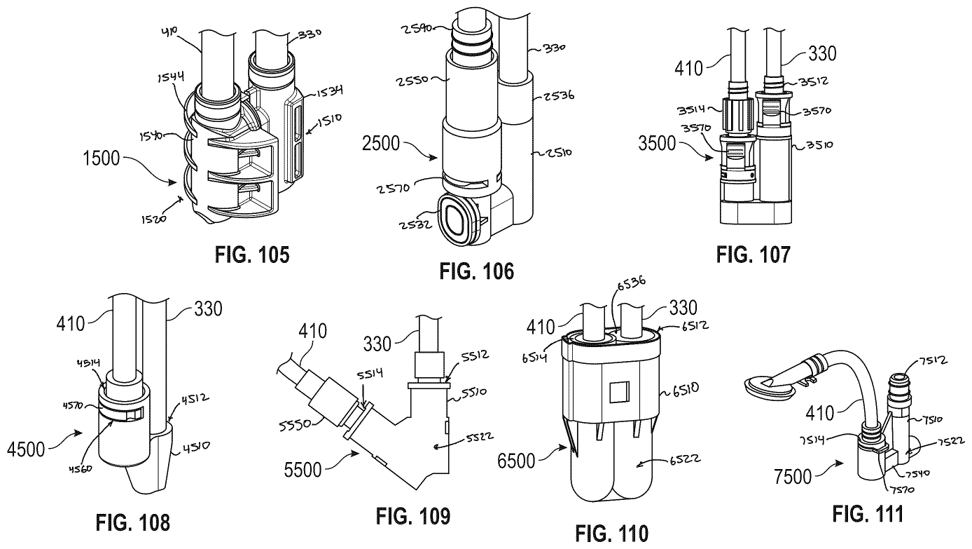

The valve body assembly 110 receives fluid (e.g., cold water and hot water) and dispenses fluid (e.g., mixed water) via the water inlet and outlet group 300. Said water inlet and outlet group 300 is selected from a plurality of different types, wherein each type typically includes: (i) a first water inlet line 310, (ii) a second water inlet line 320, and (iii) a mixed water line 330. The mixed water line 330 is then connected to the water discharge tube 410 via a mixed water connector 500. The mixed water connector 500 will be described in greater detail below, but may be replaced with alternative embodiments (e.g., 1500, 2500, 3500, 4500, 5500, 6500, and 7500) that are shown in FIGS. 105-111.

### A. Faucet Body Housing

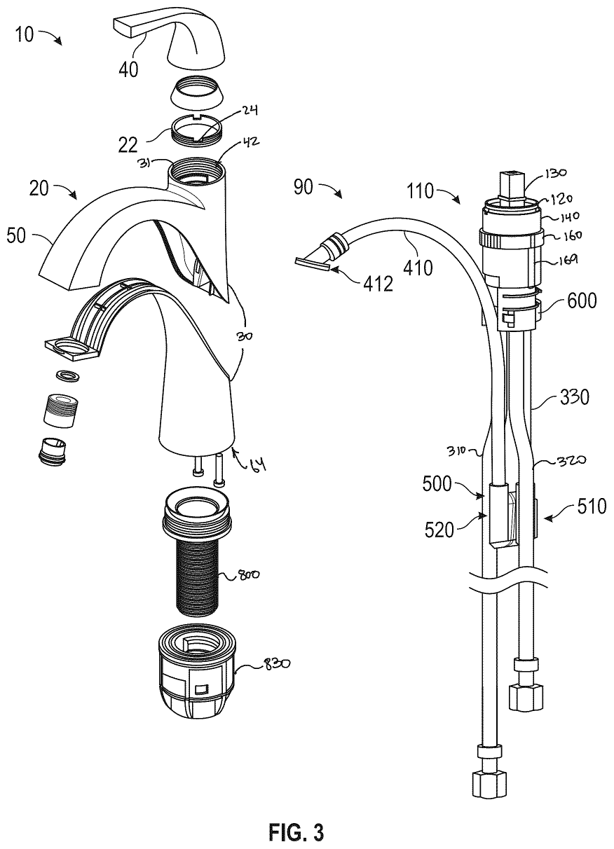

As shown in FIGS. 3 and 62, the faucet housing 20 can include a main body 30, a handle 40 operably connected to the main body 30, and a spout 50 extending from the main body 30. The main body 30 of the faucet housing 20 includes an upper opening 54, a base opening 64 and a spout opening 54. The spout 50 extends from the main body 30 at the spout opening 58 providing an internal passage from the interior of the main body 30 to the spout outlet 52. The main body 30 includes an internal threaded extent 31 below the upper opening 54 and an internal step 32 below the threaded extent 31. In some configurations, the housing 20 may also a threaded mounting portion 66 within the base portion 60. The bathroom faucet system 10 is mounted to a support or mounting surface 85 at a base portion 60 of the main body 30 using a tubular mounting shank 800. In some embodiments, alternate mounting components and/or assemblies may be used to mount the faucet 10 to the support surface 85, such as a kitchen or bathroom countertop.

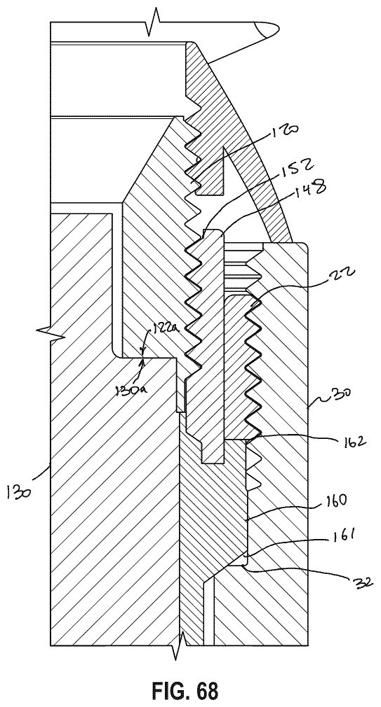

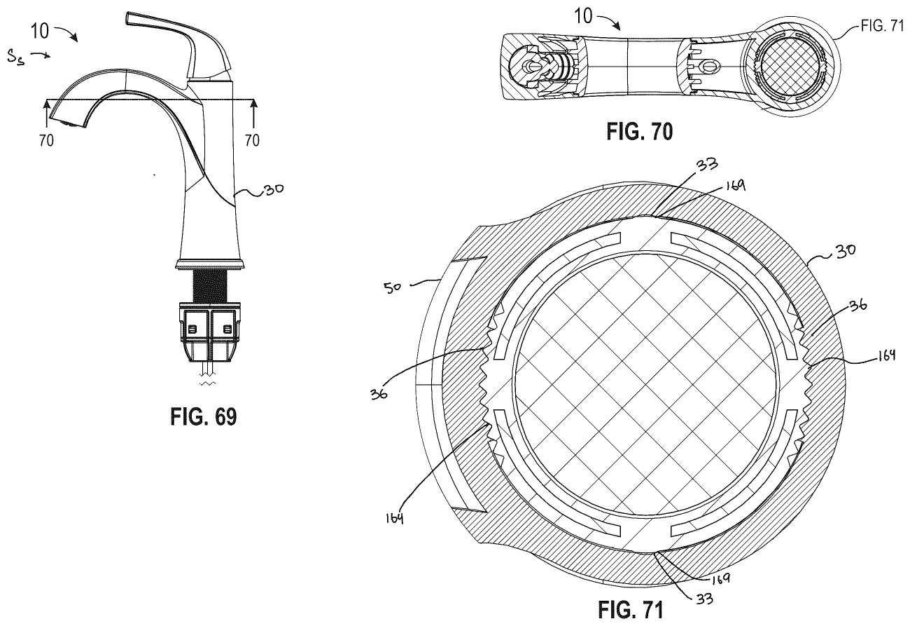

As best shown in FIGS. 62 and 68, the main body 30 of the faucet housing 20 can an internal step 32 that can be formed from a combination of projections and/or recesses within the interior of the main body 30. In an exemplary embodiment disclosed herein, the internal step 32: (i) is formed below the threaded extent 31 of the main body 30 that is cooperatively dimensioned to receive a threaded extent of a lock nut 22, and (ii) reduces at least an extent of the internal diameter of the main body 30. This reduction in at least an extent of the internal diameter of the main body 30 is configured such that the diameter of the annular band 160 is greater than the reduced diameter of the main body 30. The annular band 160 with a top or first edge surface 162 and a bottom or second edge surface 161. As such, the bottom or second edge surface 161 of the annular band 160 is suitable to engage with an internal step 32 in the main body 30 of the faucet housing 20. When installed, the lock nut 22 can engage with the top or first edge surface 162 of the annular band 160 to secure the valve body housing 140 within the faucet housing 20.

In various embodiments, the faucet housing may optionally include a lower step/shelf 38, positioning teeth 36, positioning holes 34, alignment recesses 33, and/or other mounting, alignment, or positioning features. For example as shown in FIG. 71, the main faucet body 30 can include positioning teeth 36 that interact with the spline teeth 164 of the valve body housing 140. Because the SHUP system 90 can be implemented in a variety of faucet shapes and sizes, all possible faucet features and components may be not be identified. Although examples of the faucet housing 20 are illustrated with the main body 30 split with an upper and lower extent, the SHUP system 90 can be relied on for a faucet housing 20 with the main body 30 and spout 50 formed in one or more pieces.

### B. First Embodiment of the Valve Body Housing

The valve body housing 140 is a component of the SHUP system 90 and is designed to: (i) receive an extent of the mixing cartridge 130, (ii) be threadedly coupled to the retaining nut 120, (iii) be removably secured to the faucet housing 20, and (iv) receive an extent of the water inlet and outlet group 300, and (v) accept an extent of the water group coupler 600 in order to connect said housing 140 to the water inlet and outlet group 300. The valve body housing 140 may take many forms, some of which are disclosed herein, but its core function is to form a fluid flow path that is isolated from the faucet housing 20 by coupling the mixing cartridge 130 to the water inlet and outlet group 300. To achieve this core function, the valve body housing 140 has a substantially cylindrical shape with protruding structures that are formed by an arrangement of walls 149. Said arrangement of walls 149 can be divided into the following structures: (i) an upper portion or cartridge receiving extent 142, (ii) a base wall 170, and (iii) a lower portion or water group receiver 144. Additionally, in some embodiments, said valve body housing 140 may be formed from a plurality of portions (e.g., first and second portion 202, 204) to help ensure durability of said valve body housing 140 of said system 90 and enable said housing 140 to perform it's the above describe core function.

Unlike conventional valve body housings, the valve body housing 140 does not include a threaded exterior portion. In other words, the valve body housing 140 lacks exterior threads. However, the valve body housing 140 includes interior threads 152, but these interior threads 152 are positioned within the uppermost portion of the upper extent or cartridge receiving extent 142. As such, the lower portion or water group receiver 144 of the valve body housing 140 lacks interior and exterior threads. Therefore, no structure or component is threadedly connected to a lower extent of the valve body housing 140. In embodiments of the disclosed system 10 that include a bolt mount (as discussed below), the bolt is not attached directly to the valve body housing 140. Further, the valve body housing 140 does not extend into the lower portion or lower half of the faucet housing 20. And in some embodiments, the valve body housing 140 does not extend below the narrowest extent of the faucet housing 20. In other embodiments, a lower edge or lowermost extent of the valve body housing 140 does not extend below the lowermost portion of a spout 50 of the faucet housing 20. In other words, the lower edge or lowermost extent of the valve body housing 140: is positioned in the upper half of the faucet housing 20, may be positioned above the narrowest extent of the faucet housing 20, and can be positioned above the lowermost of a spout 50.

i. Cartridge Receiving Extent

The upper extent or cartridge receiving extent 142 is designed to receive a majority of the mixing cartridge 130 within the valve body housing 140. As such, the cartridge receiving extent 142 extends between an upper edge 141 of the housing 140 and an upper surface, upper side, or first side 170a of the base wall 170. In other words, the cartridge receiving extent 142 is positioned above line P-P, wherein line P-P is co-planer with the first side 170a of the base wall 170. Stated another way, the cartridge receiving extent 142 is positioned above the base wall 170 and the water group receiver 144. The cartridge receiving extent 142 has a hollow interior 150 and typically includes (i) an internal threaded portion 152, (ii) an annular band 160, and (iii) a majority of a plurality of strengthening ribs 169.

The hollow interior 150 forms a cartridge receiver 154 that extends between a vertical portion or upper housing wall 148 of the arrangement of walls 149 and is defined between: (i) a cartridge seat 158, and (ii) an interior surface 151 of the vertical portion or upper housing wall 148 of the arrangement of walls 149. The cartridge seat 158 is limited to the area of the upper surface 170a of the base wall 170 that is designed to be in direct contact with the mixing cartridge 130. In other words, the cartridge seat 158 typically does not extend across the entire surface area of the upper surface 170a of the base wall 170 because the exterior diameter D_{OC} of the mixing cartridge 130 does not typically equal the interior diameter D_{IH} of the upper surface 170a of the base wall 170. This miss-match of the exterior and interior diameters D_{OC}, D_{IH} helps ensure that the mixing cartridge 130 can be inserted within the cartridge receiver 154 without extreme force or requiring deformation of the arrangement of walls 149. As shown in the Figures, the exterior diameter D_{OC} of the mixing cartridge 130 is typically slightly smaller than the interior diameter D_{IH} of the upper surface 170a. In other embodiments, the exterior diameter D_{OC} of the mixing cartridge 130 is may be substantially smaller than the interior diameter D_{IH} of the upper surface 170a. For example, a 25 mm mixing cartridge 130 can be instead of a 35 mm mixing cartridge 130 without changing the housing 140. It should be understood that the current embodiment does not include a SHUP system 90 where the exterior diameter D_{OC} of the mixing cartridge 130 is larger than the interior diameter D_{IH} of the upper surface 170a of the base wall 170.

The interior surface 151 of the vertical walls includes a substantially smooth surface 156 and an internal threaded extent 152. The substantially smooth surface 156 of the vertical portion 148 of the arrangement of walls 149 extends parallel to the outer surface of the mixing cartridge 130, when said mixing cartridge 130 is inserted within the cartridge receiver 154. For example, the substantially smooth surface 156 can include interior wall portion 153 and an interior extent of the tubular sidewall 206. As shown in FIG. 40, the height of the substantially smooth surface 156 of the vertical portion 148 of the arrangement of walls 149 is approximately equal to the height of the main body of the mixing cartridge 130. In other words, overall depth of the cartridge receiver 154 is greater than the height of the main body of the mixing cartridge 130, as the depth of the cartridge receiver 154 is equal to the sum of the heights of the substantially smooth surface 156 of the vertical portion 154 of the arrangement of walls 149 and internal threaded extent 152. This design allows for: (i) the retaining nut 120 to be coupled to the internal threaded extent 152 of the housing 140 and to secure said mixing cartridge 130 within the cartridge receiver 154 to form a secured state, and (ii) does not require that the interior diameter D_{IH} of the cartridge receiver 154 be substantially increased.

While the main body of the mixing cartridge 130 extends upward from a lower surface of the mixing cartridge 130 to a location of the mixing cartridge 130 that substantially changes in diameter, said mixing cartridge 130 also includes a projection that extends upward from the main body of the mixing cartridge. The change in diameter between the main body of the mixing cartridge 130 and the projection of the mixing cartridge 130 form an upper lip 130a. This upper lip 130a is designed to interact with a lower surface 120a of the retaining nut 120. Said interaction between the upper lip 130a and the lower surface 120a, ensures that a lower surface 130b of the mixing cartridge 130 is in contact with a portion of first side 170a (i.e., cartridge seat 158) of the base wall 170. Said contact between the lower surface 130b and the cartridge seat 158 ensures that a proper seal is formed between the mixing cartridge 130 and the valve body housing 140, which in turn helps ensure that fluid (e.g., water): (i) flows between the mixing cartridge 130 and the water inlet and outlet group 300, and (ii) does not flow into the faucet housing 20. In other words, the interaction between the upper lip 130a and the lower surface 120a is designed to secure said mixing cartridge 130 within the cartridge receiving extent 142 of the valve body housing 140. It should be understood that other methods of securing the mixing cartridge 130 within the valve body housing 140 is contemplated by this disclosure. Although the retaining nut 120 may also couple the handle 40 of the faucet housing 20, it does not engage with the main body 30 of the faucet housing 20.

### a) Annular Band

As discussed above, the upper extent or cartridge receiving extent 142 includes the annular band 160 that surrounds an extent of the exterior surface 210 of the valve body housing 140. Said annular band 160 extends outward from the cylindrical extent of the housing 140 and is designed to interact with an extent of the faucet housing 20 and lock nut 22 to secure said housing 140 within the faucet housing 20. As such, the exterior diameter of the annual band 160 is greater than the exterior diameter of the cylindrical extent of the housing 140. The increase in the exterior diameter of the annual band 160 over the exterior diameter of the cylindrical extent of the housing 140 creates: (i) an upper or first edge 162, and (ii) a lower or second edge 161. In other words, the annular band 160 includes the upper or first edge 162, and the lower or second edge 161. The upper or first edge 162 is substantially linear or flat and is positioned perpendicular to the upper vertical portion 148 of the arrangement of walls 149.

Unlike the upper or first edge 162, the lower or second edge 161 is sloped or beveled. As best shown in FIG. 68, the sloped or beveled lower or second edge 161 is designed to engage with at least a portion of the faucet housing 20 (e.g. internal step 32). The interaction of the beveled edge 161 of the annular band 160 and the internal step 32 of the faucet housing 20 creates a wedging effect due to a downward force FD that is provided by the lock nut 22 upon the annular band 160. As such, the lock nut 22 includes notches 24 in an upper extent to allow a specialized tool to interact with said notches to tighten the nut 22 down to make contact with the annular band 160. As the lock nut 22 is tightened, the magnitude of the downwardly directed force FD increases on the annular band 160. The beveled edge 161 attempts to avoid this downwardly directed force by moving inward or pushing the housing 20 outward. However, said beveled edge 161 cannot move inward due to the configuration of the housing 140 and the beveled edge 161 cannot push the housing 20 outward due to the material compensation of the housing 20. Thus, the downwardly directed force F_{D} functionally and effectively wedges the housing 140 within the housing 20 to securely couple the valve body housing 140 within the faucet housing 20.

In other embodiments, the second edge 161 may be parallel with the first edge 162. As such, both edges 161, 162 may be substantially perpendicular with an extent of the to the upper vertical portion 148 of the arrangement of walls 149 or may both be angled relative to said upper vertical portion 148 of the arrangement of walls 149. In other embodiments, the edges 161, 162 may have other configurations that are designed to receive one or more extents of the housing 20 (e.g., step 32 or the lock nut 22 to further secure said housing 140 within the housing 20. Finally, other designs of the edges 161, 162 and annular band 160 are contemplated by this disclosure, some of which may be based on the materials that are incorporated herein or other designs that are known to one of skill in the art.

In certain embodiment, the valve body housing 140 may include at least one, and sometimes a plurality of, teeth 164. The tooth or teeth 164 may be integrally formed in the annual band 160 or may be coupled therewith. In the embodiment shown in FIG. 71, the annual band 160 includes a first plurality of teeth positioned in a front extent of the band 160 and a second plurality of teeth positioned in a rear extent of the band 160. The first and second pluralities of teeth are designed to interact with positioning teeth 36 that are formed in main body 30 of the faucet housing 20. The interaction between the teeth 164 of the annular band 160 and positioning teeth 36 of the housing 20 is designed to limit radial movement of the valve body housing 140. Positioning teeth 164 are disposed on opposite sides of the valve body housing 140 ensure that said valve body housing 140 cannot rotate within the faucet housing 20 or be misaligned within said faucet housing 20. It should be understood that in alternative embodiments: (i) the teeth may surround the entire annular band 160, (ii) the teeth 164 may be omitted, (iii) the first and second pluralities of teeth may include more or less teeth, and/or (iv) the annular band 160 (e.g., segment band) may be segmented (e.g., band segments) into any number (e.g., 2-50) of segments.

### b) Ribs

The valve body housing 140 can further include strengthening ribs 169 that are integrally formed with the annular band 160 and may extend downward therefrom. The ribs 169 may be opposite sides of the valve body housing 140 may be designed to increase the rigidity of the valve body housing 140. In some configurations, the ribs 169 are also used for alignment and/or positioning within the faucet housing 20. For example, the ribs 169 can engage with alignment recesses 33 of the faucet main body 30. In other embodiment, the ribs 169 may be omitted, may be positioned aligned with/intersect with the teeth 164 of the annular band 160, may be separate and distinct/does not intersect with the annular band 160, and/or may be received by a structure or plurality of structures to help position or secure the housing 140 within the housing 20.

ii. Base Wall

The base wall 170 of the valve body housing 140 extends between the upper surface, upper side, or first side 170a of the base wall 170 and a lower surface 170b of the base wall 170, shown as line F-F on FIG. 40. As such, the base wall 170 has a thickness (d₄). In some embodiments, the upper surface, upper side, or first side 170a of the base wall 170 may include positioning indents 157 to receive positioning feet 134 from a mixing cartridge 130 for proper placement and alignment of the mixing cartridge 130 within the valve body housing 140. In other embodiments, said positioning indents 157 may be omitted and the mixing cartridge 130 may have projections that are designed to fit within an arrangement of fluid passages 168 that are formed in said base wall 170 for fluidly connecting the mixing cartridge 130 and the water inlet and outlet group 300.

As shown in the Figures, the arrangement of fluid passages 168 are formed through the base wall 170. In other words, the arrangement of fluid passages 168 are formed completely through the thickness d₄ of the base wall 170. Stated a further way, the arrangement of fluid passages 168 extend from the first side 170a to the water group surface 177 in order to form a fluid passageway between the mixing cartridge 130 and the water inlet and outlet group 300. The arrangement of fluid passages 168 may include: (i) a cold water passage 163a that is designed to receive cold fluid from the cold/first inlet water line 310 of the water inlet and outlet group 300, a hot water passage 163b that is designed to receive hot fluid from the hot/second water inlet line 320 of the water inlet and outlet group 300, and a mixed water passage 163c that is designed to expel mixed fluid into the mixed water outlet line 330 of the water inlet and outlet group 300. It should be understood that in other embodiments, the arrangement of passages 168 may include more or less fluid passages.

iii. Water Group Receiver

The lower extent or water group receiver 144 is designed to receive an extent of the water inlet and outlet group 300 and secure said water inlet and outlet group 300 to the valve body housing 140. As such, the water group receiver 144 extends between a lower edge 143 of the housing 140 and the water group surface 177. As such, the water group receiver 144 has a water group receiver distance d₅. The water group receiver 144 has a hollow interior 214 and typically includes an attachment means 230 that is designed to receive an extent of a coupling means 601.

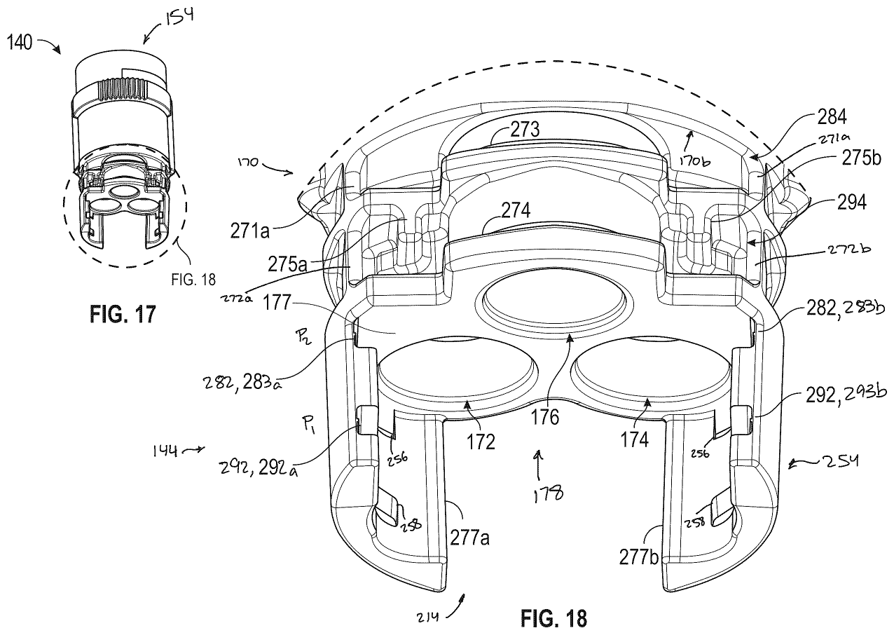

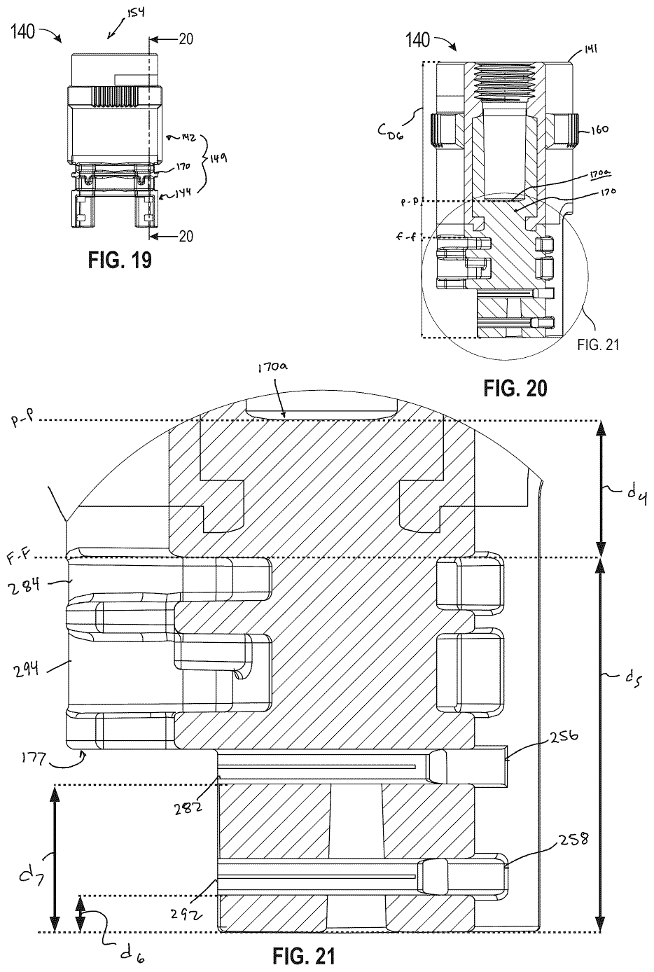

As best shown in at least FIGS. 7, 14-18, the water group receiver 144 includes: (i) left and right upper side walls 271a, 271b, (ii) an upper lateral wall 273 with left and right securing projections 275a, 275b extending downward from a lower surface of said upper lateral wall 273, (iii) left and right middle side walls 272a, 272b, (iv) a lower lateral wall 274, and (v) left and right lower side walls 277a, 277b. The combination of 271a, 271b, 272a, 272b, 273, 274, 275a, 275b, 277a, 277b form various recesses, grooves, and slots that are designed to interact with the coupling means 601 (e.g., water group coupler 600) in order to secure different types of water inlet and outlet groups 300 to said housing 140. In particular, said recesses, grooves, and slots are designed to couple two different types of water inlet and outlet groups 300 to said housing 140. To accomplish this, the water group receiver 144 includes: (i) a first extent 231 of the attachment means 230 suitable to receive at least a portion of the coupling means 601 in a first seated position, and (ii) a second extent 232 of the attachment means 230 suitable to receive at least a portion of the coupling means 601 in a second seated position. It should be understood that in other embodiments, the attachment means 230 may have additional extents (e.g., between 3 and 5) or fewer extents (e.g., between 0-1) that are suitable to receive the same or different types coupling means 601 in additional positions (e.g., between 3 and 5) or fewer (e.g., between 0-1).

### a) First Extent of the Attachment Means

The first extent 231 of the attachment means 230 includes a first collection of securing structures 290 comprising: (i) a first set of attachment grooves 292 formed within the left and right lower side walls 277a, 277b of the valve body housing 140 suitable to receive an edge portion 612 of the planar body portion 610 of the water group coupler 600, (ii) a left aperture 258a and a right aperture 258b, and (iii) a pair of tab grooves 294 formed within the valve body housing 140 and that are suitable to receive the pair of tabs 660 of the water group coupler 600. The first set of attachment grooves 292 include a first a left groove 293a and a first right groove 293b, wherein said left and right grooves 293a, 293b extend through a majority of the left and right lower side walls 277a, 277b, but do not extend completely through said left and right lower side walls 277a, 277b. As such, the left and right grooves 293a, 293b are defined by a top surface, a bottom surface, and an outer surface. The bottom surface of the left and right grooves 293a, 293b is formed at a first attachment groove distance de from the lower edge of the housing 140, wherein the first attachment groove de. When the water group coupler 600 is in a first seated position, an extent of said water group coupler 600 is in contact with at least one of the top, bottom, or outer surfaces of the left and right grooves 293a, 293b.

The left and right apertures 258a, 258b are formed in a rear extent of the left and right lower side walls 277a, 277b and are designed to receive an extent of the water group coupler 600, when said water group coupler 600 is in the first seated position. In other embodiments, the left and right apertures 258a, 258b may be omitted. In an alternative embodiment, the left and right apertures 258a, 258b may be configured to allow an extent of the water group coupler 600 to be positioned adjacent to a lateral side of the left and right lower side walls 277a, 277b in order to secure said water group coupler 600 to the housing 140. In this alternative embodiment, the extent of the water group coupler 600 may be temporarily deformed during insertion and may return to a normal state after they are fully seated within the apertures 258a, 258b. This will require deforming of the water group coupler 600 to separate said coupler 600 from the housing 140, which may be beneficial in certain embodiments.

The pair of tab grooves 294 are formed by: (i) left and right middle side walls 272a, 272b, (ii) left and right securing projections 275a, 275b extending downward from a lower surface of said upper lateral wall 273, and (iii) an upper surface of the lower lateral wall 274. Each tab grooves contained in the pair of tab grooves 294 is separated by a central projection of the housing 140, wherein said central projection is configured to allow for the receival of the mixed water tube 330. In other embodiments, the pair of tab grooves 294 may be a single grove or may be omitted.

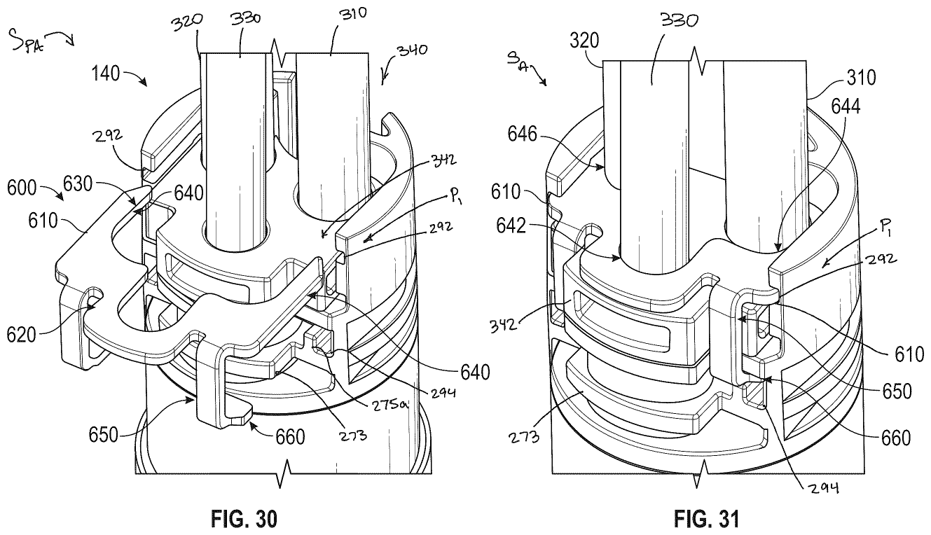

The first set of attachment grooves 292 and the first pair of tab grooves 294 of the first collection of securing structures 290 having a separation distance (s₂) substantially similar to the height (h₁) of the pair of members 650 of the water group coupler 600, such that the planar body portion 610 can be received into the first set of attachment grooves 292 and planar tabs 660 are received into the first pair of tab grooves 294 and an interior surface of the pair of members 650 abut at least a portion of the water group receiver 144 (see also e.g., FIGS. 30-31).

### b) Second Extent of the Attachment Means

The second extent 232 of the attachment means 230 includes a second collection of securing structures 280 comprising: (i) a second set of attachment grooves 282 formed within the left and right lower side walls 277a, 277b of the valve body housing 140 suitable to receive an edge portion 612 of the planar body portion 610 of the water group coupler 600, (ii) a left aperture 256a and a right aperture 256b, and (iii) a second pair of tab grooves 284 formed within the valve body housing 140 and that are suitable to receive the pair of tabs 660 of the water group coupler 600. The second set of attachment grooves 282 includes a second a left groove 283a and a right groove 283b, wherein said left and right grooves 283a, 283b extend through a majority of the left and right lower side walls 277a, 277b, but do not extent completely through said left and right lower side walls 277a, 277b. As such, the left and right grooves 283a, 283b are defined by a top surface, a bottom surface, and an outer surface. The bottom surface of the left and right grooves 283a, 283b is formed at a second attachment groove distance d₇ from the lower edge of the housing 140, wherein the second attachment groove distance d₇ is greater than the first attachment groove distance de. When the water group coupler 600 is in a second seated position, an extent of said water group coupler 600 is in contact with at least one of the top, bottom, or outer surfaces of the left and right grooves 283a, 283b.

The left and right apertures 256a, 256b are formed in a rear extent of the left and right lower side walls 277a, 277b and are designed to receive an extent of the water group coupler 600, when said water group coupler 600 is in the second seated position. In other embodiments, the left and right apertures 256a, 256b may be omitted. In an alternative embodiment, the left and right apertures 256a, 256b may be configured to allow an extent of the water group coupler 600 to be positioned adjacent to a lateral side of the left and right lower side walls 277a, 277b in order to secure said water group coupler 600 to the housing 140. In this alternative embodiment, the extent of the water group coupler 600 may be temporarily deformed during insertion and may return to a normal state after they are fully seated within the apertures 256a, 256b. This will require deforming of the water group coupler 600 to separate said coupler 600 from the housing 140, which may be beneficial in certain embodiments.

The second pair of tab grooves 284 are formed by: (i) left and right upper side walls 271a, 271b, (ii) an upper surface of the upper lateral wall 273, and (iii) the lower surface 170b of the base wall 170. Each of the tab grooves contained in the second pair of tab grooves 284 is separated by a central projection of the housing 140, wherein said central projection is configured to allow for the receival of the mixed water tube 330. In other embodiments, the second pair of tab grooves 284 may be a single groove or may be omitted.

The second set of attachment grooves 282 and the second pair of tab grooves 284 of the second collection of securing structures 280 has a separation distance (s₂) substantially similar to the height (h₁) of the pair of members 650 of the water group coupler 600, such that the planar body portion 610 can be received into the second set of attachment grooves 282 and planar tabs 660 are received into the second pair of tab grooves 284 and an interior surface of the pair of members 650 abut at least a portion of the water group receiver 144 (see also e.g., FIG. 44).

At least a back portion of the water group receiver 144 having an external surface provides for attachments options or additional securing means for some configurations is shown. The base wall 170 is formed within the water group receiver 144 provides for fluid connectivity between the water inlet and outlet group 300 and the mixing cartridge 130, with only the passages 168 internal to the interface base of the valve body housing 140 in contact with the fluids. The water group receiver 144 extends beyond the second surface of the base wall 170 including valve body extensions 254 that are substantially arcuate and substantially aligned with at least a portion of the upper housing wall 148 forming the hollow interior 150. The interior surfaces of the valve body extensions 254 include attachment grooves 282, 292 that are configured to receive the planar body portion 610 of the water group coupler 600 to secure the water inlet and outlet group 300 to the valve body housing 140.

As shown in FIG. 16, although the exterior surfaces of the valve body extensions 254 are arcuate and substantially align with the exterior surface of the upper portion of valve body housing 140, the attachment grooves 282, 292 have a uniform width between opposing extensions 254 and are formed within the extensions to accommodate the width (w₁) of the water group coupler 600. For example, each attachment groove 282 is formed in opposing interior surfaces of each valve body extension 254 and spaced apart such that the parallel edge portions 612 of the planar body portion 610 can slidably engage with respective attachment groove 282 and sized with a dimension (g₁) to receive the thickness (t₁) of the planar body portion 610. Similarly, each attachment groove 292 is formed in opposing interior surfaces of each valve body extension 254 and spaced apart such that the parallel edge portions 612 of the planar body portion 610 can slidably engage with respective attachment groove 292 and sized with a dimension (g₁) to receive the thickness (t₁) of the planar body portion 610. The valve body extensions 254 further include apertures 256, 258 in a front portion of each guard extension 254. Each aperture 256 being aligned with respective attachment grooves 282 on each valve body extension 254. Each aperture 258 being aligned with respective attachment grooves 292 on each valve body extension 254. As such, when the water group coupler 600 is positioned within attachment grooves 282 or attachment grooves 292, the edge portion 612 is engaged with the respective attachment grooves 282 or 292, and tip portion 612 of each arm 640 of the planar body portion 610 extends through apertures 256 or apertures 258, respectively, to further secure the water group coupler 600. The apertures 256, 258 are formed along the path of respective attachment groove 282, 292 through the body of the valve body extension 254 on each side, thus the relative height and distance between the pairs are the same. As such, the separation distance (s₁) between attachment groove 282 and attachment groove 292 is the same as the separation distance (s₁) between aperture 256 and aperture 258. The separation distance (s₁) also defining a distance between P₁ and P₂ and/or a distance between the first collection of securing structures 290 and the second collection of securing structures 280 for all portions of the water group coupler 600.

The tab grooves 284, 294 do not interfere with inlet ports 172, 174 or outlet port 176 or positioning of the water inlet and outlet group 300 therein. The tab grooves 284, 294 are configured to receive the planar tabs 660 of the water group coupler 600 to further secure the position of the planar body portion 610. The tab grooves 284, 294 are spaced at a width (wᵥ₁) substantially similar to the width (w₂) of between the pair of parallel members 650 and dimensioned to accommodate the thickness and width of individual planar tabs 660. Similar to the attachment grooves 282, 292, the tab grooves 284 are vertically spaced from tab grooves 294 is the same as the separation distance (s₁) defined by the distance between P₁ and P₂. The external portion of the water group receiver 144 between tab grooves 284 and the second surface of the base wall 170 has at least one flat surface onto which the members 650 of the water group coupler 600 can rest when the water group coupler 600 is secured. The shape of the water group receiver 144 formed such that when the water group coupler 600 is attached, it remains within a circumference of the external portion of the cartridge receiving extent 142, thus does not interfere with the placement of the valve body assembly 110 within a faucet housing 20.

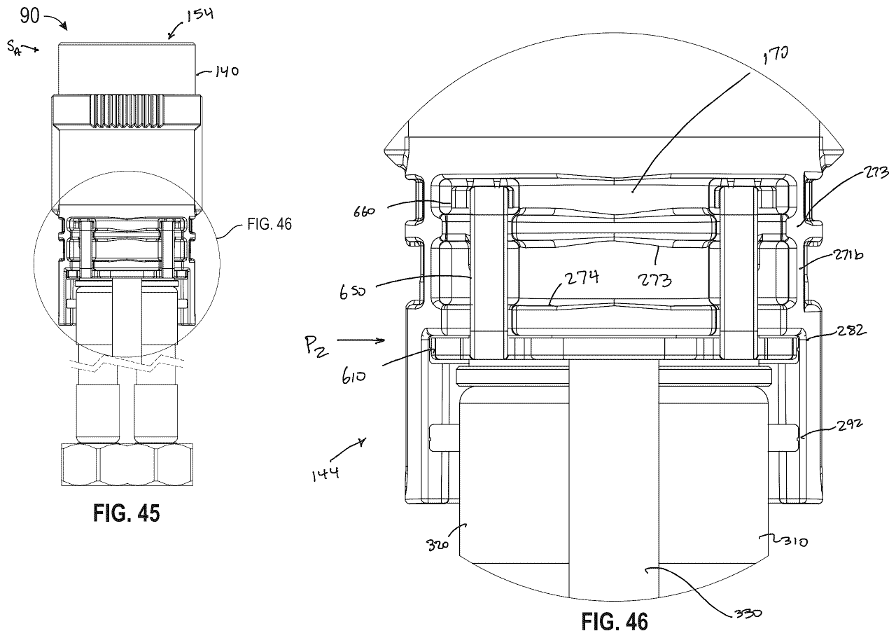

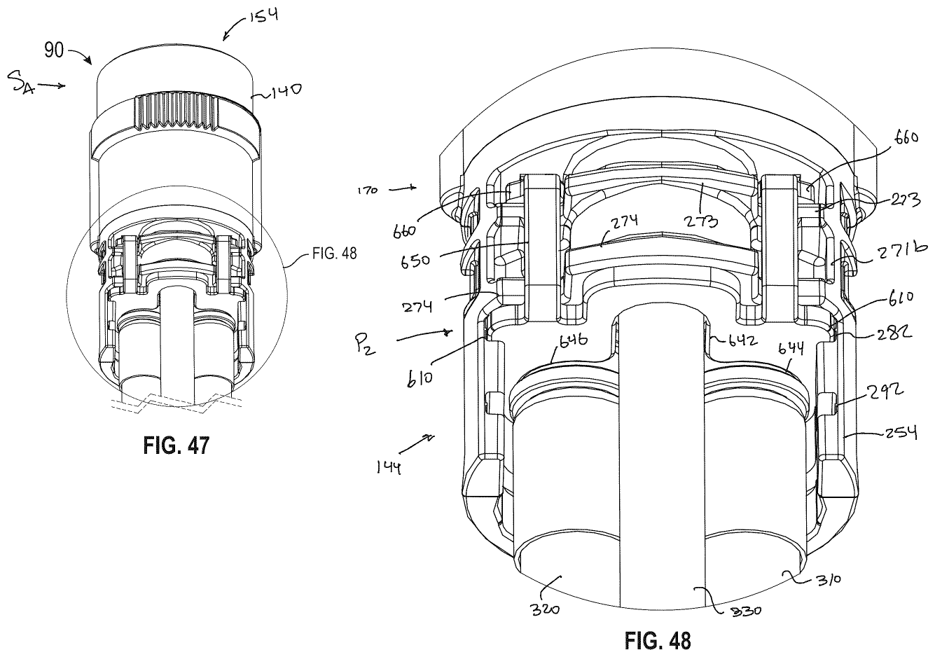

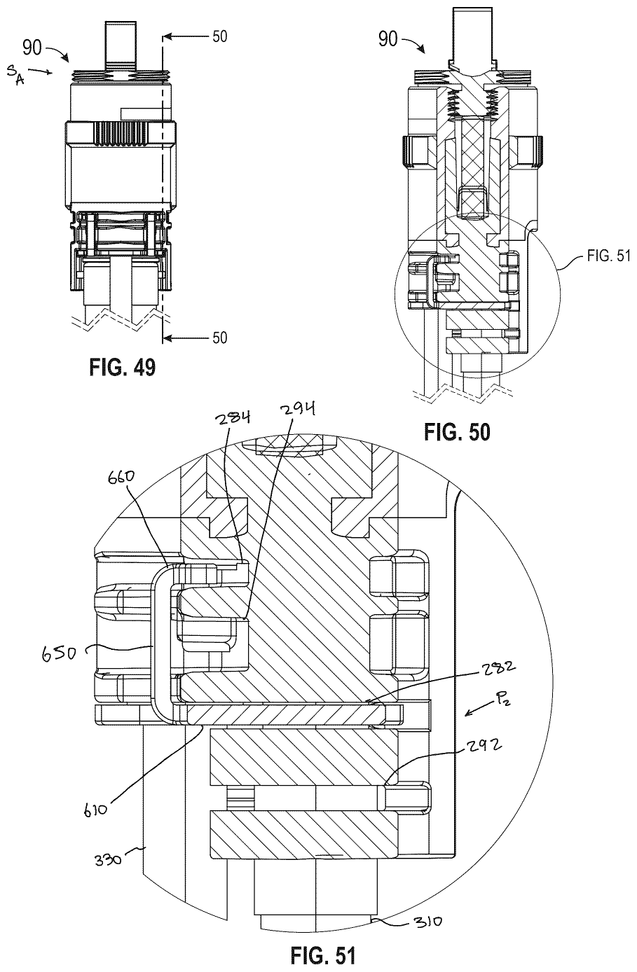

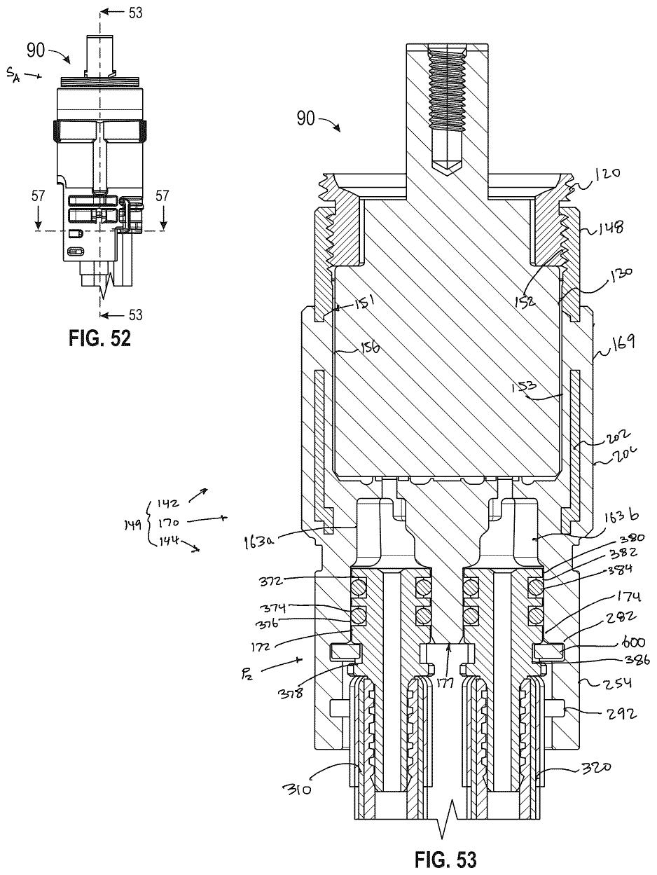

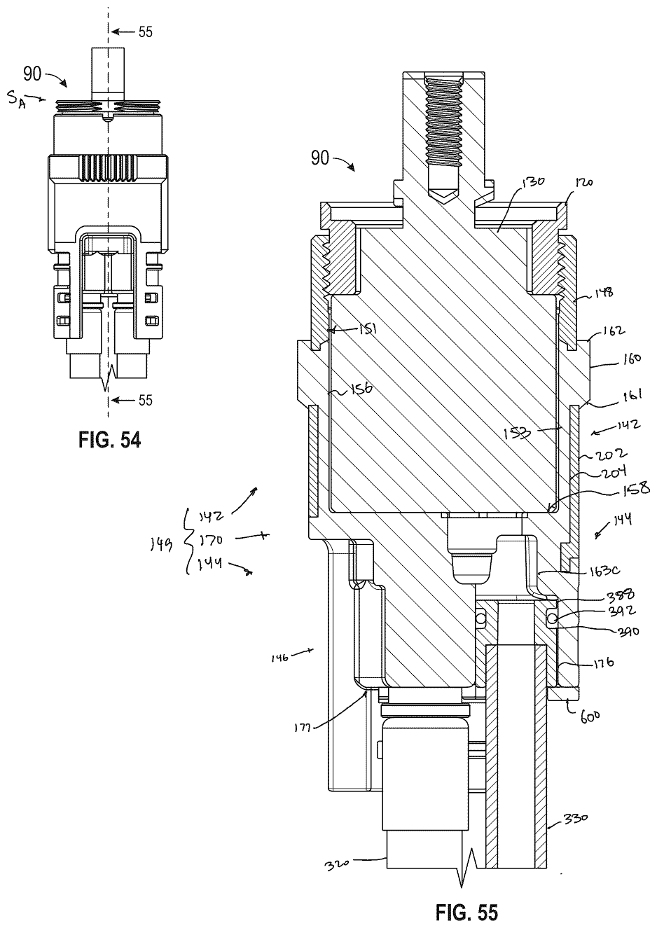

For example, the water inlet and outlet group 300 configured as individual tubes or lines (see e.g., FIGS. 24-25) can be received in a second position, directly into the water group receiver 144 of the valve body housing 140. An example of the water inlet and outlet group 300 secured by water group coupler 600 in a second position is shown in FIG. 44. The coupling relationship between the water group coupler 600 and the valve body housing in the second collection of securing structures 280 is shown in FIGS. 45-55, without the water inlet and outlet group 300.

### c) Arrangement of Ports

An arrangement of ports 178 extend from the arrangement of passages 168 that are formed through the base wall 170. Specifically, the arrangement of ports 178 includes: (i) a first or cold water inlet port 172 that extends from a lower extent of the cold water passage 163a, (ii) a second or hot water inlet 174 that extends from a lower extent of the hot water passage 163b, and (iii) a third or mixed water outlet port 176 that extends from a lower extent of the mixed water passage 163c. Each inlet/outlet port 172, 174, 176 is configured to receive an extent of the water inlet and outlet group 300. In particular, the first or cold water inlet port 172 is designed to receive a coupling end 312 of the first water inlet line 310 of said water inlet and outlet group 300, the second or hot water inlet port 174 is designed to receive a coupling end 322 of the second water inlet line 320 of said water inlet and outlet group 300, and the third or mixed water outlet port 176 is designed to receive a coupling end 332 of the mixed water line 310 of said water inlet and outlet group 300.

As discussed in greater detail below, each of the coupling ends 310, 322, 332 are inserted into the ports 172, 174, 176 using a linear force, not a rotational or twisting component. In other words, said coupling ends 310, 322, 332 are not threaded into the ports 172, 174, 176 using a rotational or twisting force. This configuration enables the coupling ends 310, 322, 332 and the ports 172, 174, 176 to lack threads. This is beneficial because it simplifies assembly, reduces potential assembly errors, and increase durability of the system 90. However, in other embodiments, the coupling ends 310, 322, 332 and the ports 172, 174, 176 may include threaded portions.

In various embodiments, the mixed water is discharged in a direction substantially parallel to the input lines and the major axis of the valve body housing 140. Water is not discharged from the valve body housing 140 perpendicular to a major axis of the valve body housing 140 or faucet 10. In other words, water is typically not discharged from the valve body housing 140 parallel with the support surface. Water is discharged from the valve body housing 140 either: (i) parallel to the major axis of the valve body housing 140 or faucet 10, or (ii) in a direction that forms an acute angle with said major axis of the valve body housing 140 or faucet 10. As such, the water is discharged from the valve body housing 140 in a direction that is either: (i) perpendicular to the support surface, or (ii) forms an obtuse angle that is less than 180 degrees with the support surface 85.

iv. Portions of the Valve Body Housing

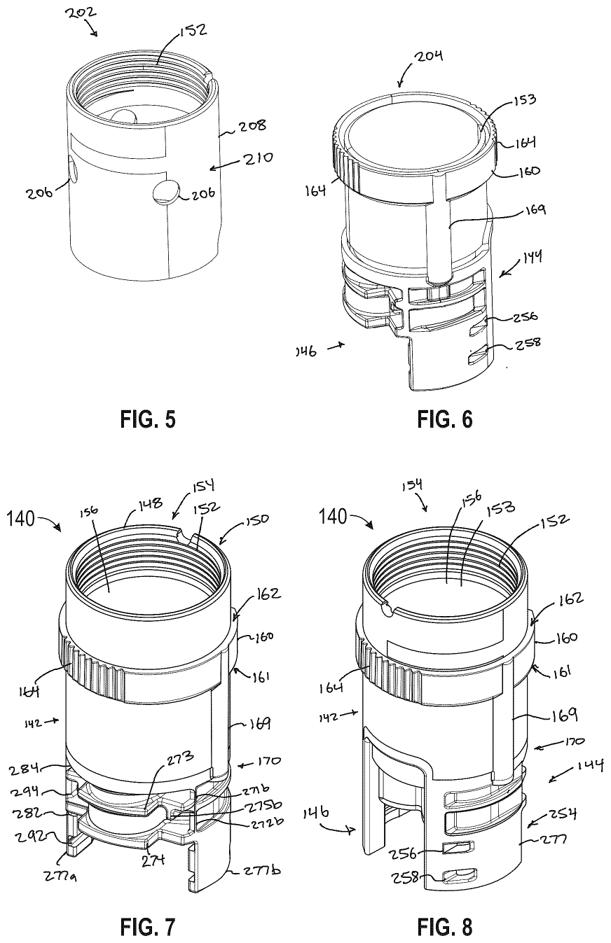

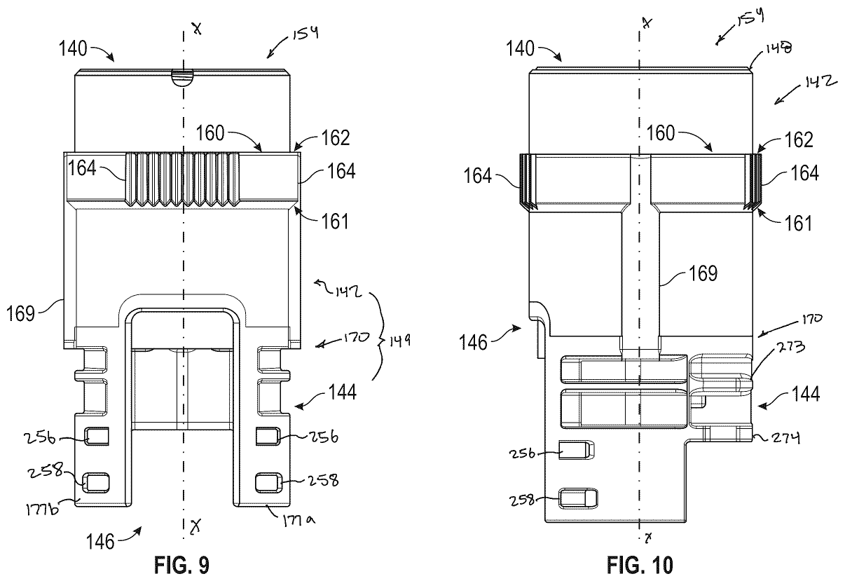

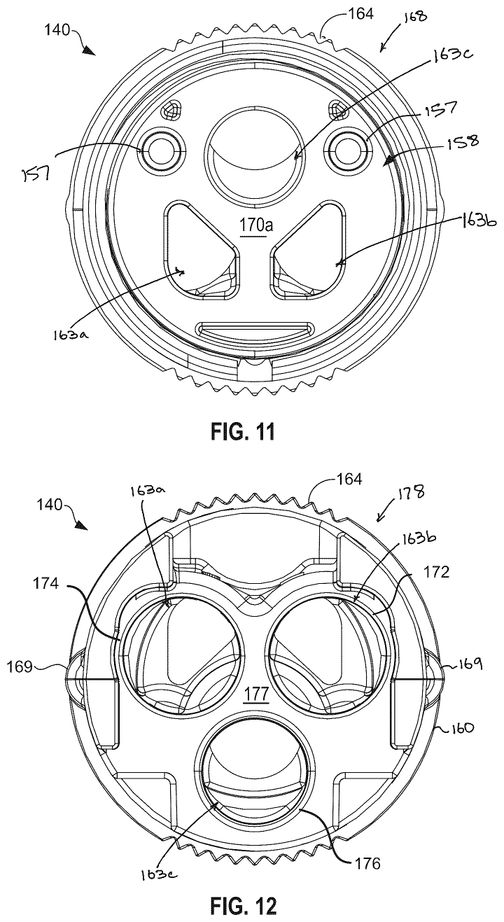

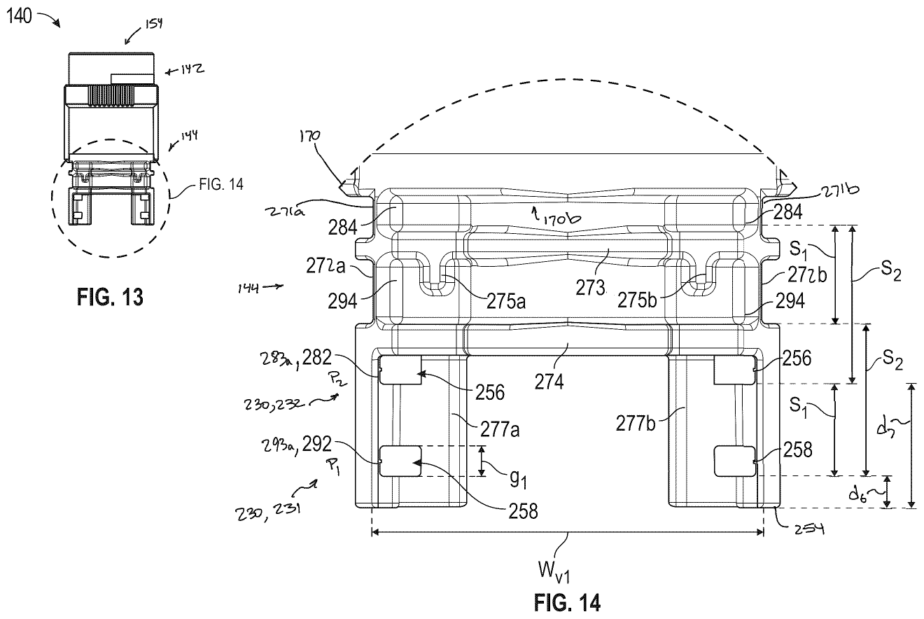

FIGS. 5-6 show that the valve body housing 140 includes a first portion 202 and second portion 204, wherein the second portion 204 can be formed within and around the first portion 202. The first portion 202 is configured to provide structural support and includes an internal threaded portion 152 that extends a distance (di) from the top of the valve body housing 140 (FIGS. 40 and 42). The first portion 202 includes: (i) a tubular sidewall 206, (ii) one or more apertures 208, and (iii) a substantially smooth exterior surface 210. Said one or more apertures 208 are formed in a mid-region of the tubular sidewall 206, wherein said one or more apertures 208 are designed to couple the first portion 202 to the second portion 204. The apertures 208 also define the level of the annular band 160 that surrounds the valve body housing 140 on the exterior surface 210 of the tubular sidewall 206, with the apertures 208 providing continuity between the interior wall portion 153 and the exterior annual ring 160. The upper housing wall 148 of the valve body housing 140 defined by the tubular sidewall 206 and the interior wall portion 153, where the exterior surface 210 is considered the exterior surface of the upper housing wall 148. The second portion 204 can be formed within and around the first portion 202 and includes a water group receiver 144, a base wall 170, the annular band 160, and ribs 169 (FIG. 6). The base wall 170 formed at least partially within the hollow interior 150 and an interior wall portion 153 that extends upward from a first side 170a of the base wall 170, covering an interior extent of the tubular side wall 206 below the threaded portion 152. For example, the interior wall portion 153 may cover the tubular side wall 206 up to and including the apertures 208 of the first portion 202. The interior wall portion 153 of the second portion 202 extends from the cartridge seat 158 and over the interior of the tubular side wall 206 of the first portion 202 to a level below the internal threaded portion 152, so that the retaining nut 120 couples with metal and the plastic portion is below that level. The cartridge seat 158 and interior wall portion 153 being molded to contain the cartridge 130. For example, the interior wall portion 153 extends from base 170 up the tubular sidewall 206 forming a cup-like barrier to the metal first portion 202. As shown in FIGS. 40 and 42, the distance (d₃) from the cartridge seat 158 to the top of the internal interior wall portion 153 can be substantially the same as distance to the top edge surface 162 of the annular band 160. The distance (d₂) from the top of the valve body housing 140 to the top edge surface 162 of the annular band 160 and top of the interior wall portion 153 includes the internal threaded portion 152 to receive the retaining nut 120 and external smooth engagement portion to receive the lock nut 22. The second portion 204 of the valve body housing 140 includes external recesses to save weight and plastic material to make the valve body housing 140 cheaper and lighter.

Shown in FIGS. 5-6, the valve body housing 140 can include a first portion 202 made of a first material and a second portion 204 made of a second material that surrounds at least an extent of the first portion 202. For example, the first portion 202 can be made of a metal, metallic material, or other durable material. The second portion 204 can be over molded in a plastic material, such as PERT or similar material that is acceptable to be in contact with water to be consumed. This combination of materials provide strength while reducing weight and ensures that the water does not interact with metal to increase life of the system and reduce potential contamination. Although the example provided in FIGS. 5-6 show the valve body housing constructed in two portions, other combinations of materials may be relied on to provide similar features. For example, the valve body housing may be formed in a plastic in one-piece.

### C. First Type of Inlet/Outlet Group

The water inlet and outlet group 300 includes: (i) water inlet lines 310, 320 having coupling ends 312, 322 and opposite supply ends 314, 324, and (ii) the mixed water line 330 having a coupling end 332 and a connection end 334. The SHUP system 90 is configured to receive at least a first type of water group 340 provided as a single waterway unit or a second type of water group 370 provided as individual lines. It should be understood from this disclosure that the water inlet and outlet group 300 may have other configurations (e.g., combination of a single water way unit for the supply lines and an individual mixed water line) that will form additional or alternative types. The function of the lines 310, 320, 330 are the same with different connectivity at the coupling end 312, 322, 332 based on the first type of water group 340 (also referred to as a waterway unit 340 herein) or the second type of water group 370 (also referred to as individual lines or tubes herein).

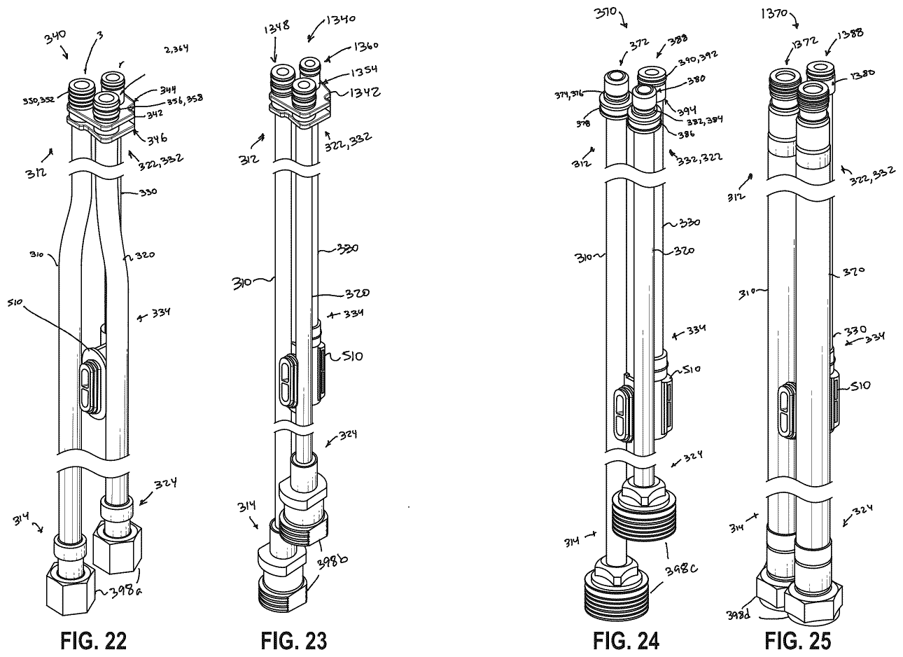

FIG. 22 illustrates a first embodiment of a first type of a water inlet and outlet group 340 configured to be coupled to the valve body housing 140 as a single waterway unit. The first type of a water inlet and outlet group 340 includes connection platform 342 to which the first and second inlet lines 310, 320 and a mixed water line 330 are fixed. The fixing of these lines can be done: (i) during manufacturing (e.g., injection molding) of the group 300, (ii) after the components are manufactured and then the components permanently joined via welding, or (iii) after the components are manufactured and then the components releasably coupled to one another.

Couplers 348, 354, 360 are fixed to the coupling ends 312, 322, 332 of the inlet lines 310, 320 and mixed water line 330 and extend from a first surface 344 of the connection platform 342. The couplers 348, 354, 360 are arranged to be received in the inlet ports 172, 174 and outlet port 176, respectively. Each of said couplers 348, 354, 360 are comprised of at least one recess 350, 356, 362, preferably a plurality of recesses, configured to receive a sealing member 352, 358, 364 (e.g., o-ring). The platform 342 is configured and oriented such that the couplers 348, 354, 360 are positioned to be received within the respective ports 172, 174, 176 of the valve body housing 140 at the same time. The couplers 348, 354, 360 do not include a threaded extent or portion.

The inlet lines 310, 320 of first type of water inlet and outlet group 350 include supply end connectors configured to attach to water supply lines, accordingly. As an example, a first embodiment of first type of a water inlet and outlet group 340 is shown including first and second water inlet lines 310, 320 as PERT or PEX tubes with ⅜″ supply connectors 398a fixed on supply ends 314, 324. Additionally, as shown in FIG. 22, the mixed water outlet line 330 can include first coupler 510 of the mixed water connector 500 to provide a quick connection with coupler 520 that is secured to the water discharge tube 410. The first coupler 510 can be laser welded to mixed water outlet line 330. In other embodiments, first coupler 510 can be replaced with a different mixed water connector 500 based on the defined requirements of a specified faucet or customer.

In FIG. 23, a second embodiment of first type of a water inlet and outlet group 1340 is shown, wherein the first and second water inlet lines 1310, 1320 include PERT or PEX with ½″ supply connectors 398b. It should be understood that across embodiments, like numbers represent like structures. The primary difference between the first and second embodiments of first type of a water inlet and outlet group 340, 1340 is the diameter of the first and second water inlet lines 1310, 1320 and the corresponding supply connectors 398b. In both FIGS. 22-23, the mixed water line 330, 1330 is shown with a first coupler 510 of the mixed water connector 500; however, in some implementations the mixed water line 330 can include an alternate connector and/or mixed water connector configured to provide a fluid connection with the water discharge tube 410. The first type of a water inlet and outlet group 340 can be formed in one piece or assembled. While these examples of connector types include at least some of the types of plumbing connections compatible with the system disclosed herein, this list and the particular diameters given should be treated as exemplary rather than exhaustive.

The first type of a water inlet and outlet group 340, 1340 simplifies manufacturing, increases durability and longevity, and reduces the number of separate parts. The inlet and outlet tubes 310, 320, 330 are coupled to the platform 342, 1342 and not configured to be removable from the waterway unit 340, 1340. The platform 342, 1342 of the waterway unit 340, 1340 can be coupled to the valve body housing 140 with the single water group coupler 600, which eliminates insertion and securing of multiple tubes. The platform 342, 1342 is configured to couple directly to the valve body housing 140, but is not integrally formed with the valve body housing 140. In other words, the platform 342, 1342 is a separate component of the SHUP system 90 from the housing 140. The platform 342, 1342 is held within the valve body housing 140 and does not sit on shelf of faucet housing 20. As such, the platform 342, 1342 does not abut an extent of the faucet housing 20.

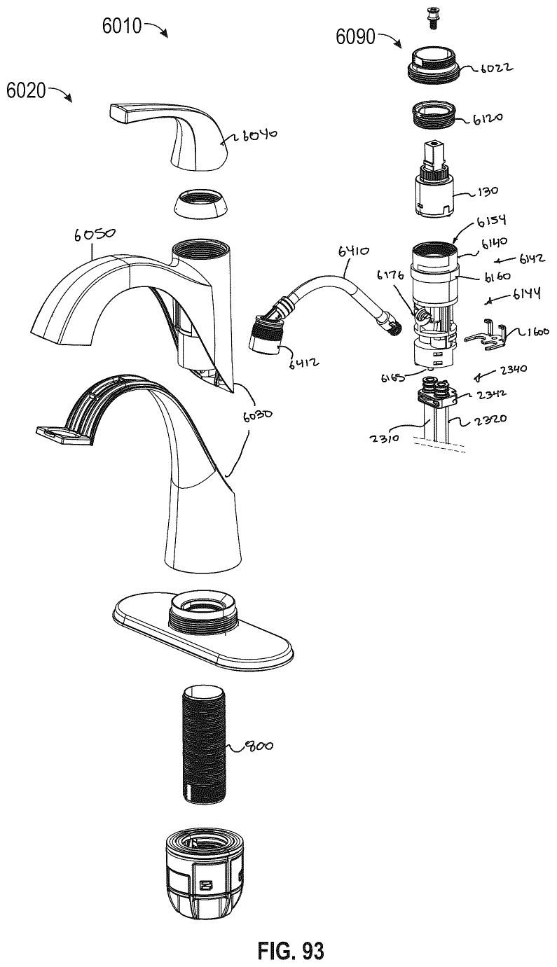

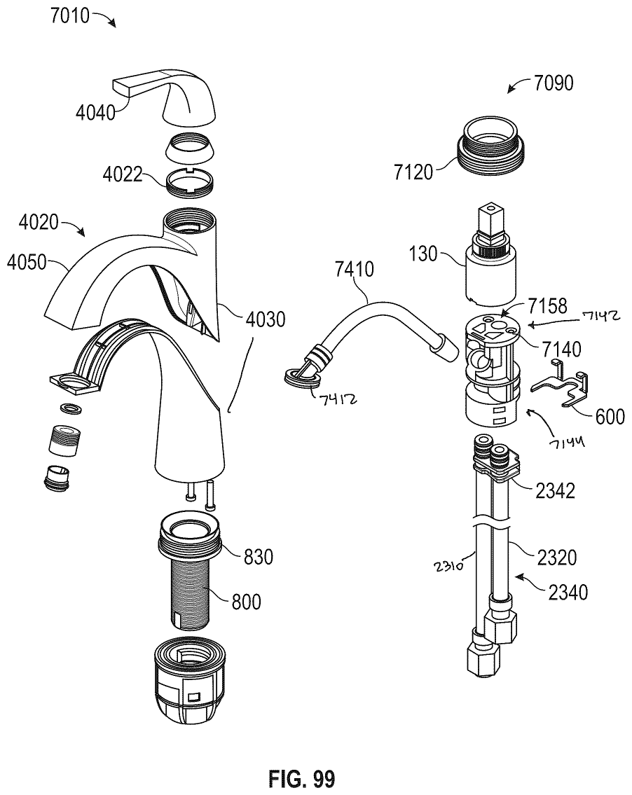

The inlet and outlet lines 310, 320, 330 extend through the platform 342, 1342 having couplers 348, 354, 360 configured to be received within the valve body housing 140 with a friction fit. The couplers 348, 354, 360 are positioned above the platform and include o-rings 352, 358, 364 positioned in coupling recesses 350, 356, 362 and are not threaded, internally or externally. The waterway unit 340, 1340 is positioned in the base wall 170 when an operator applies an upwardly directed linear force Fu that is substantially parallel, if not entirely parallel, with the major or longitudinal axis of the valve body housing 140. In alternative embodiments, the waterway connector 340, 1340 may be secured to the valve body housing 140 using a laterally directed force that is oriented perpendicular to the major or longitudinal axis of the valve body housing 140. An external surface 346 of the platform 342 is aligned with an external surface of the valve body housing 140. In an alternative embodiment, the platform 342 may only include two line or may only include one line (see e.g., FIGS. 93 and 99).

### D. Water Group Coupler

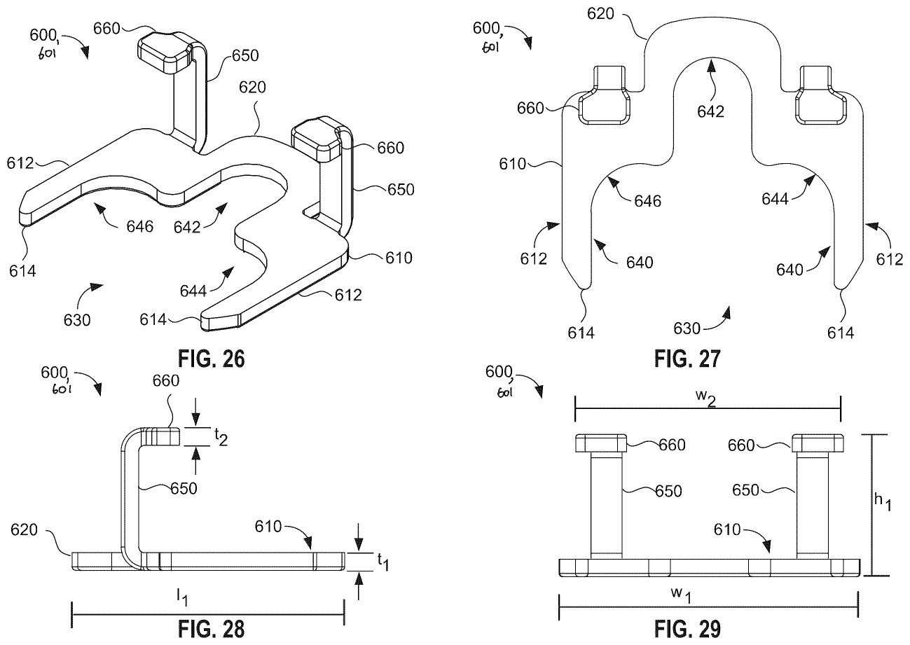

As shown in FIGS. 26-29, the water group coupler 600 can have a shape suitable to secure the water inlet/outlet group 300 to the valve body housing 140. The water group coupler 600 can include: (i) a planar body portion 610 having: (a) a handling portion 620, (b) a receiving portion 630 opposite the handling portion 620, and (c) a pair of members 650 extending in one direction from the planar body portion 610, and (ii) a pair of tabs 660 each extending perpendicularly from a respective arm of the pair of members 650 such that the pair of planar tabs 660 are positioned substantially parallel to the planar body portion 610. The receiving portion 630 can be configured with a pair of arms 640 extending from the handling portion 620 and configured to receive and secure at least a portion of the first and second water inlet lines 310, 320 and the mixed water line 330. The pair of arms 640 being spaced apart and suitable to engage the water inlet and outlet group 300 within the receiving portion 630 to secure the water inlet and outlet group 300 to the valve body housing 140. For example, the receiving portion 630 can be shaped with a first curved indent 642 sized to receive at least a portion of the mixed water line 330, a second curved indent 644 sized to receive at least a portion the first water inlet line 310, and a third curved indent 646 sized to receive at least a portion the second water inlet line 320. The water group coupler 600 can also include a pair of members 650 extending perpendicularly from the planar body portion 610, and a pair of tabs 660 each extending perpendicularly from a respective arm of the pair of members 650 such that the pair of planar tabs 660 are positioned substantially parallel to the planar body portion 610.

The planar body portion 610 further comprising a pair of parallel edge portions 612 along the exterior edges of the pair of arms 640 and pair of tip portions 614 at the distal end of each of the pair of arms 640. The edge portions 612 being substantially flat portions of the exterior edges of the planar body portion 610 on opposite sides of the water group coupler 600. The planar body portion 610 having a width (w₁) between the parallel edge portions 612 and a length (l₁) from the edge of the handling portion 620 to the end of the tip portions 614. As shown in the side view of FIG. 28, the pair of members 650 can extend from the planar body portion 610 with a first bend, such that the pair of members 650 are substantially perpendicular to the planar body portion 610, then have a second bend to the pair of planar tabs 660. The planar body portion 610 can have a thickness (t₁) and the planar tabs 660 can have a thickness (t₂). In some embodiments, t₁ and t₂ are substantially the same. In some embodiments, t₁ is greater than t₂. In some embodiments, t₁ is less than t₂. The pair of members 650 can have a height (h₁) that extends from the outward facing surface of the planar body portion 610 to the outward facing surface of the pair of planar tabs 660. The height between the inward facing surfaces is about the height (h₁) reduced by the thicknesses (t₁+t₂). The planar body portion 610 has an overall width (w₁) between the parallel edge portions 612. The width (w₂) between the exterior edges of the pair of tabs 660 is equal or less than the overall width (w₁) between the parallel edge portions 612. The water group coupler 600 being dimensioned to fit in the first collection of securing structures 290 and the second collection of securing structures 280.

As shown, the pair of members 650 are generally flat and spaced apart, extending from the planar body portion 610 on each side of the handling portion 620. The pair of members 650 being generally parallel to each other with a height (h₁) that provides a separation between the tabs 660 and the planar body portion 610. The water group receiver 144 of the valve body housing is configured such that multiple surfaces of the water group coupler 600 engage with the water group receiver 144 in various configurations. For example, when engaged with the valve body housing 140 and to secure the water inlet and outlet group 300, at least a portion of each of the (i) pair of arms 640 of planar body portion 610, (ii) pair of tabs 660, and (iii) pair of members 650 of the water group coupler 600 are in contact with the water group receiver 144 (see e.g., FIGS. 35 and 48). Although the external features of water group receiver 144 will be described with respect to the example water group coupler 600, other means of connectivity of water inlet and outlet group 300 are possible.

The water group coupler 600 is configured to couple the valve body housing 140 at two positions to accommodate either of a first or second type of inlet and outlet water group 300, accordingly. The water group coupler 600 is configured to be received at a first position of the valve body extension 254 to receive a first type of inlet and outlet water group 300, such that the edge portions 612 of the water group coupler 600 interact with first set of attachment grooves 292 and the tip portions 614 extend at least partially into the apertures 258. Similarly, the water group coupler 600 is configured to be received into a second position of the valve body extension 254 to receive a second type of inlet and outlet water group 300, such that the edge portions 612 of the water group coupler 600 interact with second set of attachment grooves 282 and the tip portions 614 extend at least partially into the apertures 256. The water group coupler 600 is coupled to the valve body housing 140 using a force that is parallel to the support surface and perpendicular to the major axis of the valve body housing 140. The water group coupler 600 cannot be accidently dislodged during use due to the configuration of the valve body housing 140, thus said water group coupler 600 cannot slip out of the received position. The water group coupler 600 may have a friction fit between the upper and lower surfaces of the first collection of securing structures 290 or the second collection of securing structures 280. The water group coupler 600 may not be removable after the first coupling without damage to said water group coupler 600. The water group coupler 600 is also configured to interact with each tube and does not rely on an interaction with a shelf or ledge of the faucet housing 20. Alternatively, the inlet and outlet water group 300 may use other securement means, such as a ball and socket, coupling teeth, ratchet system, etc.

### E. Assembly of First Embodiment of a Water Inlet/Outlet Group

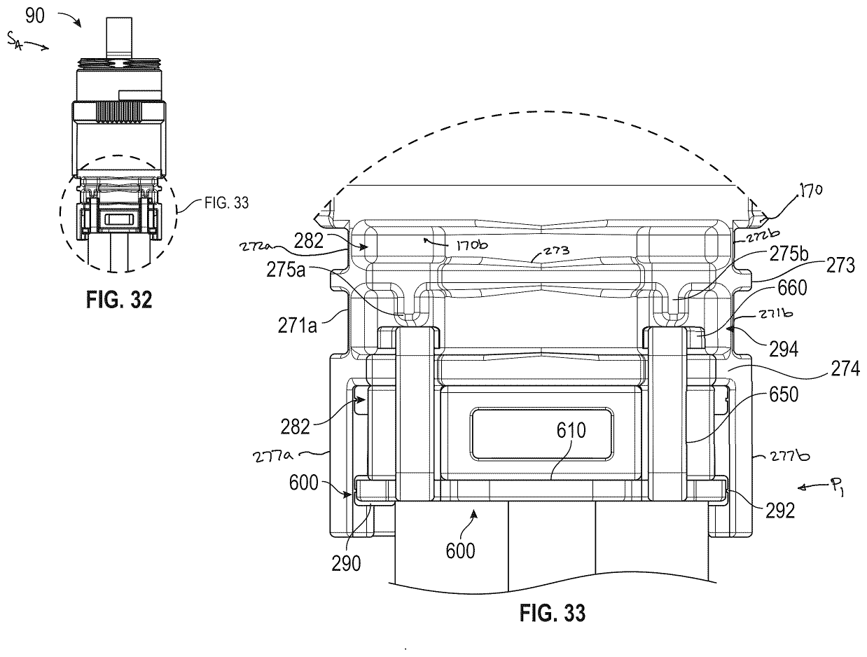

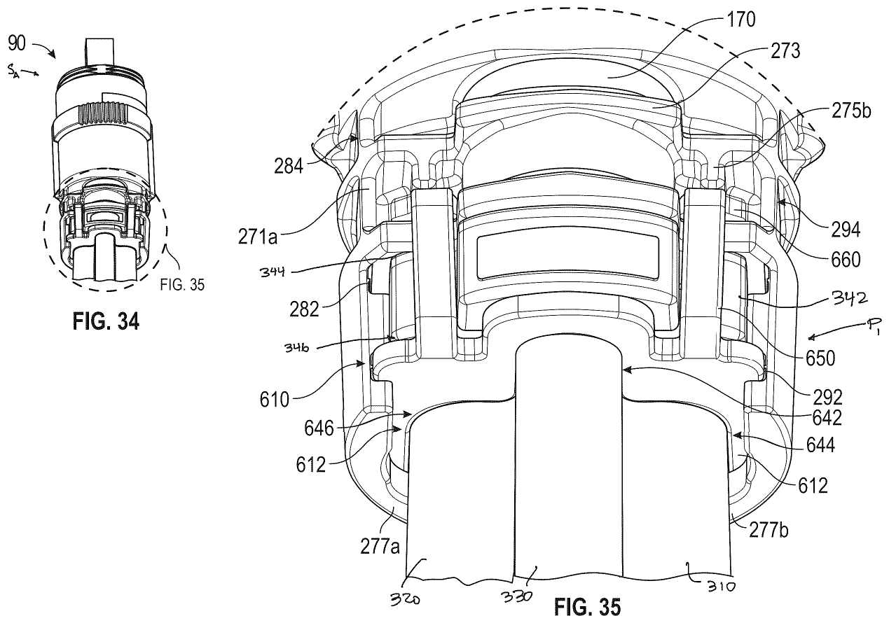

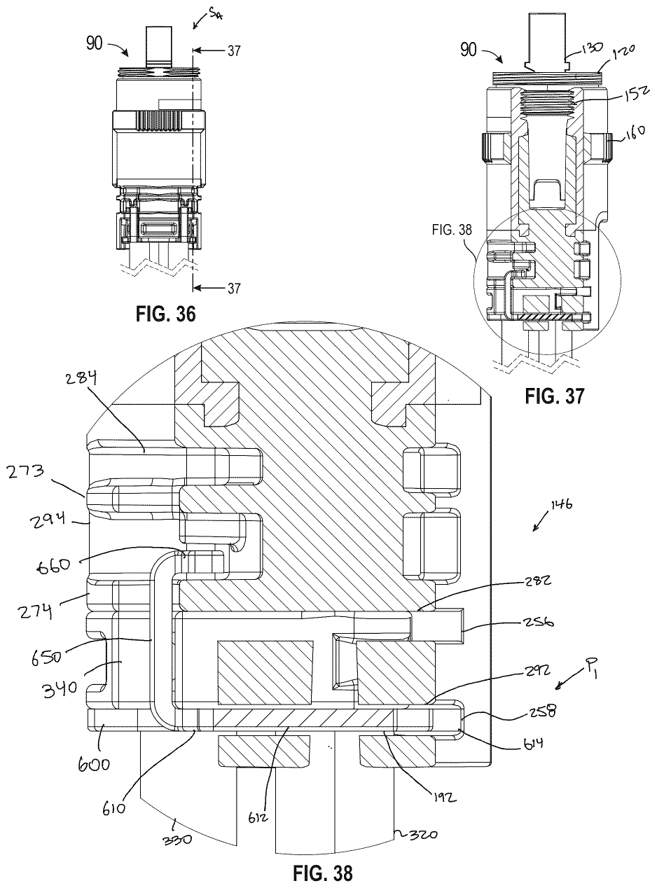

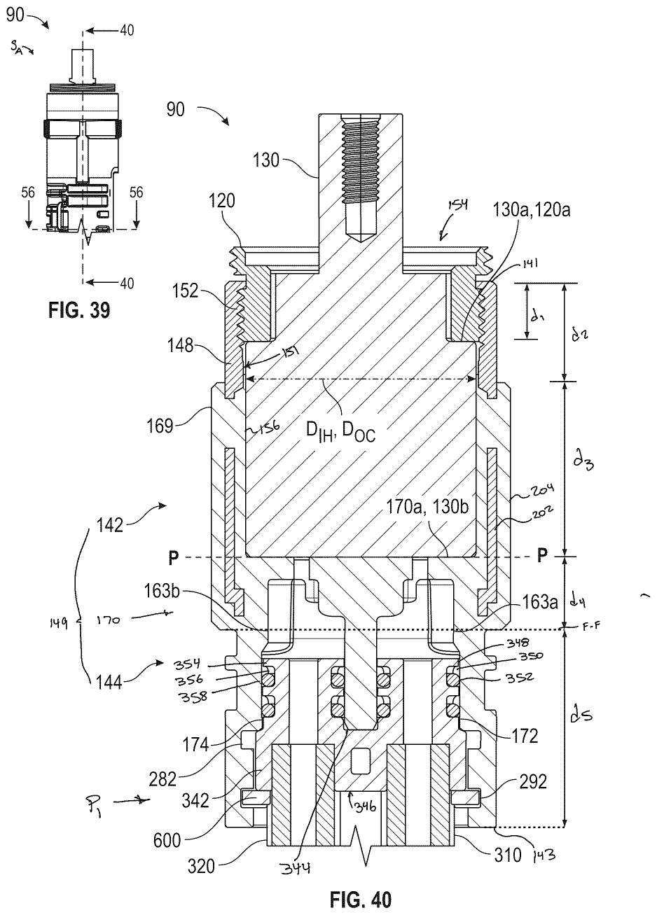

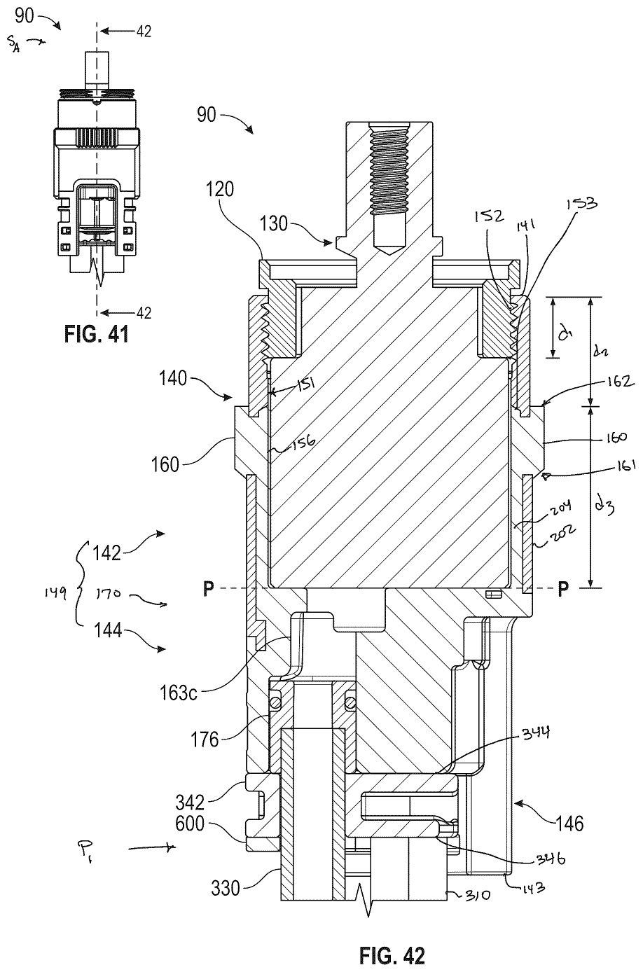

In an example, the first type of water inlet and outlet group 340 in a first embodiment can be coupled to the valve body housing 140 at a first position. The water inlet and outlet group 340 configured as a waterway unit (see e.g., FIGS. 22-23), which includes at least the first and second inlet lines 310, 320 attached to a connection platform 342, can be received in a first position configured to accommodate the thickness of the connection platform 342. An example of the water inlet and outlet group 300 secured by water group coupler 600 in a first position is shown in FIG. 31. The coupling relationship between the water group coupler 600 and the valve body housing in the first collection of securing structures 290 is shown in FIGS. 32-42, with the connection platform 342 in place.

As shown in FIGS. 30-31, the first type of water inlet and outlet group 340 shown in FIGS. 22-23 can be coupled to the valve body housing 140 in a first position using the water group coupler 600 of FIGS. 26-29. To couple the first type of water inlet and outlet group 340 to the valve body housing 140, a first or upwardly directed force F_{U1} is applied to on water inlet and outlet group 340 to position the couplers 348, 354, 360 of the inlet lines 310, 320 and water line 330 into the inlet ports 172, 174 and outlet port 176. Once said couplers 348, 354, 360 are properly seated within these ports 172, 174, 176, then the water group coupler 600 can be aligned with an extent of the valve body housing 140 by aligning: (i) the pair of arms 640 that extend from the handling portion 620 of the water group coupler 600 with the first attachment grooves 292 of the first collection of securing structures 290, and (ii) the pair of tabs 660 that extend from the pair of members 650 with the second tab grooves 294 of the first collection of securing structures 290 (FIG. 30). Once the arms 640 and tabs 660 are aligned with the second attachment grooves 292 and second tab grooves 294, a user or machine can apply a second, lateral force on the water group coupler 600, where that lateral force is oriented at least substantially perpendicular to the longitudinal axis of the valve body housing 140, to cause said water group coupler 600 to slidably engage with the attachment grooves 292 and tab grooves 294 (FIG. 31). Once said second, lateral, or perpendicular force causes the pair of members 650 to be positioned adjacent to an extent of the connection platform 342, the water inlet and outlet group 300 is fully coupled to the valve body housing 140. It should be understood that the water inlet and outlet group 300 can be disconnected from the valve body housing 140 by applying the above steps in the reverse order.

FIGS. 32-42 show various views of the connected SHUP system 90 assembled with a mixing cartridge 130 secured within valve body housing 140 by retaining nut 120 in a secured state and at least a portion of the water inlet and outlet group 300 of FIGS. 22-23 connected by the water group coupler 600 at the base wall 170 of valve body housing 140 in a first position. The water group coupler 600 secured in a first position to accommodate the connection platform 342 of the waterway unit 340 shown in FIGS. 22-23.

### F. Second Embodiment of Inlet/Outlet Group

FIG. 24 illustrates an example of a second type of the water inlet and outlet group 370 as an arrangement of individual first and second inlet lines 310, 320 and a mixed water line 330 configured to couple to the valve body housing 140 at a second position. The second type of water group 370 are provided as individual lines 310, 320, 330 with couplers 372, 380, 388 fixed to the coupling ends 312, 322, 332. Each coupler 372, 380, 388 includes at least one recess 374, 382, 390, preferably a plurality of recesses, configured to receive a sealing member 376, 384, 392 (e.g., o-ring). The couplers 372, 380 of the inlet lines 310, 320 additionally each include an annular groove 378, 386 dimensioned to receive an extent of the water group coupler 600. The coupler 388 of the mixed water line 330 includes a limit face 394 configured to abut the water group coupler 600 when installed in the valve body housing 140 at a second position. Although the individual water lines 310, 320, 330 can be inserted separately into the connection ports 172, 174, 176 of the valve body housing 140, the water inlet and outlet group 370 is coupled with the single water group coupler 600, which eliminates individually securing multiple tubes. The individual tubes 310, 320, 330 with couplers 372, 380, 388 are positioned using an upwardly directed linear force that is parallel with the major axis of the valve body housing 140 and have a friction fit. In the example shown, the first embodiment of the second type of water inlet and outlet group 370 includes individual first and second water inlet lines 310, 320 is shown as copper tubes or pipes with ½″ supply connectors 398c.

In FIG. 25, second embodiment of the second type of water inlet and outlet group 1370 with the individual first and second water inlet lines 1310, 1320 is shown as nylon braided hoses with ⅜″ supply connectors 398d. Although these non-limiting examples show specific materials and connectors, the supply connectors can be configured to couple with ⅜ inch (⅜″) or ½ inch (½″) fittings of water or water supply lines, or other suitable size for the installation. Similarly, the first and second water inlet lines 310, 320 can include standard water supply lines of various lengths such as nylon braided hose, copper tubes or pipes, PERT, or PEX tubes, or other suitable material. In various examples, the first and second inlet lines 310, 320 can be configured for a specific faucet system or faucet housing arrangement and include custom and/or standard plumbing supply lines. In some examples, first and second inlet lines 310, 320 can be chosen with distal end supply connectors provided based on the installation requirements including, but not limited to, the size of the supply line connections. In both FIGS. 24-25, the mixed water line 330 is shown with a first coupler 510 of the mixed water connector 500; however, in some implementations the mixed water line 330 can include an alternate connector and/or mixed water connector configured to provide a fluid connection with the water discharge tube 410. The water inlet and outlet group 300, 1300 as an arrangement of individual first and second inlet lines 310, 320 and a mixed water line 330 allow for additional flexibility in configuration of the single handle universal platform system 90.

### G. Assembly of Second Embodiment of a Water Inlet and Outlet Group

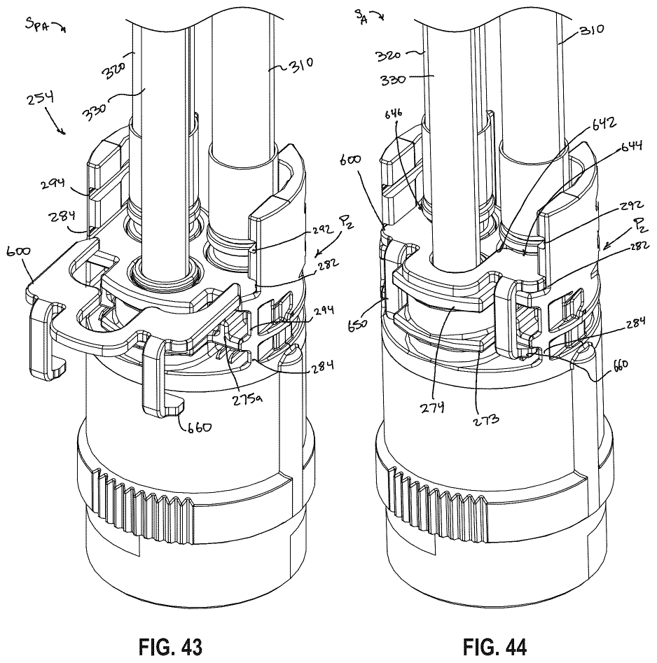

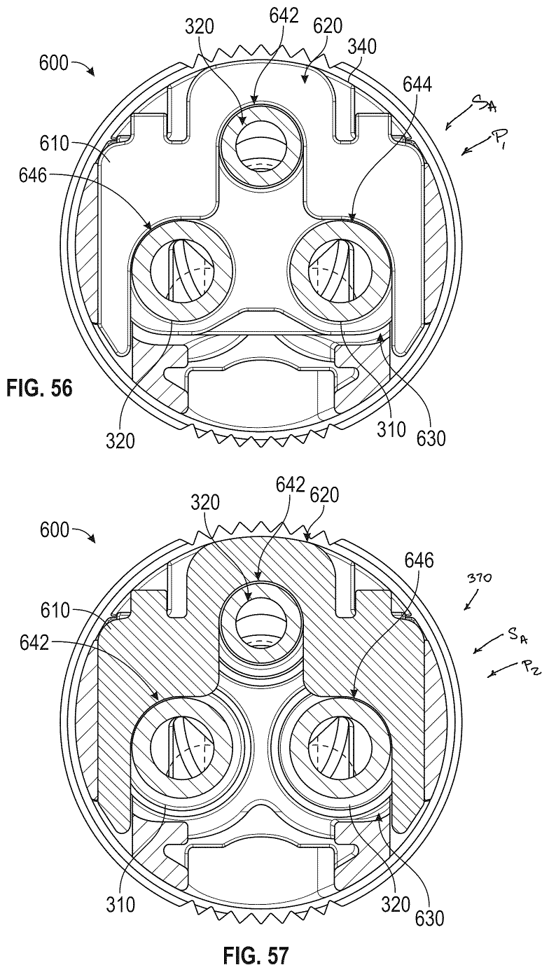

The second embodiment of the water inlet and outlet group 370 is configured to be secured to the valve body assembly 110 with the water group coupler 600 in a second position, as shown in FIGS. 43-57. To couple the second type of water inlet and outlet group 370 shown in FIGS. 24-25 to the valve body housing 140, a first or upwardly directed force F_{U1} is applied to on each of the lines and tubes contained in the water inlet and outlet group 370 in order to position the couplers 312, 322, 332 of the inlet lines 310, 320 and water line 330 into the inlet ports 172, 174 and outlet port 176. Once said couplers are properly seated within these ports 172, 174, 176, then the water group coupler 600 can be aligned with an extent of the valve body housing 140 by aligning: (i) the pair of arms 640 that extend from the handling portion 620 of the water group coupler 600 with the second set of attachment grooves 282 of the second collection of securing structures 280, and (ii) the pair of tabs 660 that extent from the pair of members 650 with the second pair of tab grooves 284 of the second collection of securing structures 280. Once the arms 640 and tabs 660 are aligned with the second set of attachment grooves 282 and second pair of tab grooves 284, a user or machine can apply a second, lateral, or perpendicular force on the water group coupler 600 to cause said water group coupler 600 to slidably engage with the second set of attachment grooves 282 and second pair of tab grooves 284 (FIGS. 43-44). Once said second, lateral, or perpendicular force causes the pair of members 650 to be positioned adjacent to an extent of the water inlet and outlet group 300, the water inlet and outlet group 300 is fully coupled to the valve body housing 140. It should be understood that the water inlet and outlet group 300 can be disconnected from the valve body housing 140 by applying the above steps in the reverse order.

### H. First Embodiment of Mix Water Connector

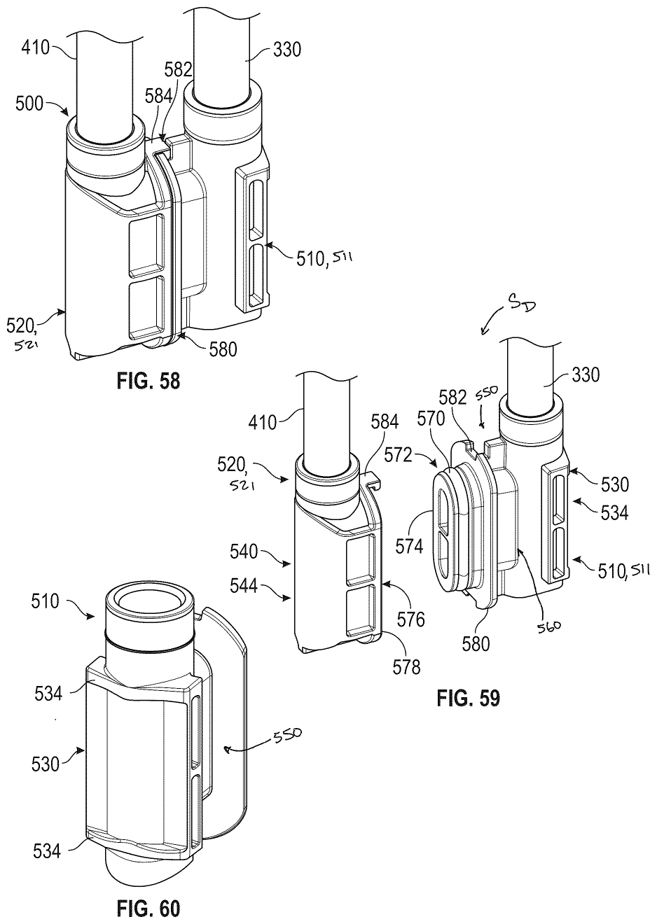

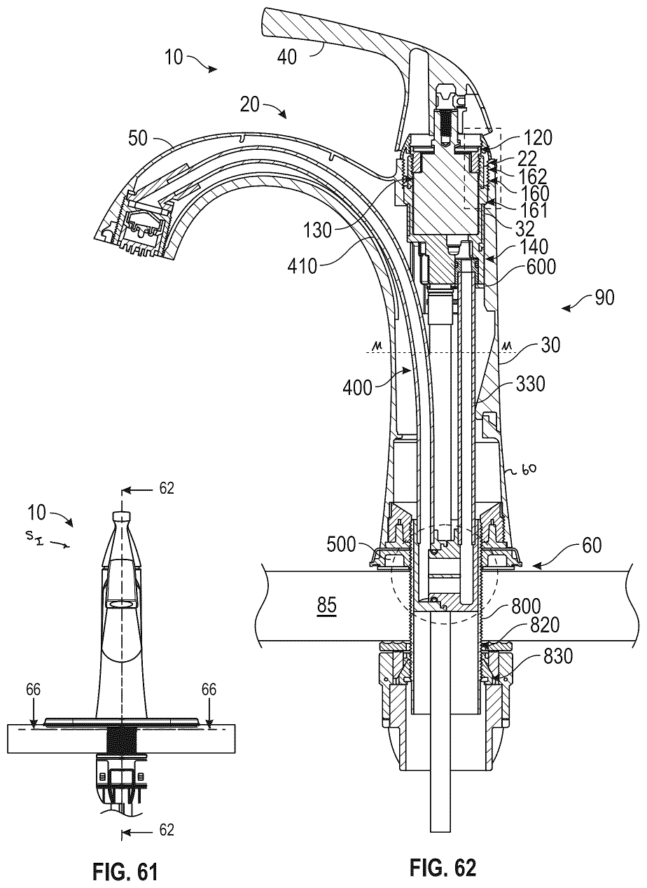

FIGS. 58-60 and 63 show the mixed water connector 500 in greater detail. The mixed water connector 500 of the SHUP system 90 provides a fluid connection between the mixed water line 330 and the water discharge tube 410. In this example, the mixed water connector 500 includes a first coupler 510 attached at a distal end of the mixed water line 330 and a second coupler 520 attached at a distal end of the water discharge tube 410. The mixed water line 330 and water discharge tube 410 tube are arranged in parallel and coupled to the first and second couplers 510, 520, respectively. The first and second couplers 510, 520 are shown as laser welded, sonic welded, or otherwise adhered to the tubes 330, 410. FIG. 59 shows a perspective view of a disconnected mixed water connector 500 in a disconnected state S_{D} with the sealing ring 570 (e.g., o-ring) between the water outlet male and female connectors 511, 521 (first and second couplers 510, 520) is shown. The sealing ring 570 is positioned on an outlet portion 572 of the male connector 511 defined between an outlet end 574 and a stop 580 formed in the male connector 511. As best shown in FIGS. 65 and 67, the mixed water connector 500 has an internal passage 590. Said internal passage 590 of the first coupler 510 can include a portion 594 substantially aligned with the direction of the attached mixed water line 330 and at least one lateral portion passage 596 to flow and connect with the internal passage 592 of the second coupler 520. The mixed water connector 500 may be configured with two separate lateral portion passages 596. Portions 594 and 596 of the internal passage 590 are configured to provide fluid flow from the mixed water tube 310 to the outlet end 574. Similarly, said internal passage 590 of the second coupler 520 can include a portion 592 substantially aligned with the direction of the attached water discharge tube 410 to receive fluid flow from the internal passage portion 594 of the first coupler 510. In the embodiment shown in the Figures, the couplers 510, 520 have a middle or supporting component that forms two separate passages. Said middle bridging component helps provide additional rigidity to the connection, preventing the couplers 510, 520 from collapsing under pressure. It should be understood that additional supporting components (e.g., 3-10) may be included within the couplers 510, 520 or said supporting components may be omitted.

When coupled (as shown in FIG. 58), the outlet portion 572 of the male connector 511 is received into the inlet portion 576 of the female connector 521 and an inlet end 578 of the female connector 521 abuts the stop 580 of the male connector 511 forming a fluid connection between the mixed water line 330 and the water discharge tube 410. In various examples, the stop 580 of the male connector 511 includes a catch 582 on opposing edges of the stop 580 and the female connector 521 includes a latch 584 extending from the inlet end 578 on opposing edges of the female connector 521. When coupled, the latch 584 can engage with the catch 582 to secure the connection of water outlet male and female connectors 511, 521 of the mixed water connector 500. It should be understood that other ways of coupling the couplers 510, 511, 520, 521 to one another is contemplated by this disclosure. For example, the couplers 510, 511, 520, 521 may include: (i) longitudinal grooves that allow for slidably coupling or (ii) threads for rotational coupling.

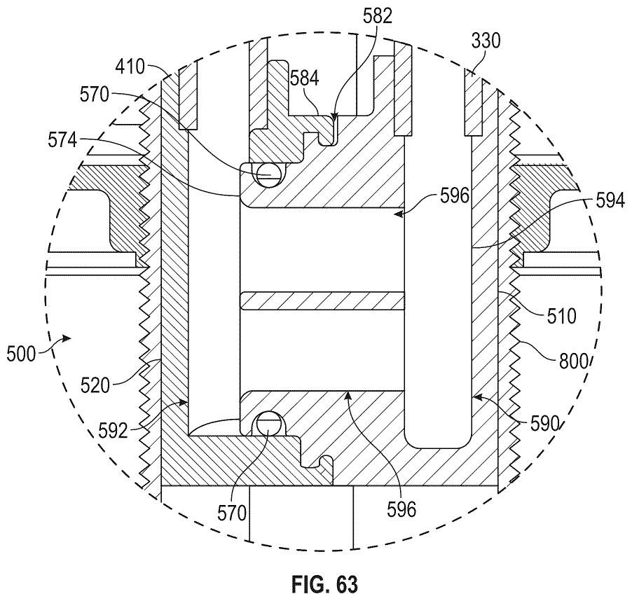

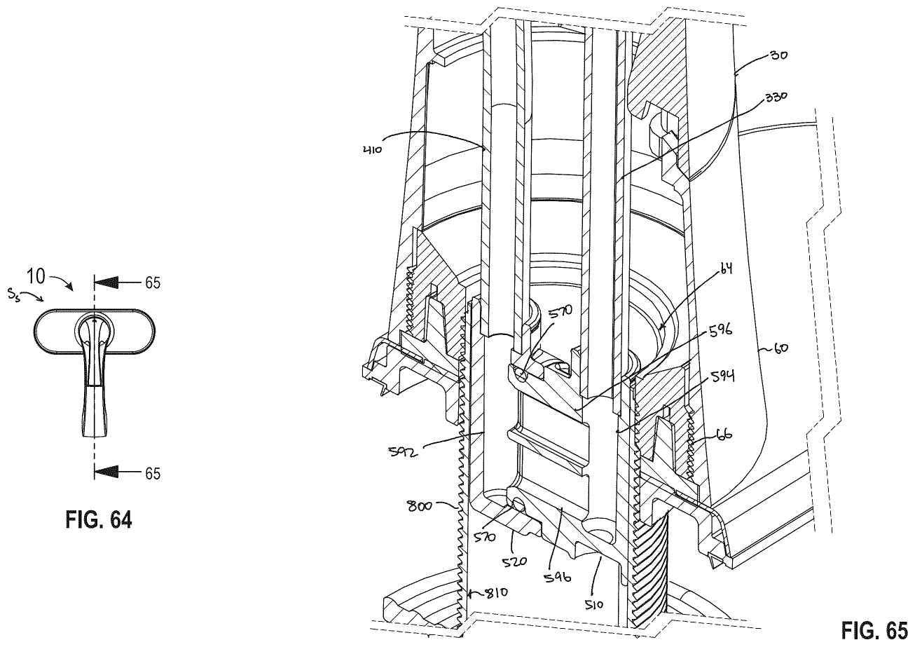

FIG. 63 is a zoomed-in view of the cross-sectional image of the mixed water connector 500 of FIG. 62, wherein said mixed water connector 500 is shown positioned within the aluminum mounting shank 800 that is positioned within/through an extent of a mounting surface 85. This design allows the mounting shank 800 to accommodate the mixed water connector 500, including connections from both the water inlet and outlet group 300 and the water discharge tube 410. Further, in at least some embodiments, this meets the 1-⅛″ installation holes in a typical basin. In the illustrated design, the water discharge tube 410 connection is concealed inside the mounting shank 800, which eases installation and minimizes externally exposed parts for a more clean aesthetic presentation. Further, the inner wall of the mounting shank 800 holds and reinforces the mixed water connector 500 in a connected position, which enhances the reliability of the connection. The mounting shank 800 is shown affixed to a nut assembly 830, such that the mounting shank 800 extends through a mounting surface 85 (e.g., countertop), in an installed position of the single handle water faucet 10 (see FIGS. 1 and 2S. In other embodiments the mounting shank 800 can be crafted from brass, steel, or other materials.

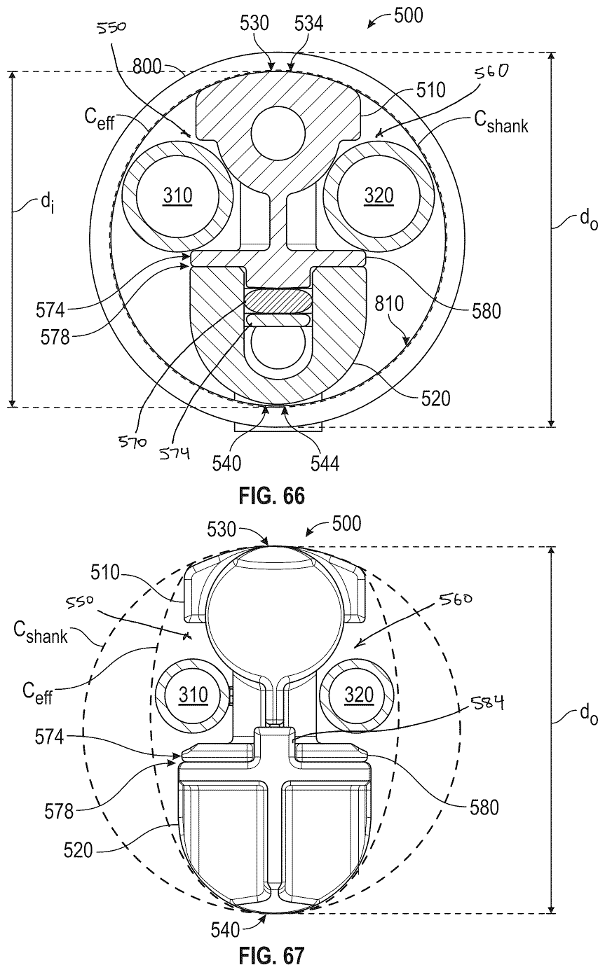

As best shown in FIGS. 66-67, the first coupler 510 of the mixed water connector 500 has an external surface with a curvilinear extent 530, while the second coupler 520 of the mixed water connector 500 also has an external surface with a curvilinear extent 540. The curvilinear extents 530, 540 have substantially similar radiuses to one another. Additionally, the radiuses of the curvilinear extents 530 and 540 are substantially similar to the radius of the internal surface of the mounting shank 800. Additionally, the outer diameter (dₒ) that extends between the curvilinear extents 530, 540 is substantially similar to the inner diameter (dᵢ) of the mounting shank 800. Specifically, the outer diameter do of the mixed water connector 500 that is formed when the first coupler 510 is secured to the second coupler 520 is between 50% and 99% of the inner diameter dᵢ of the mounting shank 80, preferably between 75% and 99% of the inner diameter dᵢ, and most preferably between 85% and 99% of the inner diameter dᵢ. It should be noted that that ratio between any number between 50% and 99%.

Due to the fact that the inner and outer diameters are substantially similar, at least a portion of curvilinear extents 530, 540 are configured to abut opposite portions of the interior surface 810 of the mounting shank 800. The abutting of these surfaces 530, 540, 810 forms: (i) a first external engagement region 534 of the first coupler 510 (e.g. male connector), (ii) a second external engagement region 544 that is formed as part of the water inlet second coupler 520 (e.g. female connector), and (iii) opposed internal engagement regions 812a, 812b. The external engagement regions 534, 544: (i) extend along a substantial length of the mixed water connector 500, and (ii) are positioned parallel with the opposed internal engagement regions 812a, 812b. This configuration helps ensure that the mixed water connector 500 cannot pivot within the mounting shank 800. When the faucet is installed in the shank 800, the first and second couplers 510, 520 maintain a leak free connection even if the top and bottom latch 584 are temporarily displaced. The first and second couplers 510, 520 are secured to one another using a compressive force that is parallel with the support surface and perpendicular to the major axis of the faucet The first coupler 510 of mixed water connector 500 includes a first external recess 550 and a second external recess 560 formed on opposite sides of the first coupler 510. The coupled first and second couplers 510, 520 are positioned within the mounting shank 800 and the first and second water inlet lines 310, 320 are positioned between (i) the first and second recesses 550, 560 of the first connector 510 and (ii) the internal surface of the mounting shank 800. An outer extent of the coupled first and second couplers 510, 520 together with an outer extent of the first and second water inlet lines 310, 320 have an effective outer periphery (c_{eff}). Said effective outer periphery (c_{eff}) that is formed from a combination of the outer surfaces of the mixed water connector 500 and the first and second water inlet lines 310, 320 is between 50% and 99% of the inner periphery (cₛₕₐₙₖ) of the mounting shank 800, preferably between 75% and 99% of the inner periphery (cₛₕₐₙₖ), and most preferably between 85% and 99% of the inner periphery (cₛₕₐₙₖ). It should be noted that that ratio between any number between 50% and 99%.

In some embodiments, as shown in FIG. 66, the effective outer periphery (c_{eff}) may be circular and can be referred to as an effective outer circumference and the inner periphery (cₛₕₐₙₖ) may be circular and can be referred to as an inner circumference. In this embodiment, the effective outer circumference (c_{eff}) may be within 1% of the inner circumference (cₛₕₐₙₖ). Having the outer circumference (c_{eff}) be substantially similar to the inner circumference (cₛₕₐₙₖ), causes the first and second external engagement regions 534, 544 and extents of the first and second water inlet lines 310, 320 abut portions of the interior surface 810 of the mounting shank 800. This configuration causes a wedging effect that: (i) increases the reliability of the connection, (ii) reduces the chance that the first and second water inlet lines 310, 320 can vibrate or shutter within the mounting shank 800, and (iii) reduces installation errors.

In an alternative embodiment, as shown in FIG. 67, the diameters of the first and second water inlet lines 310, 320 can be reduced in comparison to the embodiment shown in FIG. 66. This reduction in the diameters of the first and second water inlet lines 310, 320 does not create an effective circular outer circumference; instead, the effective outer periphery (c_{eff}) has a curvilinear or oval shape, which is not substantially similar to the inner periphery (cₛₕₐₙₖ) of the mounting shank 800. Because said outer periphery (c_{eff}) is not substantially similar to the inner periphery (cₛₕₐₙₖ) of the mounting shank 800, a wedging effect of the first and second water inlet lines 310, 320 is not formed. Nevertheless, the mixed water connector 500 disclosed in this embodiment is still substantially reliable do to the fact that it has a similar configuration as the configuration that is discussed above.

### I. Assembly of the Faucet

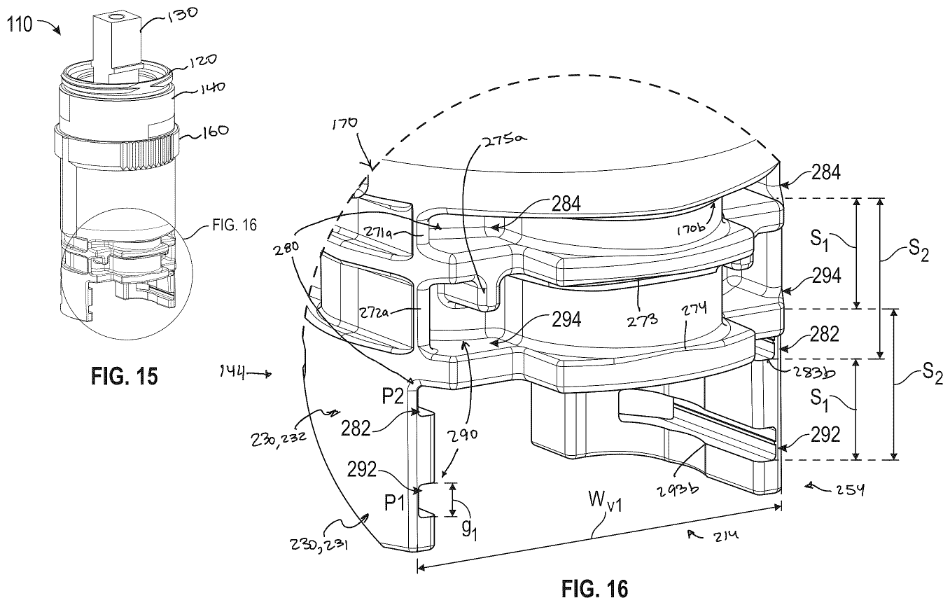

The process for assembling the faucet system 10 includes inserting a mixing cartridge 130 in a valve body housing 140 and thready coupling the retaining nut 120 to the valve body housing 140 to form a secured state. Once said assembly in in the secured state, the valve body assembly 110 (e.g. FIG. 15) is assembled in a single unit. The water inlet and outlet group 300 is then attached to the valve body assembly 110. As discussed above, the valve body housing 140 is configured to receive a first embodiment of the water inlet and outlet group 300, shown as a waterway unit 340 that includes a platform 342 (FIG. 22-23) or a second embodiment of the water inlet and outlet group 300 that includes individual inlet lines 310, 320 and outlet line 330 (FIG. 24-25).

The first type of the water inlet and outlet group 340 (FIGS. 22-23) can be positioned such that couplers 348, 354, 360 extending from platform 342 align with ports 172, 174, 176, respectively. A water group coupler 600 is then installed to retain the water inlet and outlet group 340. As shown in FIG. 30, the planar body portion 610 of the water group coupler 600 engages with the grooves 292 of the valve body housing 140. The water group coupler 600 can then slide over the second platform surface 344 to secure the first type of the water inlet and outlet group 340. As shown in FIG. 31, when assembled, the tabs 660 are coupled to the tab grooves 294 and the receiving portion 630 engages with an extent of mixed water line 330 at the first curved indent 642, an extent of first inlet line 310 at the second curved indent 644, and an extent of second inlet line 320 at the third curved indent 646.

The second type of the water inlet and outlet group 370 (FIG. 24-25) includes individually inserting the couplers 372, 380, 388 of the water lines 310, 320, 330 into ports 172, 174, 176, respectively. As shown in FIG. 43, the planar body portion 610 of the water group coupler 600 engages with the second set of attachment grooves 282 of the valve body housing 140. The water group coupler 600 can then slide to couple the second type of the water inlet and outlet group 340 to the valve body housing 140. As shown in FIG. 44, when assembled, the tabs 660 are coupled to the second pair of tab grooves 284 and the receiving portion 630 engages with an extent of the limit face 394 of the mixed water line coupler 388 at the first curved indent 642, an extent of the annular groove 378 of first inlet line coupler 372 at the second curved indent 644, and an extent the annular groove 386 of second inlet line coupler 380 at the third curved indent 646.

The valve body assembly 110 and coupled water inlet and outlet group 300 is then placed into the main body 30 of the faucet housing 20 and affixed by a locking nut 22. The valve body housing 140 lacks exterior threads and is configured to receive the lock nut 22 around the smooth exterior surface of the upper housing wall 148. As noted above, the valve body housing 140 only includes an internal threaded portion 152 configured to receive the retaining nut 120 to hold the cartridge 130 inside the valve body housing 140. As shown in the cross-sectional view of assembled faucet system 10 in FIG. 62, the valve assembly 110 is positioned within the main body 30 such that the annular band 160 extending from the valve body housing 140 is interacts with an internal step 32 of the faucet housing 20. In particular, the second (lower) edge surface 161 of the annular band 160 is in contact with the internal step 32 of the main body 30 of the faucet housing.

As best shown in FIG. 68, the retaining nut 120 includes exterior threads that are cooperatively dimensioned to be received by the internal threaded portion 152 of the valve body housing 140, wherein the interaction of the exterior and interior threads is designed to secure the mixing cartridge 130 within the valve body housing 140. Additionally, the lock nut 22 includes exterior threads that are cooperatively dimensioned to be received by the internal threaded portion of the faucet housing 20, wherein the interaction of the exterior and interior threads is designed to sandwich the annular band 160 of the valve body housing 140 between said shelf 32 of the housing 20 and the nut 22 in order to secure the valve body housing 140 within the faucet housing 20. To thread the nut 22 into the housing 20, the lock nut 22 includes notches 24 in an upper extent to that are designed to receive a specialized tool. Based on this disclosure, a single nut or coupler is not utilized to secure the valve body housing 140 and the mixing cartridge 130 within the faucet housing 20. Similarly, the mixing cartridge 130 is not simply secured to the faucet housing 20 with a single component (e.g., nut or another coupling means). Instead, the faucet system 10 uses an indirect coupling method to secure the mixing cartridge 130 within the housing 140, and then to secure the housing 140 within the faucet housing 20. This configuration may not be optimal in certain faucet designs, but it enables the disclosed system 10 to be modular and provide the numerous benefits described above.

The water discharge tube 410 is separately installed in spout 50 of the faucet housing 20 and includes coupler 520 on one end. The mixed water connector 500 is formed by securing the first coupler 510 coupled to the mixed water line 330 and the second coupler 520 coupled to the water discharge tube 410. The mounting shank 800 is then installed over the mixed water connector 500, and a handle set 40 is installed to finalize the product. The SHUP system 90 can be provided as a fully assembled system contained within a faucet system in a shipped state S_{S}, ready to install. The SHUP system 90 can be provided as separately from the faucet housing 20 to be assembled by another.

### J. Alternative Assemblies of the Faucet Body Housing

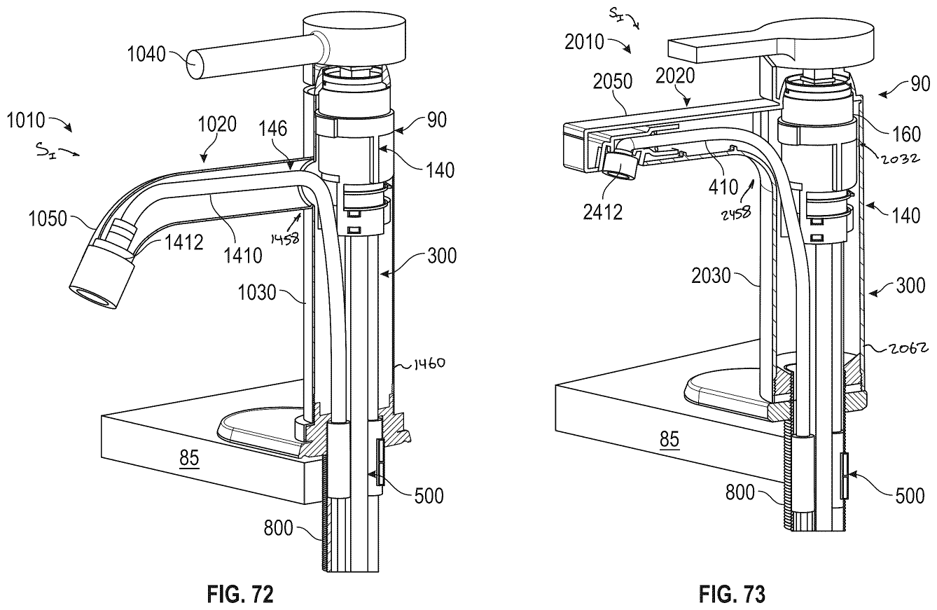

FIG. 72 shows an example of a tubular spout shape faucet 1020 with a portion of the faucet housing 1010 removed to reveal the assembled SHUP system 90 of FIG. 3. As shown, the water discharge tube 410 is flexible and can be adapted to the shape of the tubular spout 1050, with the front recess 146 providing additional clearance for the arrangement of water discharge tube 410. Similar to the curved spout faucet shown in FIG. 62, the coupled first and second couplers 510, 520 are positioned within the mounting shank 800 and the first and second water inlet lines 310, 320 are positioned between the first and second recesses 550, 560 of the first coupler 510 and the internal surface of the mounting shank 800. The faucet outlet adapter 1412 can be attached to the water discharge tube 410 and secured to the spout 1050.

FIG. 73 show an example of a flat spout shape faucet 2010 with a portion of the faucet housing 2010 removed to reveal the corresponding internal systems. FIG. 73 shows SHUP system 90 of FIG. 3 installed within the faucet housing 20, with an outlet adapter 2412 suitable for the flat spout shape faucet. The valve body assembly 110 is positioned within the main body 2030 with annular band 160 in contact with at least step 2032 to limit movement of the SHUP system 90 within the faucet housing 2010. As shown, the faucet outlet tube 2410 is flexible and can be adapted to the shape of the flat spout. Similar to the curved spout faucet shown in FIG. 62, the coupled first and second couplers 510, 520 are positioned within the mounting shank 800 and the first and second water inlet lines 310, 320 are positioned between the first and second recesses 550, 560 of the first connector and the internal surface of the mounting shank 800.

In various examples, the water discharge tube 410 and/or the water discharge tube adapter 412 can be adapted to correspond to the selected faucet housing without substantially changing the SHUP system 90. As provided as an example water discharge tube 410 herein, various figures illustrate the water discharge tube 410 shown with a second coupler 520 of the mixed water connector 500 on one end and an outlet adapter 412 at the other end the water discharge tube 410 to dispense water. The example water discharge tube 410 shown herein can be made of PERT over-molded or laser welding one-piece construction to include the second coupler 520. This has an advantage in the manufacturing and assembly process as well as the water safety, and also can be more cost efficient. For example, the water discharge tube 410 can be formed as a one-piece outlet tube in PERT, or other material safe for drinkable water, by over-molding or laser welding the second coupler 520 to minimize leakage. The material can be flexible to allow configuration with a multitude of faucet shapes. Alternatively, the water discharge tube 410 can be formed in copper in one piece. In another example water discharge tube 410 includes a braided hose with a riveted connection to the second coupler 520 of the mixed water connector 500 on one end and an outlet adapter 412 at the other end the water discharge tube 410.

In some examples, the faucet outlet tube can be assembled using multiple parts that can be coupled by a threaded, snap, compression fit, or other suitable means. In an example, the water discharge tube 410 can comprise an outlet adapter 412 and second coupler 520 provided separately from the water discharge tube 410. In another example, the second coupler 520 can be formed with the water discharge tube 410 and the outlet adapter 412 provided separately configured to couple with the water discharge tube 410. In a third example, the water discharge tube 410 can be provided in two pieces, where the outlet adapter 412 is attached to a first portion of the water discharge tube 410 and the second coupler 520 attached to a second portion of the water discharge tube 410, with a coupling portion on both the first and second portions to provide a fluid connection. Although these examples are shown with the second coupler 520 of mixed water connector 500, other mixed water connector arrangements or connectors 1500, 2500, 3500, 4500, 5500, 6500, and 7500 can be relied on for similar faucet outlet tube arrangements.

### K. Alternative Embodiments of Valve Body Housing

The SHUP system 90 can be configured to include various embodiments of the valve body housing 140, using the same or alternate embodiments or assemblies of the water inlet and outlet group 300, the mixed water connector 500, and water discharge tube 410. For example, as shown in FIGS. 74-82, the valve body housing 140 can be replaced with valve body 1140, 2140, 3140, 4140, 5140, 6140, or 7140. The common feature of the alternate embodiments is the guard extensions of the water group receiver that are configured to accept water group coupler 600 at two levels for attachment of at least the inlet lines 310, 320. Although the water inlet and outlet group 300 is shown as a waterway unit 340 in various examples, the alternate embodiments of the valve body housing can receive individual inlet and outlet lines as described with respect to valve body housing 140, including the option to secure the water inlet and outlet group 300 at a first or second position. The alternate embodiment of a valve body housing may be selected based on the configuration of the faucet housing, customer specifications, or other requirements. This illustrates the modularity of the system, which aids in the ability to fit more than 80% of the single handle lavatory faucets and to reduce the number of parts that a manufacturer needs to stock.

### I. Second Embodiment of the Valve Body Housing

Shown as a second valve body housing embodiment in FIG. 74, a valve body housing 1140 has the same features as a valve body housing 140 described above with alternate alignment features. For sake of brevity, the above disclosure in connection with valve body housing 140 will not be repeated below, but it should be understood that across embodiments, like numbers represent like structures. For example, the disclosure relating to valve body housing 140 applies in equal force to valve body housing 1140. The primary difference between the first embodiment of the valve body housing 140 and this second embodiment of the valve body housing 1140 relates to the addition of extended ribs 1220 protruding from the exterior surface 1212 of the valve body extensions 1254 and aligned with ribs 1169.

As shown as an example in FIG. 74, the valve body housing 1140 includes an annular band 1160 that can include spline teeth 1164 at the front and rear of the valve body housing 1140. The ribs 1169 on opposite sides of the valve body housing 1140 extend from the annular band 1160 on an exterior portion of the upper housing wall 1148 to the water group receiver 1144. Valve body housing 1140 further includes at least one extended rib 1220, preferably two extended ribs 1220, protruding from the exterior surface 1212 of the valve body extension 1254 and aligned with ribs 1169. The extended ribs 1220 may have a similar shape or profile as the ribs 1169 with rounded, tapered, or beveled ends. Although the ribs 1169 and extended ribs 1220 are separated in the example shown, in some examples, the ribs 1169 and extended ribs 1220 may be continuous (e.g., not separate).

ii. Third Embodiment of the Valve Body Housing

Shown as a third valve body housing embodiment in FIGS. 75-77, a valve body housing 2140 has the same features as a valve body housing 140 described above with alternate alignment features. For sake of brevity, the above disclosure in connection with valve body housing 140 will not be repeated below, but it should be understood that across embodiments, like numbers represent like structures. For example, the disclosure relating to valve body housing 140 applies in equal force to valve body housing 2140. The primary difference between the first embodiment of the valve body housing 140 and this third embodiment of the valve body housing 2140 relates to the omission of ribs 1169 on opposite sides of the valve body housing 140 extending from the annular band 160 to an exterior portion of the water group receiver 144.

Omitting ribs 169 allows for the valve body housing 2140 be positioned with faucet housings that are not configured with positioning slots, but have a step onto which the annular band 2160 can rest. The annular band 2160 can include spline teeth 2164 at the front and/or rear of the valve body housing 2140. Similar to the valve body housing 140, the annular band 2160 of valve body housing 2140 is configured to rest on the step 32 within the main body 30 of a faucet housing 20, when installed in the faucet housing 20.

iii. Fourth Embodiment of the Valve Body Housing

Shown as a fourth valve body housing embodiment in FIG. 78, a valve body housing 3140 has the same features as a valve body housing 140 described above with alternate alignment features. For sake of brevity, the above disclosure in connection with valve body housing 140 will not be repeated below, but it should be understood that across embodiments, like numbers represent like structures. For example, the disclosure relating to valve body housing 140 applies in equal force to valve body housing 3140. The primary difference between the first embodiment of the valve body housing 140 and this fourth embodiment of the valve body housing 3140 relates to the omission of ribs 169 on opposite sides of the valve body housing 140 and the addition of a pair of anti-rotation ribs 3166 extending along the exterior surface of the valve body housing 3140 from the annular band 3160 for a rib length toward the water group receiver 3144.

Different from ribs 169 of valve body housing 140, the rib length of the anti-rotation ribs 3166 may be shorter than the full distance from the annular band 3160 to the water group receiver 3144. Additionally, the anti-rotation ribs 3166 may be positioned in the front and/or back of the valve body housing 3140. The annular band 3160 can include spline teeth 3164 at the front and/or rear of the valve body housing 3140 or at the sides of the valve body housing 3140. In some examples, the anti-rotation ribs 3166 extend downward from an extent of the annular band 3160 overlapping the spline teeth 3164. In some examples, the anti-rotation ribs 3166 are positioned in the front and/or back of the valve body housing 3140 and the spline teeth 3164 are positioned on the sides. In some examples, the valve body housing 2140 also includes a second anti-rotation rib 3167, where the first anti-rotation ribs 3166 extend on opposing sides from the annular band and the second anti-rotation rib 3167 protrudes from a back surface of the waterway interface 3144 and is aligned with a corresponding first anti-rotation rib 3166. Similar to the valve body housing 140, the annular band 3160 of valve body housing 3140 is configured to rest on the step 32 within the main body 30 of a faucet housing 20, when installed in the faucet housing 20.

iv. Fifth Embodiment of the Valve Body Housing

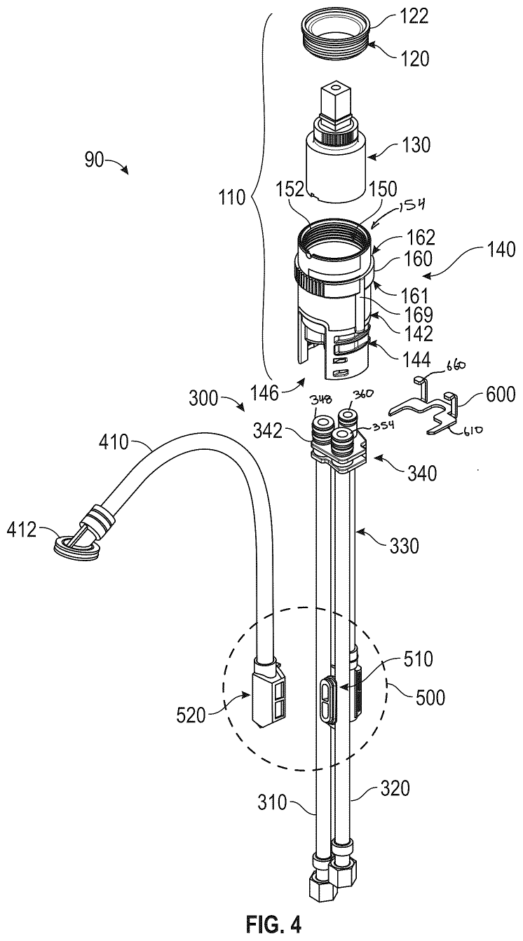

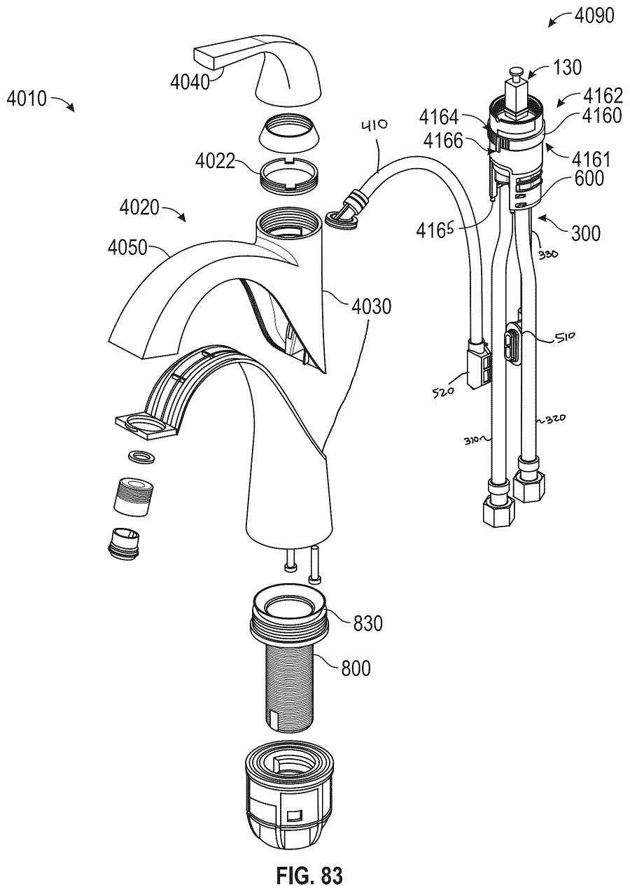

FIG. 83 shows an exploded view of an example alternate faucet system 4010 that includes alternate faucet housing 4020 and SHUP system 4090 that includes valve body housing 4140. Similar to the previous embodiments, the valve body assembly 4110 includes the valve body housing 4140, mixing cartridge 130, and retaining nut 120. The SHUP system 4090 includes valve body assembly 4110, inlet and outlet group 300, water group coupler 600, mixed water connector 500, and water discharge tube 410 configured for the faucet housing 4020, which includes a step 4038 onto which the valve body housing 4140 is seated (FIG. 86). The SHUP system 4090 can be assembled by replacing valve body housing 140 (shown in FIG. 4) with valve body housing 4140, where all other components of the assembly are the same as SHUP system 90. Although the water inlet and outlet group 300 is shown as a waterway unit 340, the valve body housing 4140 can receive individual inlet and outlet lines as described with respect to valve body housing 140, including the option to secure the water inlet and outlet group 300 at a first or second level.

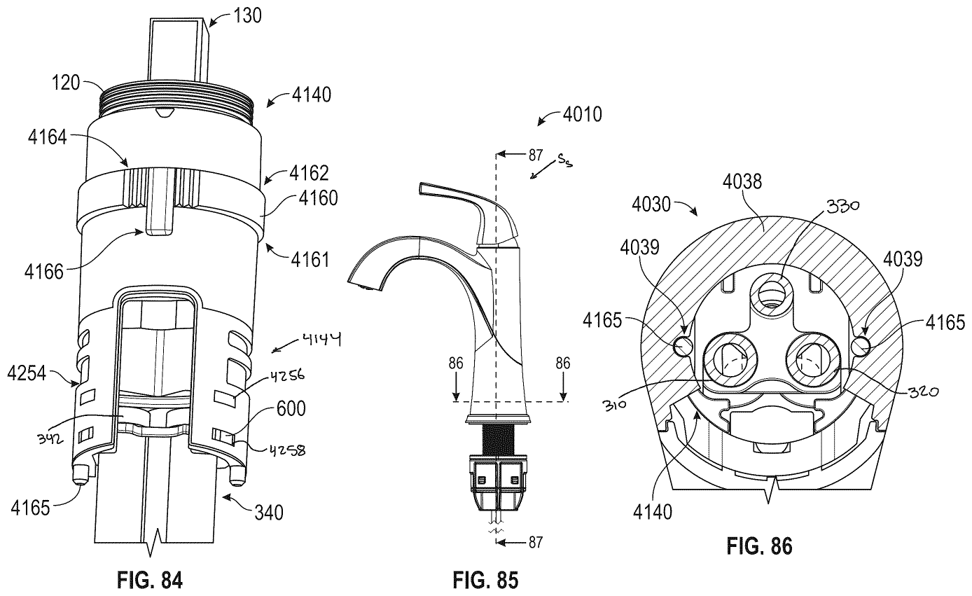

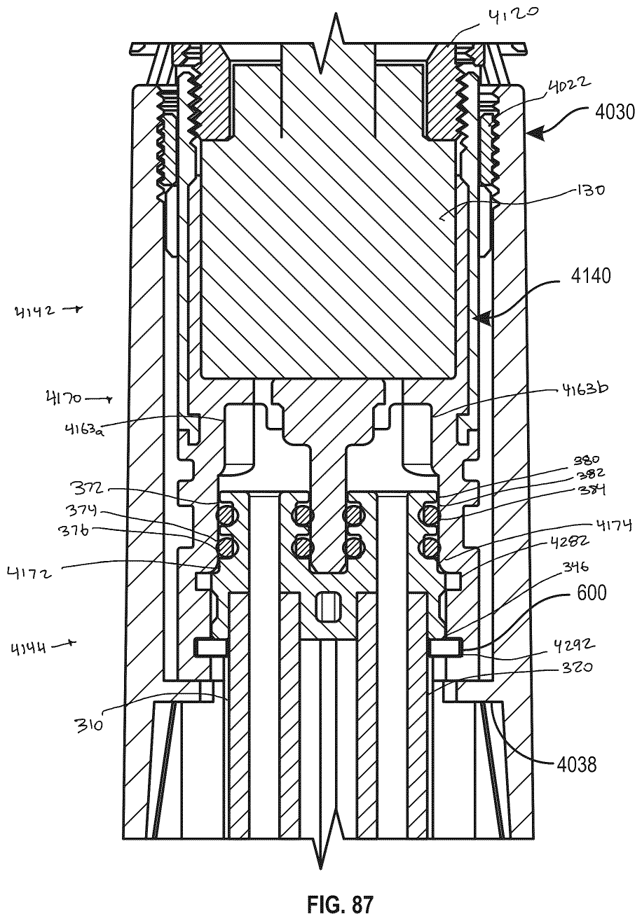

Shown as a fifth valve body housing embodiment in FIG. 79 and 83-87, a valve body housing 4140 has the same features as a valve body housing 140 described above with alternate alignment features. For sake of brevity, the above disclosure in connection with valve body housing 140 will not be repeated below, but it should be understood that across embodiments, like numbers represent like structures. For example, the disclosure relating to valve body housing 140 applies in equal force to valve body housing 4140. The primary difference between the first embodiment of the valve body housing 140 and this fifth embodiment of the valve body housing 4140 (FIG. 78) relates to the addition of at least one additional base anti-rotation rib 4165 to allow for an alternate installation for the alternate faucet housing 4020 having a lower step 4038 (FIG. 87) for engagement with the valve body housing 4140. Although the example shown in FIG. 84 includes external alignment features similar the fourth embodiment valve body housing 3140 (FIG. 78), the at least one additional base anti-rotation rib 4165 can be relied on and implemented with other embodiments of the valve body housing, including 140, 1140, and 2140.

In the example shown in FIG. 84, the valve body housing 4140 includes an annular band 4160 with teeth 4164 and anti-rotation rib 4166 extending from the annular band 4160 similar to the fourth embodiment valve body housing 3140. The valve body housing 4140 additionally includes at least one base anti-rotation rib 4165 extending from the bottom of the water group receiver 4144 of the valve body housing 4140. Different from ribs 169 of valve body housing 140, the extended alignment ribs 1220 of valve body housing 1140, and the anti-rotation ribs 3166 of valve body housing 3140, the base anti-rotation ribs 4165 provide an alternate positioning and alignment feature for a faucet housing 4010 configured with a lower step 4038.

As shown in FIGS. 86 and 87, the alternate faucet housing 4020 does not have an upper step and does not engage with the annular band 4160 for support. Instead, alternate faucet housing 4020 has a lower step 4038 which can include at least pair of slots 4039 for positioning the valve body housing 4140. FIG. 84 shows a section view taken along line 84-84 of the faucet system 4020 in FIG. 85 with valve body 4140 within a faucet system 4010. As shown, the base anti-rotation ribs 4165 extending from the bottom of the water group receiver 4144 of the valve body housing 4140 of FIG. 84 engage with a step 4038 the main body 4030 of a faucet housing 4020. In this example, the step 4038 has a pair of slots 4039 to receive the base anti-rotation ribs 4165 extending from the valve body housing 4140. As shown in FIG. 87, step 4038 within the main body 4030 of a faucet housing 4020 impedes the valve body assembly 4110 from moving along the axis of the valve body assembly 4110 within the main body 4030 of a faucet housing 4010. Although this example is shown with slots 4039 positioned on opposite sides of the step 4038, the can slots 4039 also be embodied as indentations, apertures, or other positioning features, where the base anti-rotation ribs 4165 are configured to correspond and be received at least partially within the slots, indentations, apertures, or other positioning features.

v. Sixth Embodiment of the Valve Body Housing

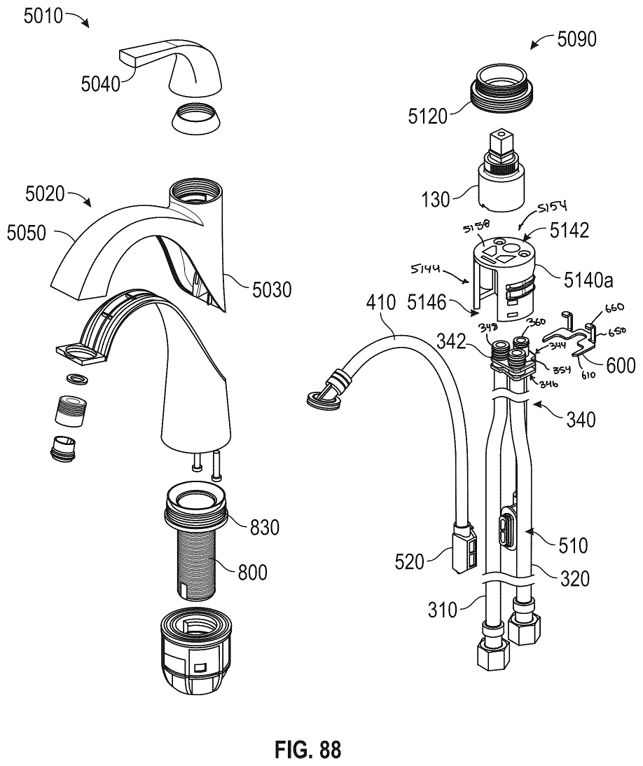

FIG. 88 shows an exploded view of an example alternate faucet system 5010 that includes alternate faucet housing 5020 and valve body housing 5140. The valve body assembly 5110 includes the valve body housing 5140, cartridge 130, and retaining nut 5120. The SHUP system 5090 includes valve body assembly 5110, inlet and outlet group 300, water group coupler 600, mixed water connector 500, and water discharge tube 410 configured for the faucet housing 5020. The SHUP system 5090 can be assembled by replacing valve body housing 140 (shown in FIG. 4) with valve body housing 5140, where all other components of the assembly are the same as SHUP system 90. Although the water inlet and outlet group 300 is shown as a waterway unit 340 that can be received at a first position, the valve body housing 5140 can also receive individual inlet and outlet lines as described with respect to valve body housing 140, including the option to secure second type of water inlet and outlet group 370 at a second position.

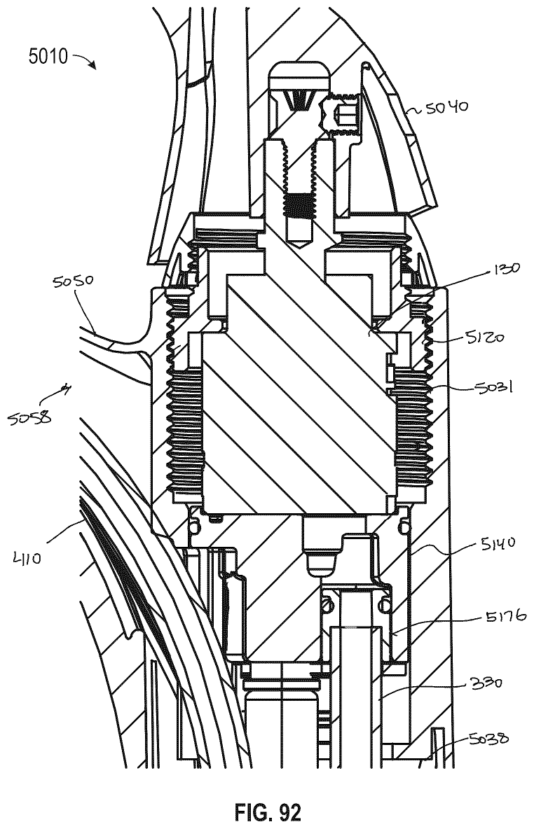

Shown as a sixth valve body housing embodiment in FIGS. 80 and 88-92, a valve body housing 5140 has the similar features as a valve body housing 140 described above with alternate alignment features. For sake of brevity, the above disclosure in connection with valve body housing 140 will not be repeated below, but it should be understood that across embodiments, like numbers represent like structures. For example, the disclosure relating to valve body housing 140 applies in equal force to valve body housing 5140 to the extent applicable. The primary difference between the first embodiment of the valve body housing 140 and this sixth embodiment of the valve body housing 5140 relates to the omission of the upper portion of the valve body housing 140 in the valve body assembly 5110. Specifically, the change between these embodiments 140 and 5140 is the omission of the upper portion of the valve body housing 140 including the upper housing wall 148 and external alignment features, such as the annular band 160 and ribs 169. The valve body housing 5140 includes base anti-rotation ribs 5165 configured to interact with a step 5038 within the faucet housing 5020. Similar to the fifth valve body housing embodiment, valve body housing 5140 is held in place at the step 5038 and the base anti-rotation ribs 5165 of the valve body housing 5140 may engage with slots, or other positioning features of the faucet 5020.

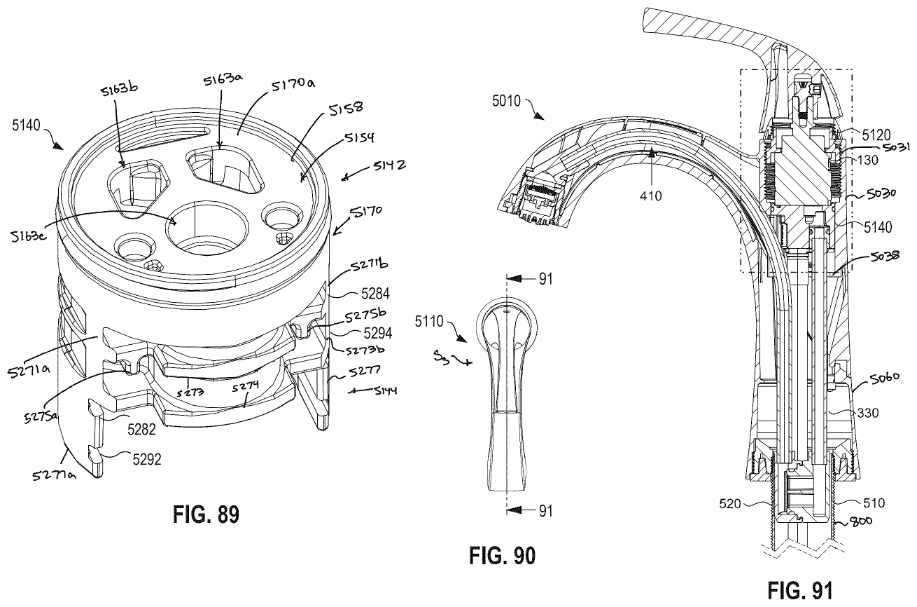

The valve body housing 5140 can have a substantially cylindrical shape with a cartridge receiving extent 5142 and a water group receiver 5144. In some examples, the mixing cartridge 130 can have registration pins extending from the base and the cartridge receiving extent 5142 have corresponding indentations to facilitate placement and alignment on the cartridge receiving extent 5142 (FIG. 89). To further improve the durability and reliability, valve body housing 5140 includes an o-ring around the valve seat, so that if any potential cartridge damage happens, water will only leak from the top side of the faucet and not leak from the underdeck to avoid flooding issue. Omitting the upper portion of the valve body housing 5140 allows for either: (i) a larger mixing cartridge 130 to be used in the same size faucet housing 5020, or (ii) the same size mixing cartridge 130 to be used in a smaller faucet housing 5020. In other words, the removal of material from the valve body housing 5140 frees up additional space between the outer perimeter of the mixing cartridge 130 and the inner surface of the faucet housing 5020, which in turn provides the designer with additional configuration combinations that would not be possible without the omission of the upper portion of the valve body housing 140. Typically, this alternative configuration is utilized to enable the designer to use a faucet housing 5020 that has an interior diameter that is approximately the outer diameter of the mixing cartridge 130, which is not possible to accomplish when utilizing the valve body housing 140 described in connection with the first embodiment of faucet system 10.

Like valve body housing 140, the valve body housing 5140 can have a cartridge receiving extent 5142 and a water group receiver 5144 on opposing sides of a base wall 5170. Because the upper portion of the valve body housing 140 is omitted, the mixing cartridge 130 is not directly coupled to the valve body housing 5140 using the bonnet nut 5120. Instead, the mixing cartridge 130 is placed between the cartridge seat 5158 and the retaining nut 5120, when the retaining nut 5120 is tightened downward so that its threads are engaged with the faucet housing 5020. Without needing the annular band 160 to be engaged with other structures, additional structures may be formed in the mixing cartridge 130, the valve body housing 5140, and/or the faucet housing 5020. For example, the valve body housing 5140 can be positioned within the faucet housing 5020 on a lower step 5038 for support. In some implementations, the valve body housing 5140 can also include at least one additional base anti-rotation rib 5165 to aid in secure placement and/or positioning for the valve body housing 5140, in a similar manner as described with respect to the fifth embodiment valve body housing 4140. The at least one additional base anti-rotation rib 5165 can be configured to cooperate with a correspond and be received at least partially within slots, indentations, apertures, or other positioning features of the lower step 5038 and/or faucet housing 5020.

vi. Seventh Embodiment of the Valve Body Housing

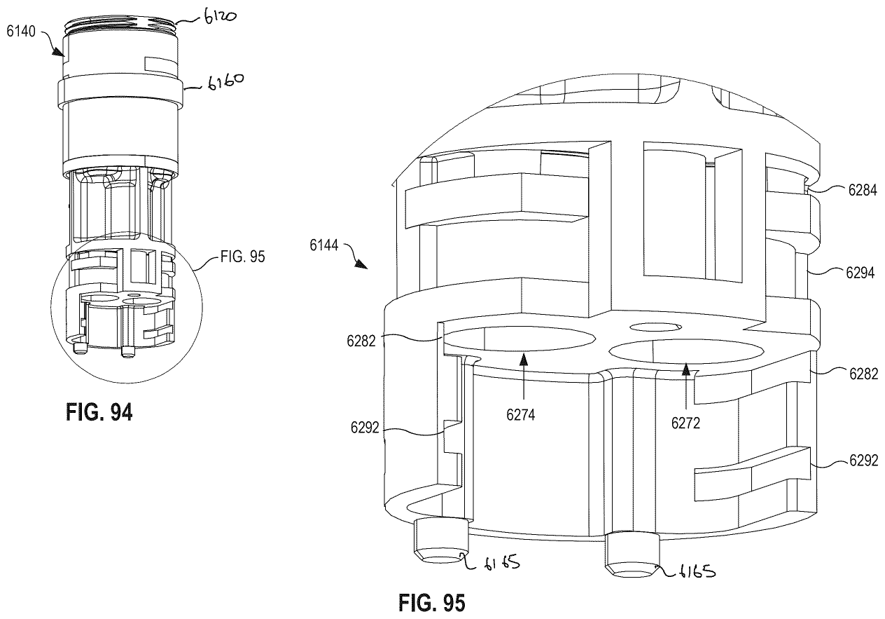

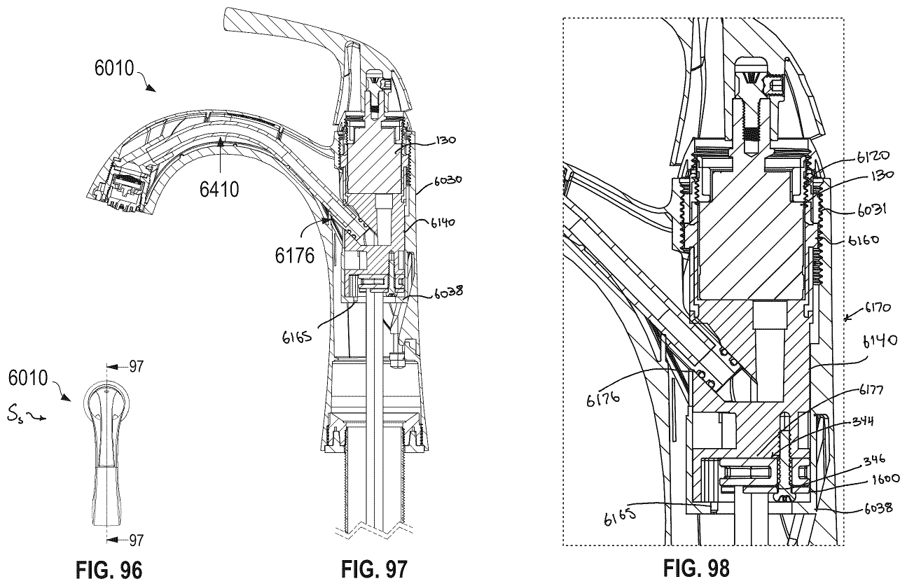

FIG. 93 shows an exploded view of an example alternate faucet system 6010 that includes faucet housing 6020 and valve body housing 6140. Shown in FIGS. 93-98, the valve body assembly 6110 includes the valve body housing 6140, cartridge 130, and retaining nut 6120. The SHUP system 6090 includes valve body assembly 6110, inlet and outlet group 6300, water group coupler 600, and water discharge tube 6410 configured for the faucet housing 6020. The primary difference between the first embodiment of the faucet system 10 and this seventh embodiment of the faucet system 6020 relates to the omission of the mixed water connector 500 and the direct coupling of the water discharge tube 6410 to the valve body housing 6140. The valve body housing 6140 is extended to accommodate the outlet port 6176 in a side location. The cartridge 130 can be received into the hollow interior 6150 of the valve body housing 6140 and seated on cartridge receiving extent 6142.

The valve body housing 6140 includes base anti-rotation ribs 5165 configured to interact with a step 6038 within the faucet housing 6020. Similar to the fifth valve body housing embodiment, valve body housing 6140 may be positioned and held in place at the step 6038. The base anti-rotation ribs 6165 of the valve body housing 6140 may engage with slots, or other positioning features of the faucet 6020. Additionally, the valve body housing 6140 includes an annular band 6160 that may be utilized with an alternate faucet housing to couple SHUP system 6090 in a similar manner as described with respect to valve body housing 140.

It should be understood that the alteration of the water discharge tube 6410 and valve body housing 6140, also causes changes to the water inlet and outlet group 300. In this example, water inlet group 6300 is shown as a third embodiment of a first type of water inlet and outlet group 2340 with a connection platform 2342 and only the inlet tubes 2310, 2320 that are received into the bottom of the water group receiver 6144. In other examples, a third embodiment of the second type of inlet and outlet group 2370 can provide the inlet tubes 2310, 2320 individually to be coupled with water group coupler 600 at the first level. These changes do not affect the shape or function of the water group coupler 600. Even though the mixed water line 330 is eliminated from this embodiment, the water group coupler 600 remains effective in retaining inlet tubes 2310, 2320. In some examples, the water group coupler 1600 can be a modified version of water group coupler 600 that excludes the first indent 642 and includes an aperture 1622 configured to receive a screw or other fastener to secure the water group coupler 1600 to the valve body housing 6140. Additionally or alternatively, the valve body housing 5140 can be supported within the faucet housing 5020 via the annular band 5160 or be seated on a lower step 5038 for support (FIG. 97).

vii. Eighth Embodiment of the Valve Body Housing

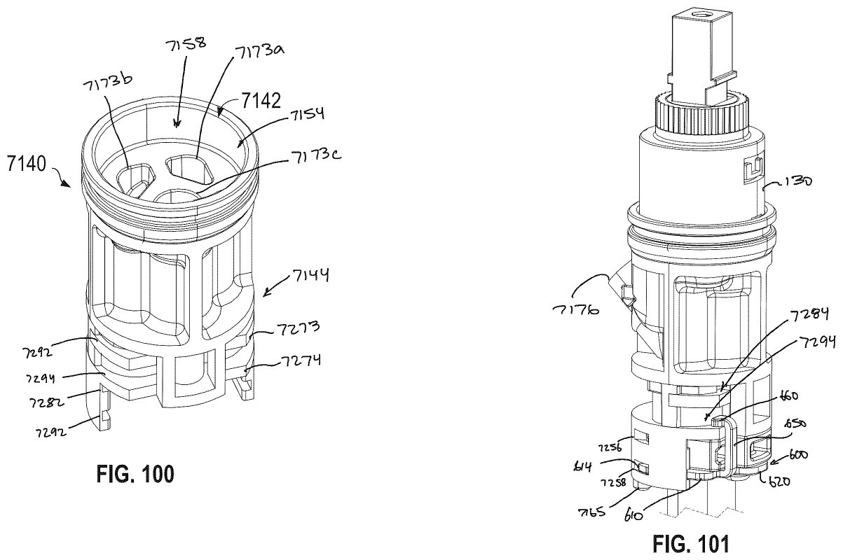

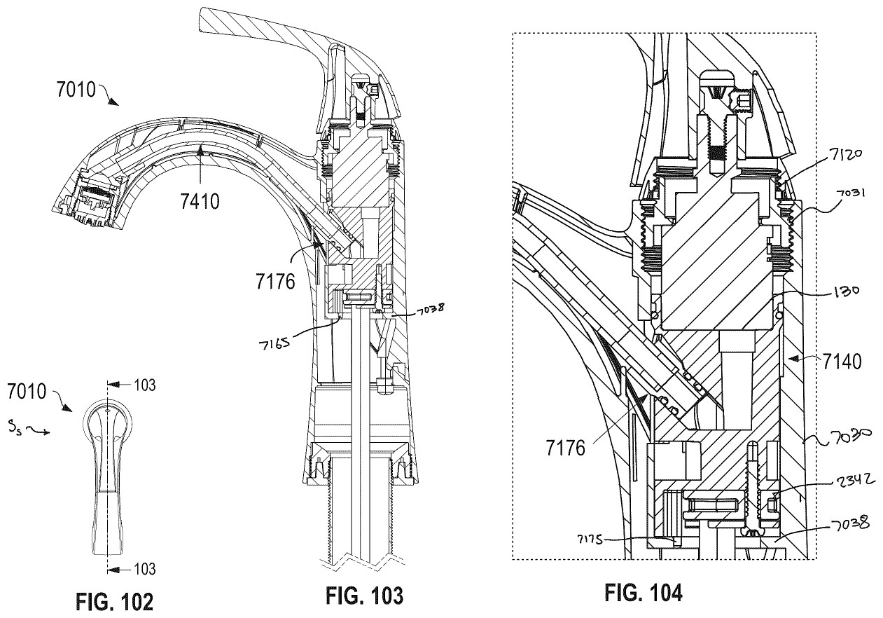

FIG. 99 shows an exploded view of an example alternate faucet system 7010 that includes faucet housing 20 and valve body housing 7140. Shown in FIGS. 99-104, the valve body assembly 7110 includes the valve body housing 7140, cartridge 130, and retaining nut 7120. The SHUP system 7090 includes valve body assembly 7110, inlet and outlet group 7300, water group coupler 600, and water discharge tube 7410 configured for the faucet housing 20. For sake of brevity, the above disclosure in connection with faucet system 10 will not be repeated below, but it should be understood that across embodiments like numbers represent like structures. This eighth embodiment of a valve body housing 7140 combines the sixth and seventh embodiments of the valve body housing 5140 and 5140. Specifically, the mixed water connector 500 is omitted, like the seventh embodiment 6140. The valve body housing 7140 can also receive inlet group 2340 or 2370 at a first or second position, respectively. Similar to the sixth embodiment 5140, the upper extent of the upper portion is omitted and an o-ring around the exterior surface of the valve body housing 7140, so that if any potential cartridge damage happens, water will only leak from the top side of the faucet and not leak from the underdeck to avoid flooding issue. Additionally, valve body housing 7140 includes base anti-rotation ribs 7165 configured to interact with a step 7038 within the faucet housing 7020.

### L. Alternative Mixed Water Connector

FIGS. 105-111 illustrate various connection groups suitable to for use in SHUP system 90 according to various embodiments. Although a bathroom faucet system 10 is used as an example herein, the SHUP system 90 can be configured for kitchen faucet systems, utility faucet systems, and/or other faucet configurations. In certain examples and configurations, the mixed water connector 500 described herein can be replaced with the group connectors 1500, 2500, 3500, 4500, 5500, 6500, and 7500.

i. Second Embodiment of Mixed Water Connector

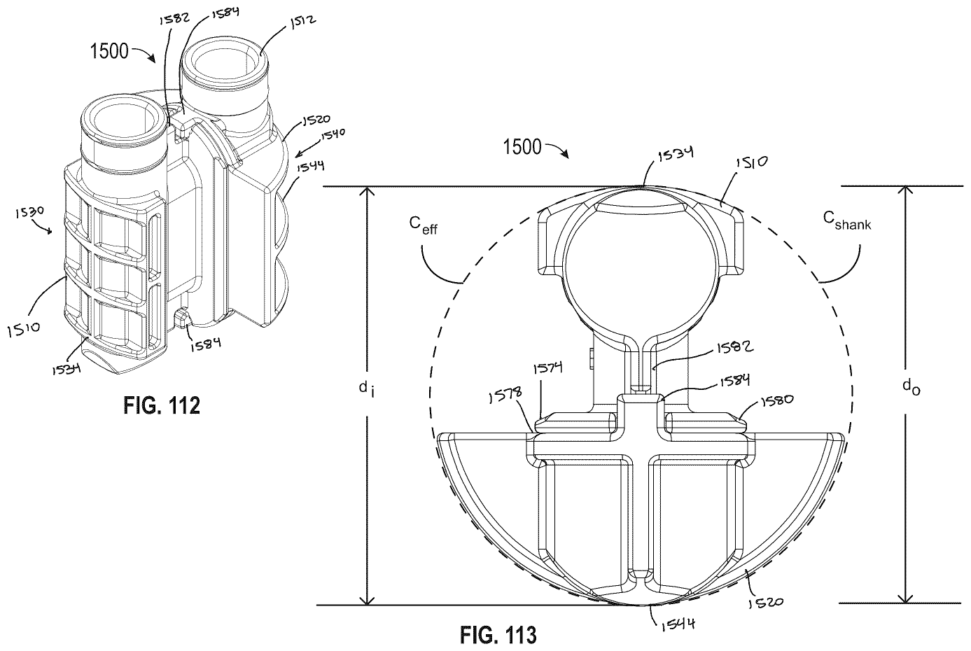

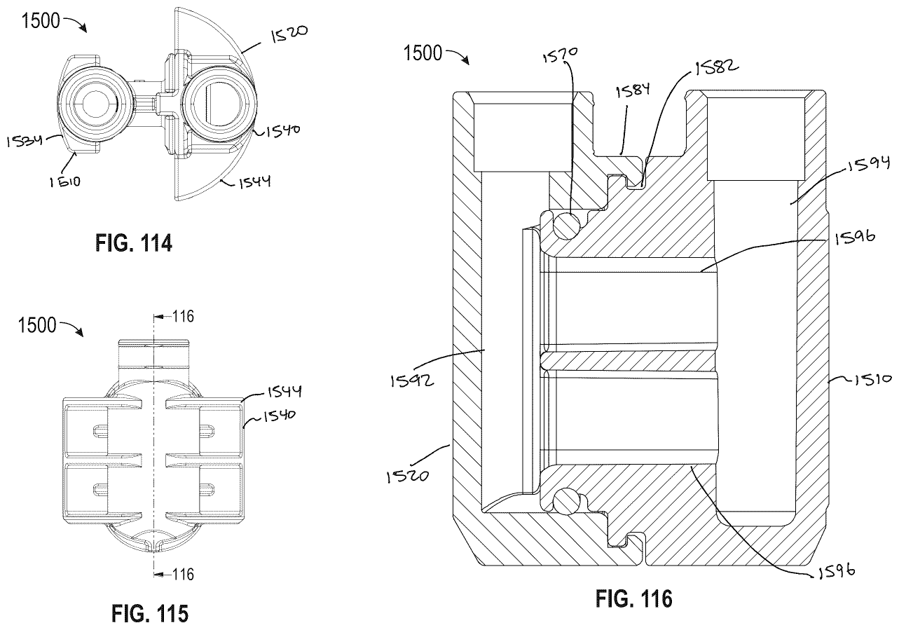

As shown in FIGS. 105 and 112-116, mixed water connector 1500 is an alternate embodiment of mixed water connector 500. The first coupler 1510 and the second coupler 1520 of the mixed water connector 1500 can be coupled and provide a fluid connection between the mixed water line 330 and the water discharge tube 410 to provide a leak-free connection.

The first coupler 1510 of the mixed water connector 1500 can attach to the mixed water outlet line 330 and the second coupler 1520 of the mixed water connector 1500 can connect to the water discharge tube 410 to provide a leak-free connection. For sake of brevity, the above disclosure in connection with mixed water connector 500 will not be repeated below, but it should be understood that across embodiments like numbers represent like structures. The first coupler 1510 and the second coupler 1520 of the mixed water connector 1500 can be coupled and provide a fluid connection between the mixed water line 330 of the water inlet and outlet group 300 and the water discharge tube 410.

The primary difference between the mixed water connector 500 and mixed water connector 1500 relates the external features of the first coupler 1510 and second coupler 1520. In particular, at least the curvilinear extent 1540 of second coupler 1520 is shaped to conform to a mounting shank 800 having a large arcuate profile, such that the second coupler 1520 has a larger effective engagement area 1544 than the engagement area 1544 of coupler 520.

ii. Third Embodiment of Mixed Water Connector

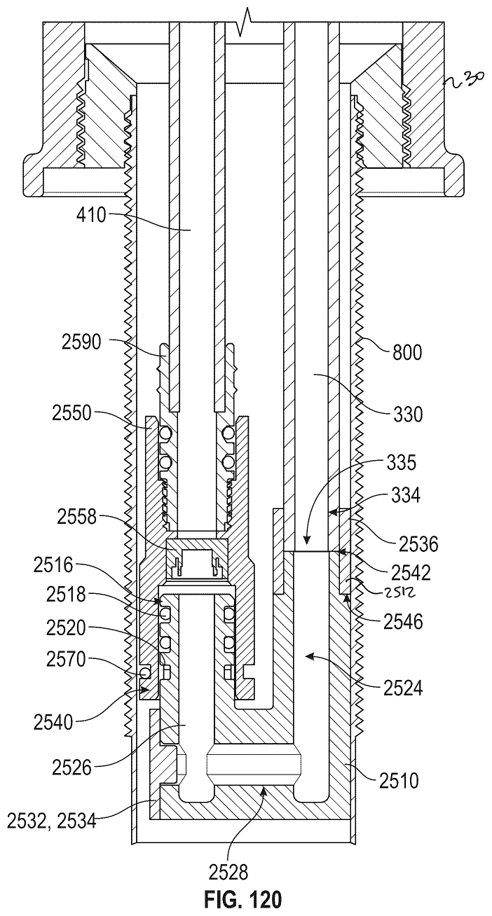

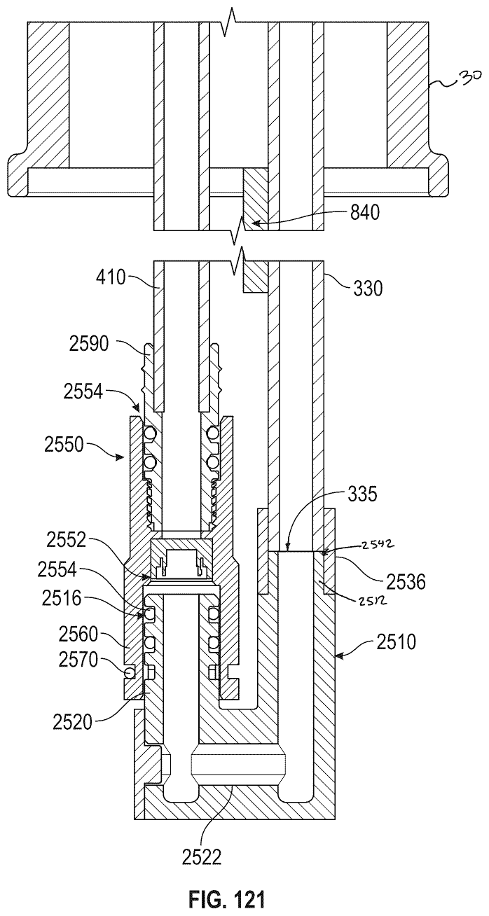

Shown in FIGS. 106 and 117-121, alternative mixed water connector 2500 is configured to fluidly connect the mixed water outlet line 330 to the water discharge tube 410. As shown in the Figures, the connection group 2500 can either be concealed in the mounting shank 800 (FIG. 120) or it can be utilized with bolt 840 installation (FIG. 121). As such, the horizontal width, at any location, in of the mixed water connector 2500 is less than the diameter of the shank. While said horizontal width of the mixed water connector 2500 is less than the diameter of the shank, it should be understood that it is desirable to maximize the horizontal width of the mixed water connector 2500 to ensure there is enough room to couple the mixed water outlet line 330 and the water discharge tube 410 to said mixed water connector 2500 without using a complex or expensive manufacturing process. Accordingly, said horizontal width of the mixed water connector 2500 is preferably within 20% of the diameter of the shank and most preferably within 5% of the diameter of the shank. An additional benefit of increasing the horizontal width of the mixed water connector 2500 to a dimension just less than the diameter of the shank is to help minimize the rattling, shaking, or vibration of the mixed water connector 2500 within the shank, which not only reduces noise but also increase the longevity of the mixed water connector 2500. Further, the curvature that is associated with the mixed water connector 2500 is greater than the curvature of the shank to ensure that said mixed water connector 2500 fits within the shank, while maximizing the horizontal width of the mixed water connector 2500.

The mixed water connector 2500 can include a water flow coupler 2510, an adapter 2550, and coupler clip 2570. The water flow coupler 2510 includes an inlet port 2512, an outlet port 2514, and a fluid passage 2522 there between. The inlet port 2512 may be fluidly connected to the mixed water outlet line 330, while the outlet port 2514 may be fluidly connected to the water discharge tube 410. The fluid passage 2522 of the water flow coupler 2510 may be formed by: (i) a substantially vertical inlet portion 2524, (ii) a substantially vertical outlet portion 2526, and (iii) a substantially horizontal connection portion 2528 that extends between the inlet portion and the outlet portion in order to fluidly connect the inlet portion and outlet portion. Accordingly, the passage 2522 may have a generally U-shaped configuration. In other words, the sidewalls of the inlet portion 2524 may be: (a) substantially parallel with the sidewalls of the outlet portion 2526, and (b) substantially perpendicular with the sidewalls of the connection portion 2528.

The water flow coupler 2510 may include multiple features that enable said coupler 2510 to be: (i) permanently and directly secured to mixed water outlet line 330, and (ii) removability and indirectly coupled to the water discharge tube 410. In particular, said features may include: (i) a recess 2546 that may be formed in an exterior extent of the inlet portion 2524 and is configured to receive an extent of an inlet coupler 2536, (ii) at least one, and preferably a plurality of, sealing grooves 2516 formed in an exterior extent of the outlet portion 2526 and is configured to receive a sealing o-ring 2518 to help ensure that fluid does not escape though said connection between the water flow coupler 2510 and the adaptor 2550, and (iii) a coupling groove 2520 that is designed to receive an extent of a mechanical coupling means 2580 that is configured to secure said water flow coupler 2510 to the adaptor 2550. It should be understood that in other embodiments, the sealing O-ring 2518 may be omitted or additional sealing o-ring 2518 may be utilized.

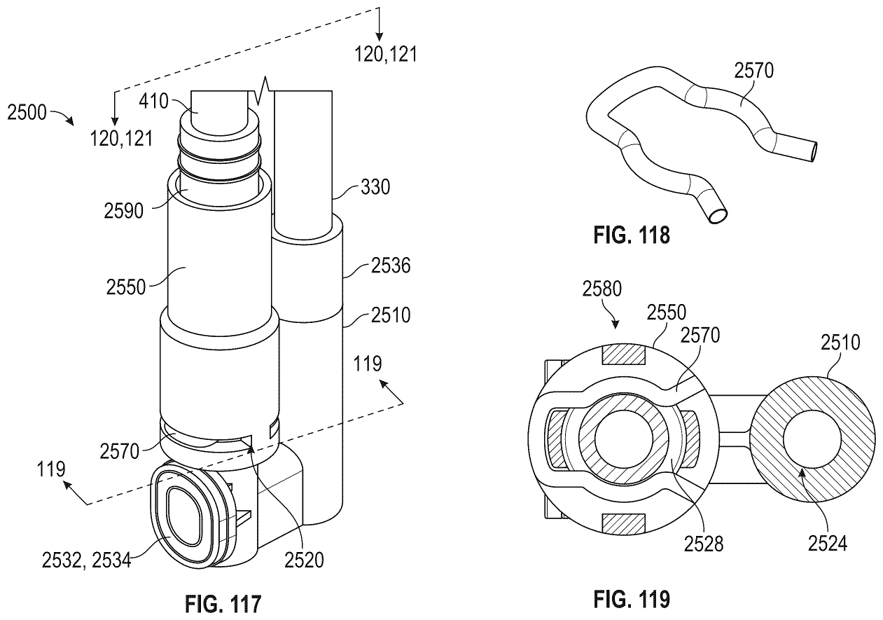

In order to simplify manufacturing of the water flow coupler 2510, said water flow coupler 2510 may be formed in one or more pieces. In particular, said water flow coupler 2510 may be formed using an injection molding process that utilizes an internal core. As such, the water flow coupler 2510 may be made from a plastic material (e.g., PERT, PEX, CPVC, PE-RT, PP-R, ABS). In this process, an internal core that includes an inlet extent, an outlet extent, and a connection extent are coupled to one another and placed in the center of the model in order to form the fluid passage 2522 within the water flow coupler 2510. To remove said connection extent of the internal core from the water flow coupler 2510 after said water flow coupler 2510 is cooled, an opening 2544 is formed in the sidewall 2530 of the water flow coupler 2510. As shown in the Figures, said opening is substantially aligned with the substantially horizontal connection portion 2528. After the connection extent of the internal core is removed from the water flow coupler 2510, the opening is filled in with a plug 2532. In the Figures, said plug 2532 is shown as a cap 2534 (FIGS. 117 and 120). To secure said cap 2534 to the sidewall of the water flow coupler 2510, the cap is bonded (e.g., laser welded) to said sidewall in order to provide a water tight water flow coupler 2510. It should be understood that in other embodiments, the water flow coupler 2510 may be formed in a different manner that does not require the formation of the opening in the sidewall 2530 of the water flow coupler 2510 and therefore does not require the plug 2532 or securing said plug to the sidewall 2530 of the water flow coupler 2510. In further embodiments, other methods of coupling (e.g., ultrasonic welding, hot plate welding, vibration welding, spin welding, induction welding, solvent bonding, adhesive bonding, any combination of the above, or any other known method) said plug to the sidewall are contemplated. Moreover, in other embodiments, said water flow coupler 2510 may be made from metal (e.g., copper) and said coupler 2510 may not use an injection molding process.

An inlet coupler 2536 that is shown in the figures as a collar 2538 may be used to fluidly connect the inlet port 2512 of the water flow coupler 2510 to the mixed water outlet line 330. As shown in the Figures, an end 2542 of the inlet port 2512 may abut an end face 335 at the connector end 334 of the mixed water outlet line 330; as such, the water flow coupler 2510 is not directly connected to the mixed water outlet line 330. Instead, said collar 2538 is configured to secure the inlet port 2512 to the mixed water outlet line 330 by surrounding and being directly coupled to: (i) the connector end 334 of the mixed water outlet line 330, and (ii) an extent 2548 of the inlet port 2512. Said extends may be secured to the collar 2538 using any known method (e.g., laser welding, ultrasonic welding, hot plate welding, vibration welding, spin welding, induction welding, solvent bonding, adhesive bonding, any combination of the above). In other embodiments, the collar 2538 may be omitted and an extent of the mixed water outlet line 330 may be received within the inlet port 2512 and secured therein.

An adaptor 2550 may be used to fluidly connect the outlet port 2514 of the water flow coupler 2510 to the water discharge tube 410. The adapter 2550 may include: (i) a slit 2560 configured to help secure the adaptor 2550 to the water flow coupler 2510, (ii) a flow restrictor 2558, (iii) an input seat 2552 that is configured to receive an extent of the outlet port 2514 of the water flow coupler 2510, (iv) an output seat 2554 that is configured to receive an extent of a water discharge tube coupler 2590 that is secured to the water discharge tube 410, and (v) a connecting passage 2556 that extends between input seat 2552 and the output seat 2554. As shown in the Figures, the water discharge tube 410 is not received within the adaptor 2550. Instead, said water discharge tube coupler 2590 may be received within the output seat 2554. However, it should be understood that in other embodiments, the said water discharge tube coupler 2590 may be omitted and the adapter 2550 may be directly coupled to the water discharge tube 410. In various embodiments, the water discharge tube 410 may be coupled to the output seat 2554 of the adapter 2550 via a threaded connection. For example, the water discharge tube coupler 2590 or the water discharge tube 410 may have an extent with a threaded exterior portion and the output seat 2554 of the adapter 2550 may have a threaded interior portion.

A mechanical coupling means 2580 may be used to secure the outlet port 2514 within an extent of the input seat 2552. Said mechanical coupling means includes: (i) the slit 2560 formed in the sidewall of the adapter 2550, (ii) a deformable coupler clip 2570, (iii) the coupling groove 2520 formed in the exterior extent of the water flow coupler 2510. The slit 2570 is configured to align with the coupling groove 2520 when water flow coupler 2510 is properly seated within the adaptor 2550. Once the slit 2570 and coupling groove 2520 are aligned, the deformable coupler clip 2570 can be inserted within said slit 2570 and into the coupling groove 2520. In doing so, the deformable coupler clip 2570 surrounds a central portion 2540 of the outlet port 2514 of the water flow coupler 2510. As such, said mechanical coupling means 2580 secures said adaptor 2550 and the water flow coupler 2510, while not interrupting the water flow between said components 2510, 2550. It should be understood that other mechanical coupling means are contemplated herein. For example, said mechanical coupling means may include cooperatively dimensioned threads.

As shown in the Figures, the adaptor 2550 may include a flow restrictor 2558 that is positioned within the connecting passage 2556. The flow restrictor 2558 may be designed to meet a customer requirement or requirement of a locality. For example, the restricted flow may be 1.5 gallons per minute (GPM) or 1.2/1.0 GPM. In other embodiments, the adapter 2550 may not include a flow restrictor 2558, especially in installations where the facet already includes an aerator.

iii. Fourth Embodiment of Mixed Water Connector

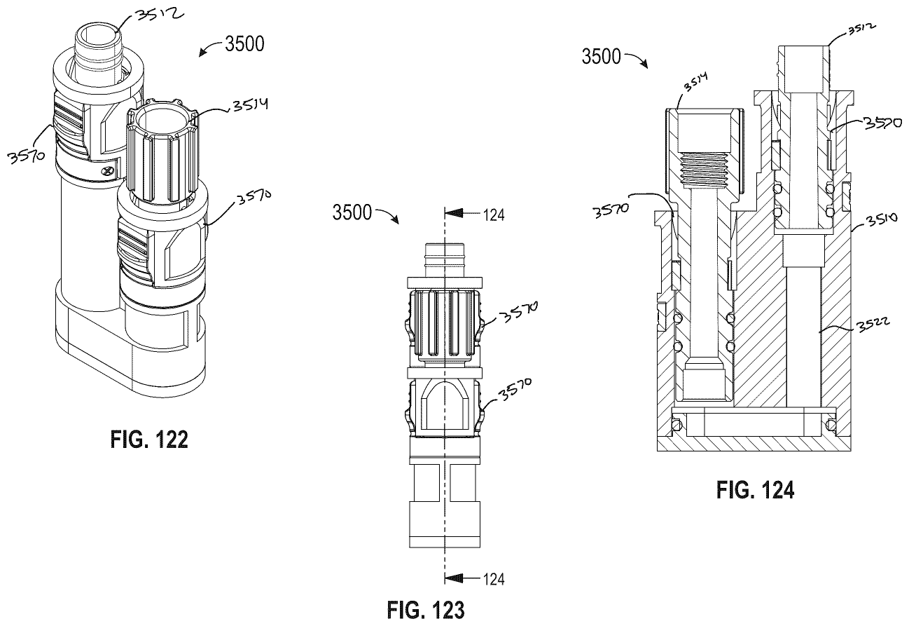

Shown in FIGS. 107 and 122-124, the mixed water connector 3500 is a single connector 3510 comprising an inlet port 3512 and an outlet port 3514 positioned to provide a fluid passage 3522 therebetween directing the fluid in a substantially about 180 degrees from the inlet port 3512. For example, the fluid passageway 3522 can be seen in a cross-section view in FIG. 124. In the example shown, the mixed water line 330 can be coupled to the inlet port 3512 and the water discharge tube 410 can be coupled to the outlet port 3514 with a threaded connection. In some examples, the outlet port 3514 can include a rotatable connection port to facilitate and secure the threaded connection of the water discharge tube 410. In some examples, a tab 3570 or other means of securing the tubes 330, 410 can be provided externally on either the inlet port 3512, the outlet port 3514, or both.

iv. Fifth Embodiment of Mixed Water Connector

Shown in FIG. 108, the mixed water connector 4500 can be a single piece connector 4510 comprising an inlet port 4512 attached to the mixed water outlet line 330, with a fluid passage 4522 through the connector 4510 to an outlet port 4514 directing the fluid about 180 degree from the inlet port 4512. The mixed water connector 4500 is sized to fit within a mounting shank 800. The mixed water connector 4500 can be made of the same or different material as the mixed water outlet line 330. For example the mixed water outlet line 330 and/or the mixed water connector 4500 can be made from copper and/or brass, or other suitable material, and either welded together or formed in one piece. The mixed water connector 4500 can have an external slot 4560 on near the outlet port 4514 configured to secure a clip ring 4570 or other fastener to secure the water discharge tube 410 when inserted into the mixed water connector 4500.

v. Sixth Embodiment of Mixed Water Connector

Shown in FIG. 109, the mixed water connector 5500 can be a single piece connector 5510 comprising an inlet port 5512 configured to receive the mixed water outlet line 330, with a fluid passage 5522 through the connector 5510 to an outlet port 5514. The mixed water connector 5500 having a substantially V-shape with fluid passage 5522 directing the fluid at an angle of about 30 to about 60 degrees from the inlet port 5512. The V-shape of the connector 5510 allowing for longer lengths of the mixed water outlet line 330 and/or water discharge tube 410. For example, in a pull-out faucet configuration, the mixed water connector 5500 can receive the mixed water outlet line 330 at a lower position beneath the sink, with the connector 5510 projecting the water discharge tube 410 away from the mixed water outlet line 330 to minimize entanglement of the tubes 310, 320, 330, 410. The mixed water outlet line 330 and/or the water discharge tube 410 can be coupled to the mixed water connector 5500 by a threaded, snap, compression fit, or other suitable means. In some examples, an adapter 5550 can be provided to allow the water discharge tube 410 to attach to the adapter 5550 with a threaded connection and the adapter 5550 be inserted into the outlet port 5514 coupled by a compression fit.

vi. Seventh Embodiment of Mixed Water Connector

Shown in FIG. 110, the mixed water connector 6500 can be a single piece connector 6510 comprising an inlet port 6512 configured to receive the mixed water outlet line 330, with a fluid passage 6522 through the connector 6510 to an outlet port 6514 configured to receive the water discharge tube 410. Similar to the mixed water connector 5500, the inlet port and outlet port are configured to allow the tubes 330, 410 to be received with the fluid directed about 180 to the outlet port 6514, allowing the connector 6510 to fit within a mounting shank 800. The mixed water connector 6500 can be provided with a tube coupler 6536 to couple together the mixed water line 330 and the water discharge tube 410 such that both tubes 330, 410 can be received together into the mixed water connector 6500. In some examples, the ends of the mixed water line 330 and the water discharge tube 410 can be shaped or adapted to link to each other and optionally be secured by the tube coupler 6536

vii. Eighth Embodiment of Mixed Water Connector

Shown in FIG. 111, the mixed water connector 7500 can be a single piece connector 7510 wherein an inlet port 7512 is configured to connect to the valve body housing 140 in a manner similar to the mixed water outlet line 330. As such, the mixed water is received directly into the mixed water connector 7500. The connector 7510 also has an outlet port 7514, spaced apart from the inlet port 7512 connection with a fluid passage 7522 therebetween. In some examples, a support 7540 is included between the inlet port 7512 and outlet port 7514. The water discharge tube 410 can be received into the outlet port 7514. In some examples, a clip ring 7570 can be provided to further secure the water discharge tube 410.

### III. Second Type of the Universal Waterway Platform System

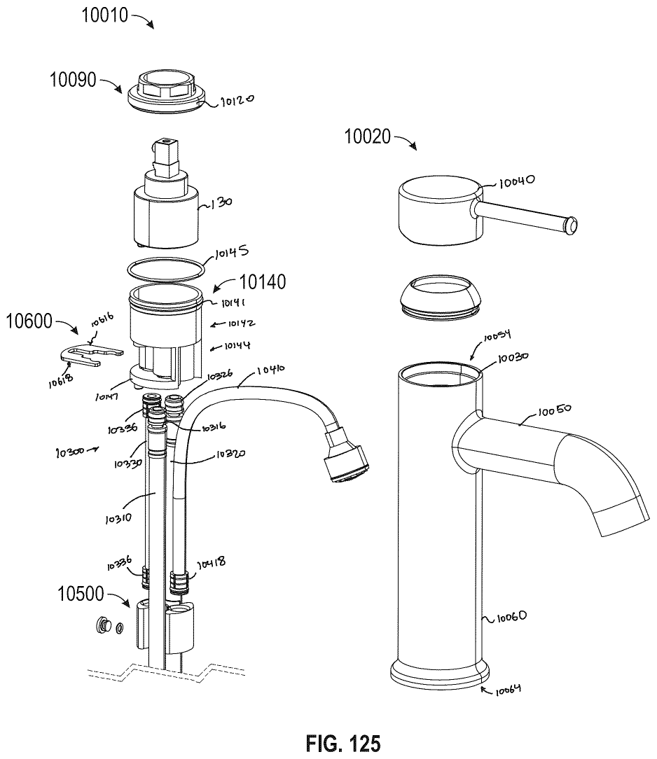

Shown in an exploded view in FIG. 125, faucet system 10010 includes a ninth embodiment of the SHUP system 10090 contained in a faucet housing 10020. The SHUP system 10090 includes (i) a ninth embodiment of a valve body assembly 10110, (ii) a third type of an inlet and outlet water group 10300, (iii) a third embodiment of a water group coupler 10600, (iii) a faucet outlet tube 10410, and (v) a ninth embodiment of the mixed water connector 10500. The valve body assembly 10110 includes a ninth embodiment of valve body housing 10140, the mixing cartridge 130, and a retaining nut 10120. The water inlet and outlet group 10300 includes the first water inlet line 10310, the second water inlet line 10320, and the mixed water line 10330. The first and second water inlet lines 10310, 10320 include couplers 10316, 10326 configured couple to the valve body housing 10140. The mixed water line 10330 includes coupler 10336 affixed on both end. The faucet outlet tube 10410 having a coupler 10418, which is substantially similar to coupler 10336 and configured to cooperate with features of the faucet housing 10020. The mixed water connector 10500 is configured receive said coupler 10336, 10418 and to provide a fluid connection between the mixed water outlet line 10330 and faucet outlet tube 10410.

This embodiment of the SHUP system 10090 is designed and configured for slimmer faucet products. In various figures, the faucet system 10010 includes the SHUP system 10090 contained a faucet housing 10020 that has at least one C-type mounting hole, preferably two C-type mounting holes, formed a mounting shelf in a base portion of the faucet housing 10020. Although an illustrative faucet system 10010 is disclosed with a certain spout shape the SHUP system 10090 may be included or installed faucet housings having various shapes and sizes including, but not limited to a curved spout shape, a tubular spout shape, and a flat spout shape.

Shown in an exploded view in FIG. 125, the SHUP system 10090 is configured to be installed in a faucet housing 10020. The faucet housing 10020 includes a main body 10030, a handle 10040 operably connected to the main body 10030, and a spout 10050 extending from the main body 10030. The main body 10030 includes a base portion 10060 configured to receive an extent of the mounting assembly 10800 therein to mount the faucet system 10010 to a support surface 85 in a substantively vertical configuration. The faucet housing 10020 includes an upper step 10032 and/or a lower mounting shelf 10038 within the interior of the main body 10030. As shown in FIGS. 139 and 145, the upper step 10032 projects inward from the housing wall 10012. The upper step 10032 may be positioned within the main body 10030 and configured to receive the valve body housing 10140. For example, the upper step 10032 may be in an upper portion of the main body 10030 positioned below the spout 10050. In various examples, the upper step 10032 may be a rim or ridge projecting inward from the housing wall 10012. In some examples, the upper step 10032 may be discontinuous. In some examples, the upper step 10032 may be a plurality of discrete projections extending inward from the housing wall 10012. The lower mounting shelf 10038 (FIG. 141) may project inward from the housing wall 10012 and span the hollow interior 10014 within a base portion 10060 of the main body 10030. The lower mounting shelf 10038 may include first and second surfaces 10037, 10039 with a waterway opening 10080.

As shown in FIG. 145, when assembled, the SHUP system 10090 may utilize internal mounting features of the faucet housing 10020 for positioning the valve body housing 10140 and to secure the inlet and outlet water group 10300. A ninth embodiment of a mixed water connector 10500 is configured to provide a fluid connection between the mixed water outlet line 10330 and faucet outlet tube 10410. The mixed water connector 10500 is also configured to accommodate the inlet lines 10310, 10320 in a space saving manner. The mixed water connector 10500 is designed to be secured to the faucet housing 10020 between a lower mounting shelf 10038 inside a base portion 10060 of the faucet housing 10010 and the mounting assembly 10800 that secures the SHUP system 10090 to a support surface 85, such as a kitchen or bathroom countertop.

### A. Ninth Embodiment of the Valve Body Housing

The valve body housing 10140 includes a substantially cylindrical upper wall 10148 extending from the waterway base portion 10144 that includes an interior portion 10150 suitable to receive the mixing cartridge 130. The waterway base portion 10144 includes an interface base 10170. A cartridge seat 10158 is formed in at least a portion of a surface of the interface base 10170 within the interior portion 10150. The cartridge seat 10158 may include indents positioning indents 10157 to receive positioning feet 132 of a mixing cartridge 130 for proper placement and alignment of the mixing cartridge 130 within the valve body housing 140.

The exterior portion 10149 of the substantially cylindrical upper wall 10148 may include a circumferential groove 10141 about the exterior surface near the top edge 10143 of the valve body housing 10140. The circumferential groove 10141 suitable to receive an o-ring 10145. The valve body housing 10140 may further include a base 10147 configured to rest on the upper step 10032 within the interior of the main body 10030 of the faucet housing 10020. In various examples, the base 10147 may include position feet 10159 extending from a base bottom surface 10147b that may be received in positioning holes 10034 (not shown) of the upper step 10032. The base 10147 of the valve body housing 10140 is formed in the waterway base portion 10144 opposite the top edge 10143. At least a portion of the base 10147 may have a perimeter aligned with the perimeter of the substantially cylindrical upper wall 10148.

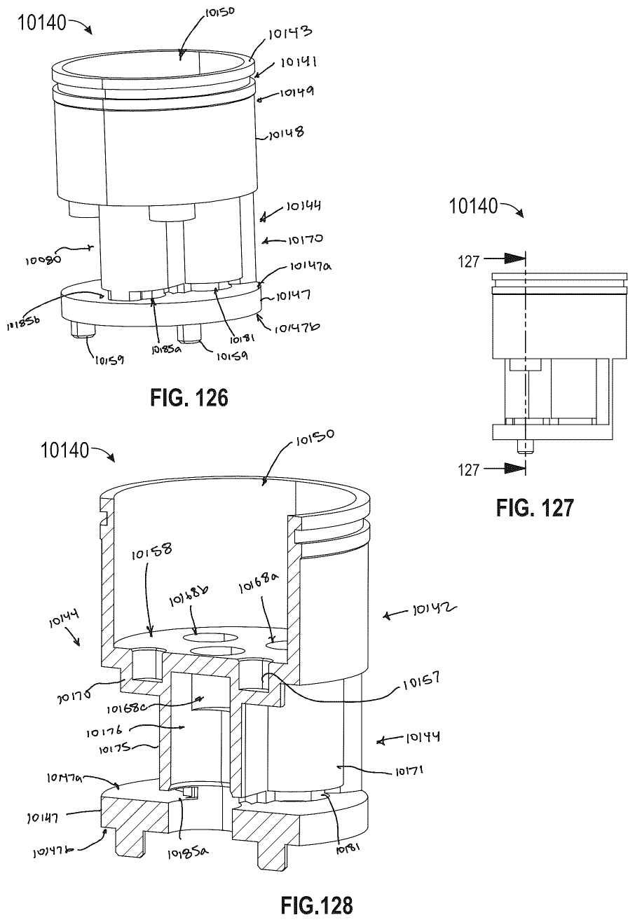

The waterway base portion 10144 provides an interface base 10170 for fluid communication between the water inlet and outlet group 10300 and the mixing cartridge 130. The interface base 10170 includes a first inlet port 10172, a second inlet port 10174, and an outlet port 10176 accessed through the base 10147 (FIGS. 128, 135). Each of the first inlet port 10172 and the second inlet port 10174 being formed within the interface base 10170 of the waterway base portion 10144 having port walls 10171, 10173 with interior diameters suitable to receive the first couplers 10316, 10326 of the inlet lines 10310, 10320 (FIG. 137). Similarly, the outlet port 10176 being formed within the waterway base portion 10144 having an outlet port wall 10175 with an interior diameter suitable to receive the coupler 10336 of the mixed water discharge tube 10330 (FIG. 150). As shown in FIGS. 126-128, the valve body housing 10140 may include an interior portion 10150 to receive the mixing cartridge 130 and a waterway base portion 10144 that includes an interface base 10170 for fluid communication between the water inlet and outlet group 10300 and the mixing cartridge 130 via passages 10168 (FIG. 128).

The valve body housing 10140 may have a curvilinear exterior surface portion 10180 that conforms with at least an extent of the port walls 10171, 10173, 10175 of each of the first inlet port 10172, the second inlet port 10174, and the outlet port 10176. For example, at least a portion of the waterway base portion 10144 may have a trefoil cross section at inlet ports 10172, 10174, 10176. A plurality of clip mounting slots 10181, 10183, 10185a, 10185b are formed through the curvilinear exterior surface portion 10180 into an extent of each port wall 10171, 10173, 10175 and positioned adjacent to a top surface portion 10147a of the base 10147 of the valve body housing 10140. For example, port wall 10175 may include two clip mounting slots 10185a, 10185b to receive water group coupler 10600 on both sides of the mixed water tube 10330; and each port wall 10171, 10172 may include clip mounting slots 10181, 10183 configured to receive water group coupler 10600. The clip mounting slots 10181, 10183, 10185a, 10185b are configured to receive an extent of the water group coupler 10600 through the curvilinear exterior surface portion 10180 of the inlet and outlet ports 10310, 10320, 10330.

### B. Third Type of Inlet/outlet Group

The third type of water inlet and outlet group 10300 includes individual inlet lines 10310, 10320 and mixed water outlet line 10330. As shown in FIG. 130, the first and second inlet lines 10310, 10320 are configured with couplers 10316, 10326 at the coupling end that configured and dimensioned to be received in inlet ports 10172, 10174 of the valve body housing 10140. The couplers 10316, 10326 can include a recess 10374, 10382 and a sealing member 10376, 10382 (e.g. o-ring) positioned within the recess 10374, 10382. Additionally, each coupler 10316, 10326 has an annular groove 10318, 10328 dimensioned to receive an extent of the water group coupler 10600. The annular groove 10318, 10328 positioned at a predetermined distance (dᵣ) from the first end 10317, 10327. As shown in FIG. 137, the first water inlet coupler 10316 and the second water inlet coupler 10326 may be received into first and second inlet ports 10172, 10174 of the waterway base portion 10144 of the valve body housing 10140 to deliver a first and second water to the mixing cartridge 130. For example, the first and second fluids may be hot water and cold water. The fluids received and mixed in the mixing cartridge 130 may be delivered through the mixed water discharge tube 10330.

The mixed water discharge tube 10330 has a coupler 10336 that is dimensioned and configured to be fully inserted into the outlet port 10176. The coupler 10336 of the mixed water discharge tube 10330 includes a limit face 10338 at a predetermined distance (d_{f}) from the first end 10337. The mixed water discharge tube 10330 being configured such that the same coupler 10336 can be fixed to both the coupling end 10332 and the connector end 10334. The predetermined distance (d_{f}) being configured such that the coupler 10336 is suitable to engage with outlet port 10176 of the valve body housing 10140 and to be secured by water group coupler 10600. The predetermined distance (d_{f}) also configured such that the coupler 10336 is suitable to fully engage with connector port 10592 of the mixed water connector 10500. The predetermined distance (d_{f}) being substantially equal to the depth of the outlet port 10592, 10594, such that when the water group coupler 10600 is coupled with the valve body housing 10140, an extent of the water group coupler 10600 engages with the limit face 10338 of the mixed water discharge tube 10330 (FIG. 135).

Unlike the first and second types of inlet/outlet group 300 the mixed water outlet line 10330 is not preconfigured with a connector. Instead, both the coupling end and the connector end 10332, 10334 of the mixed water outlet line 10330 include the same coupler 10336 (shown as 10336a, 10336b), which can simplify assembly within the faucet. As shown in FIG. 140, the faucet outlet tube 10410 includes coupler 10418 at the connector end and has the same configuration as coupler 10336 and is suitable to fully engage with connector port 10594 of the mixed water connector 10500.

### C. Third Embodiment of Water Group Coupler

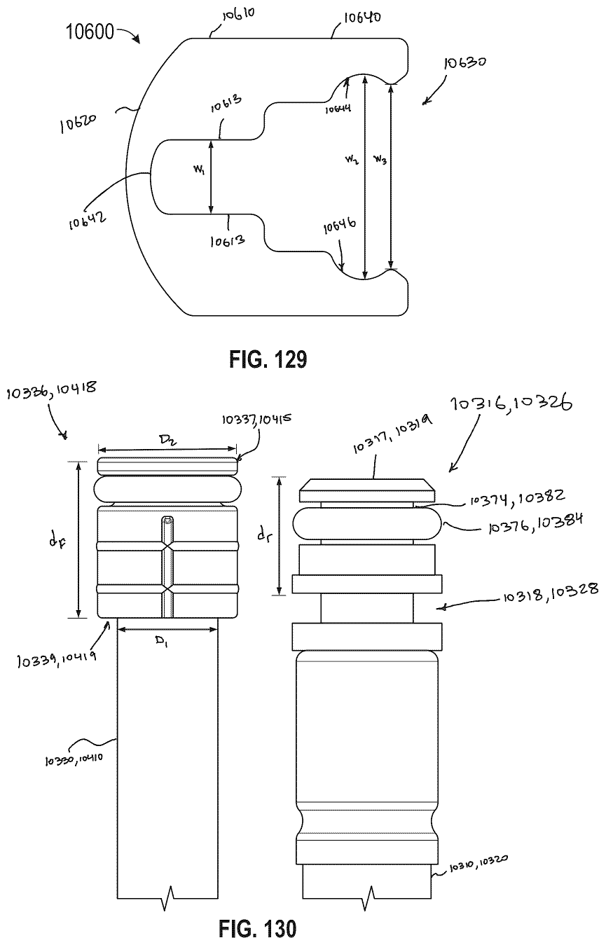

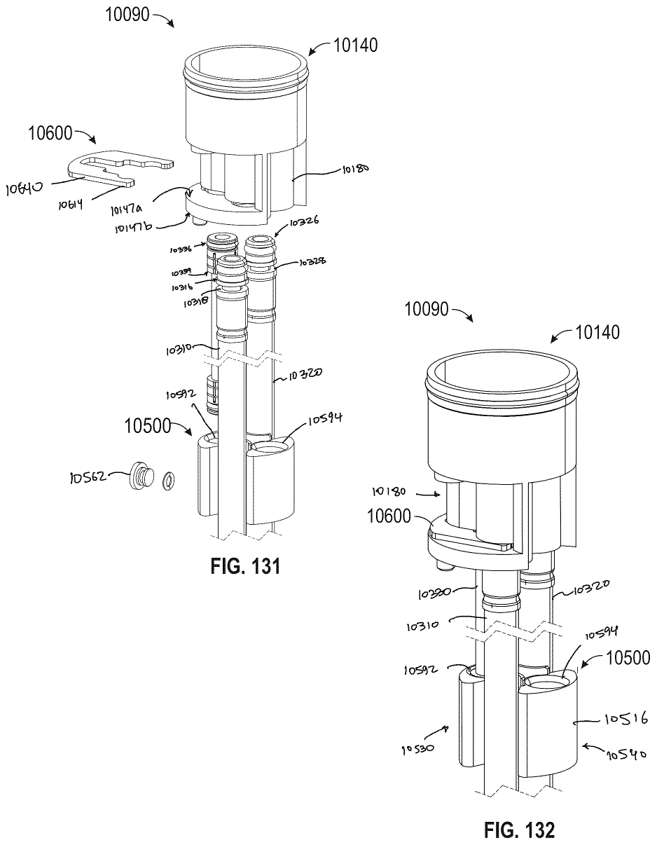

Shown in FIGS. 129 and 131, the water group coupler 10600 may have a planar body having a handling portion 10620 and a curvilinear receiving portion 10630 opposite the handling portion 10620. The water group coupler 10600 having a first surface 10616 and a second surface 10618 and a thickness suitable to be received into the clip mounting slots 10181, 10183, 10185a, 10185b of the valve body housing 10140. In the example shown, the receiving portion 10630 is configured with a pair of arms 10640 extending from the handling portion 10620. The pair of arms 10640 being spaced apart. The curvilinear receiving portion 10630 formed between the pair of arms 10640 and suitable to engage the clip mounting slots 10181, 10183, 10185a, 10185b of the valve body housing 10140 to secure the inlet lines 10310, 10320 and mixed outlet tube 10330. The planar body portion 10610 further comprising a pair of edge portions 10612 along the exterior edges of the pair of arms 10640, facing interior edge portions 10613, and pair of tip portions 10614 at the distal end of each of the pair of arms 10640. The curvilinear receiving portion 10630 of the water group coupler 10600 configured to receive an extent of an outer diameter of each of the inlet and outlet tubes 10310, 10320, 10330. For example, the shape of the curvilinear receiving portion 10630 may include extents that contact the mixed water discharge tube 10330 below the connection first end portion 10336 such that an extent of the limit face 10616 of the water group coupler 10600 abuts an extent of the limit face 10338 of the mixed water discharge tube 10330.

As shown in FIGS. 129 and 135, the receiving portion 10630 may be shaped with a first curved indent 10642 sized to receive at least an extent of the mixed water tube 10330. The first curved indent 10642 is adjacent to the handling portion 10620, between arms 10640. The interior edge portions 10613 may be substantially parallel within the first curved indent 10642, with a width (w₁) between edges configured to contain the mixed water tube 10330 at a diameter portion (D₁). The limit face 10339 of the second end portion 10338 arranged to be in contact with the limit face 10616 of the water group coupler 10600, when engaged with the valve body housing 10140. A second curved indent 10644 and third curved indent 10646 are positioned symmetrically and sized to receive at least an extent the first water inlet line 10310 and second water inlet line 10320, respectively. For example, the arcuate curvature of the second and third curved indents 10644, 10646 is configured to mate with an arcuate portion of the external surface of the respective inlet line 10310, 10320. The second and third curved indents 10644, 10646 are spaced adjacent to the tip portions 10614, where the tip portion 10614 is shaped with a limiting feature 10615 such that the water group coupler 10600 will snap on the inlet tubes 10310, 10320 at the clip mounting slots 10181, 10183, 10185a, 10185b. For example, the width (w₂) between the interior edges 10613 of second and third curved indents 10644, 10646 at the widest position is greater than the width (w₃) between the interior edges 10613 at the limiting feature at the tip portion 10614 of the receiving portion 10630.

### D. Assembly of Third Embodiment of a Water Inlet and Outlet Group

As shown in an exploded view in FIG. 131, the first water inlet line 10310, the second water inlet line 10320, and the mixed water discharge tube 10330 configured to be coupled with the valve body housing 10140. Couplers 10316, 10326, 10336 are configured for a friction fit within ports 10172, 10174, 10176 of the valve body housing 10140. The water lines 10310, 10320, 10330 are secured to the valve body housing 10140 by a water group coupler 10600. The water group coupler 10600 is received into the clip slots 10181, 10183, 10185a, 10185b of the valve body housing 10140 to secure the couplers 10316, 10326, 10336 of the water lines 10310, 10320, 10330 into the valve body housing 10140.

As shown in FIG. 135, when the water group coupler 10600 is secured in the valve body housing 10140, certain extents of the receiving portion 10630 are in contact with an extent of each of the water lines 10310, 10320, 10330. The water group coupler 10600 is in contact with the limit face 10339 of coupler 10338 and surrounds an extent of mixed water line 10330 diameter portion (D₁). The water group coupler 10600 is also in contact with extents of annular groove 10318, 10328 of inlet lines 10310, 10320. Although the water group coupler 10600 is described with distinct features to couple with inlet lines 10310, 10320, the water group coupler 10600 can be substantially symmetrical and can be relied on regardless of which planer surface 10616, 10618 is facing the limit face 10339 of the second end portion 10338.

### E. Ninth Embodiment of Mixed Water Connector

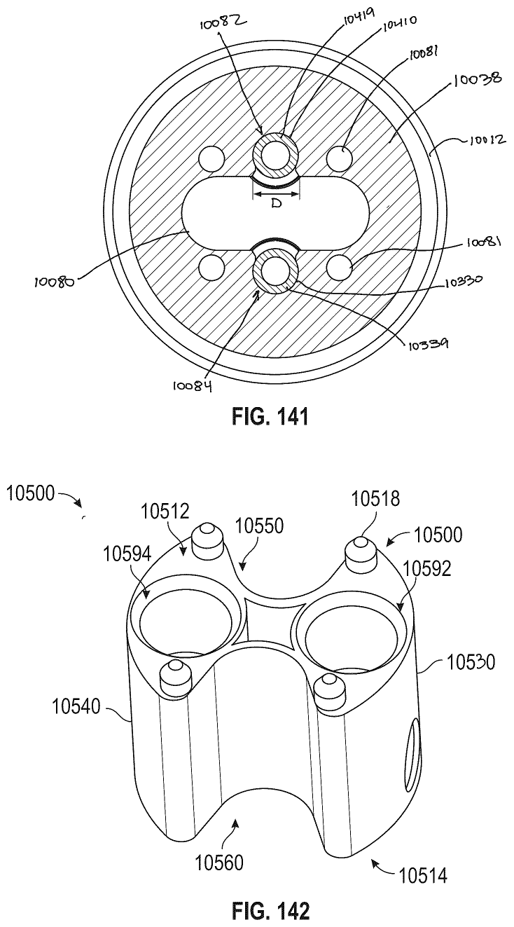

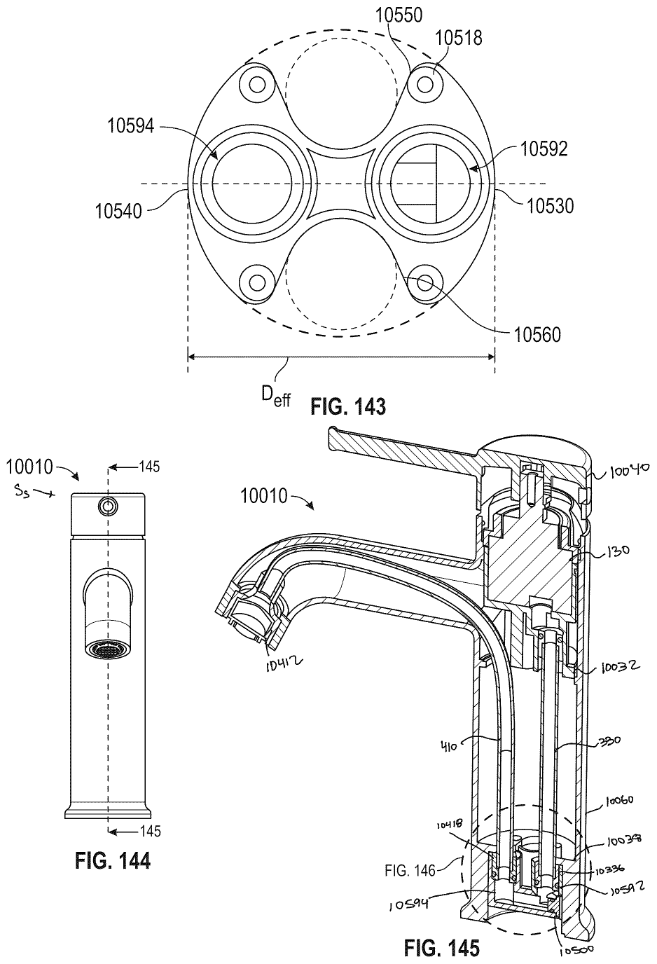

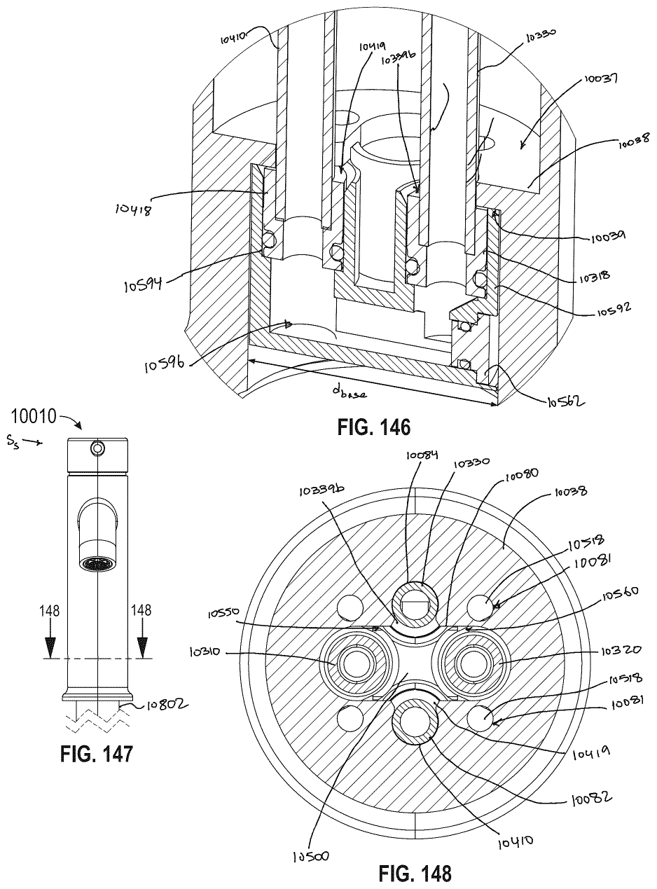

As shown in FIGS. 142-143, the mixed water connector 10500 may be a single body having first and second surfaces 10512, 10514 and an external surface 10516 therebetween. The mixed water connector 10500 includes connector ports 10592, 10594. The connector inlet port 10592 suitable to receive the coupler 10336b on a connection end of the mixed water discharge tube 10330. The connector outlet port 10594 is suitable to receive the coupler 10418 of the faucet outlet tube 10410. As shown in FIG. 146, the connector inlet and outlet ports 10592, 10594 are fluidly connected via an internal passage 10596. The mixed water connector 10500 may be formed in a manner that requires a plug 10562, with or without a sealing member 10564, a hole in the sidewall. To secure said plug 10562 to the sidewall of the fluid flow connector 10500, the cap is bonded (e.g., laser welded) to said sidewall in order to provide a water tight water flow connector 10500.

The external surface 10516 may have opposing curvilinear extents 10530, 10540 having the same radius. The mixed water connector 10500 is configured to span an internal diameter (d_{base}) of base portion 10060 of the main body 10030 of the faucet housing 10020. As shown in FIG. 143, the mixed water connector 10500 is configured to have an effective diameter (d_{eff}) that is substantially similar to the internal diameter (d_{base}) of base portion 10060 (FIG. 146). The mixed water connector 10500 also includes a first external recess 10550 and a second external recess 10560 formed on opposite sides of the mixed water connector 10500. The first and second recesses 10550, 10560 to accommodate the inlet lines 10310, 10320 (shown as dashed circles) as the mixed water connector 10500 is positioned to accept the mixed water discharge tube 10330 and the faucet outlet tube 10410 within the faucet base 10060.

The mixed water connector 10500 is configured to cooperate with the lower mounting shelf 10038 and an extent of the mounting assembly 10800 to secure the position of the mixed water connector 10500 within the faucet housing 10020. Shown in FIG. 148, the waterway opening 10080 of the lower mounting shelf 10038 has pair of rounded outlet recesses 10082, 10084 configured to accept and secure the mixed water discharge tube 10330 and the faucet outlet tube 10410 such that the second ends of the tubes 10330, 10410 are below the lower mounting shelf 10038 and at least a portion of the end face 10339b, 10419 of each connector abuts the lower surface 10039. The lower mounting shelf 10038 also includes a plurality of alignment holes 10081 (FIG. 141). The mixed water connector 10500 may have alignment pins 10518 protruding from the first surface 10512 that correspond to the alignment holes 10081 of the lower mounting shelf 10038 (FIG. 148). The second surface 10514 may be substantially flat and configured to engage with an end surface 10812 of the mounting assembly 10800. In an embodiment, said mounting assembly 10800 can include a mounting shank 10802 (not shown). Said mounting shank 10802 is designed to have an outer perimeter (outer diameter) that substantially matches the inner perimeter or internal diameter (d_{base}) of base portion 10060 of the faucet housing 10020. Additionally, the outer perimeter (outer diameter) of the mounting shank 10802 substantially matches the outer perimeter (outer diameter) of the mixed water connector 10500. This design allows the mounting shank 10802 to apply substantially even pressure on the second surface 10514 of the mixed water connector 10500 to hold said connector in place.

### F. Assembly of the Faucet

The SHUP system 10090 of FIG. 125 is configured to be installed in a faucet housing 10020. In particular, faucet housing 10020 is a slim-line housing with a main body 10030 narrow diameter. The faucet housing 10020 includes an upper step 10032 projects inward from the housing wall 10012 and a lower mounting shelf 10038 that projects inward from the housing wall 10012 and spans the hollow interior 10014 within a base portion 10060 of the main body 10030. As discussed above, the lower mounting shelf 10038 includes a waterway opening 10080 and pair of rounded outlet recesses 10082, 10084 that extend from the waterway opening 10080 (FIGS. 141 and 148). When assembling the faucet 10010, the inlet lines 10310, 10320 are inserted from the bottom of the faucet housing 10020, through the waterway opening 10080, and extended upward to connect to the valve body housing 10140, due to the limited size of the waterway opening 10080 compared to supply end connectors that may have larger dimensions than said opening 10080.

The faucet system 10010 includes the SHUP system 10090 contained within the faucet housing 10020. The faucet system 10010 is assembled by first passing the faucet outlet tube 10410 through the spout 10050 and into the main body 10030 of the faucet housing 10020. As shown in FIG. 139, the outlet adapter 10412 at one end of the faucet outlet tube 10410 can be attached at the outlet of the spout 10050. The opposite end of the faucet outlet tube 10410 including the coupler 10418 is passed through the waterway opening 10080 of the lower mounting shelf 10038, then fixed to the faucet housing 10020 by inserting an extent of the faucet outlet tube 10410 in to a front rounded recess 10082 of the waterway opening 10080.

Shown in FIG. 141, the lower mounting shelf 10038 may include first and second surfaces 10037, 10039 with a waterway opening 10080 and a set of alignment holes 10081 therethrough. The waterway opening 10080 of the lower mounting shelf 10038 has a curvilinear shape with a pair of rounded outlet recesses 10082, 10084 extending from an oblong central opening 10086. For example, the pair of rounded outlet recesses 10082, 10084 may include a front recess 10082 to accommodate the faucet outlet tube 10410 and a rear recess 10084 to accommodate the mixed water discharge tube 10330. When installed, the first end 10412 of the faucet outlet tube 10410 is attached at the spout outlet 10052 and an opposite end portion of the faucet outlet tube 10410 is positioned within a front rounded recess 10082 of the waterway opening 10080 in the lower mounting shelf 10038 with coupler 10418 beneath.

Next, the inlet lines 10310, 10320 and mixed water outlet line 10330 are coupled to the valve body housing 10140. The inlet lines 10310, 10320 are inserted into the main body 10030 from the bottom of the faucet housing 10020. The couplers 10316, 10326 of inlet lines 10310, 10320 are passed through the waterway opening 10080 and extended through the main faucet body 10030 to be received into the first and second inlet ports 10172, 10174 of the valve body housing 10140. The first coupler 10336a of the mixed water outlet line 10330 is received into the outlet port 10176. The water group coupler 10600 is received into the clip slots 10181, 10183, 10185a, 10185b of the valve body housing 10140 to secure the first end portions 10316, 10326 of the inlet lines 10310, 10320 and mixed water discharge tube 10330 into the valve body housing 10140 (FIGS. 131-135).

With the inlet and outlet water group 10300 coupled to the valve body housing 10140 by water group coupler 10600, the valve body housing 10140 is positioned on the upper step 10032 within the main body 10030 of the faucet housing 10020. The position feet 10159 extending from a base bottom surface 10147b that may be received in positioning holes 10034 (not shown) of the upper step 10032 for proper alignment. The valve body housing 10140 is positioned such that the first and second water inlet lines 10310, 10320 extend into the main body 10030 of the faucet housing 10020 and through the waterway opening 10080 of the lower mounting shelf 10038. The mixed water line 10330 extends into the main body 10030 of the faucet housing 10020 and is passed through the waterway opening 10080 and coupled to the faucet housing 10030 at the rear rounded recess 10084 by the coupler 10336 of the mixed water line 10330. As shown without the inlet lines 10310, 10320 in FIGS. 139-141, the respective end faces 10339, 10419 of couplers 10338, 10418 abut the bottom surface 10038 of the lower shelf 10038. As shown in FIG. 148, when assembled, the water inlet and outlet group 10300 and faucet outlet tube 10410 are arranged in a space saving manner within the slim line faucet 10010.

Shown in FIG. 141, the coupler 10418 of the faucet outlet tube 10410 may have a connector portion with a diameter (D₂) larger than the diameter (D₁) of the faucet outlet tube 10410 and a facing surface 10419 a distance from the first end 10417 of the faucet outlet tube 10410. The limit face 10419 of the coupler 10418 is defined on a surface of the coupler 10418 between D₁ and D₂. For example, the coupler 10418 of the water discharge tube 10410 may have substantially the same features as the couplers 10336a, 10336b of the mixed water tube 10330. The waterway opening 10080 configured for passage at least one end of each of inlet lines 10310, 10320 and outlet tubes 10330, thus the width of the oblong portion is greater than at least the diameter (D₂). The rounded outlet recesses 10082, 10084 may be a C-type mounting hole being a substantially circular opening that intersects with the oblong portion. As such, the faucet system 10010 may include two rounded outlet recesses 10082, 10084 or C-type mounting holes. As shown in FIG. 141, the entry opening 10083, 10085 of the c-shaped rounded outlet recess 10082, 10084 may have a dimension D that is smaller than diameter D₁ of the faucet outlet tube 10410 such that once assembled, the faucet outlet tube 10410410 will not come out easily. When positioned in the rounded outlet recess 10082, 10084, at least an extent of the facing surface 10419 of the faucet outlet tube 10410 abuts a bottom surface 10039 of the lower mounting shelf 10038 (FIG. 140).

Next, the mixed water connector 10500 may be inserted from the bottom of the faucet housing 10020. The water inlet lines 10310, 10320 are positioned within the recesses 10550, 10560 of the mixed water connector 10500 such that the waterway connector may slide into the base portion 10060 of the main body 10030 to couple the mixed water discharge tube 10330 and the faucet outlet tube 10410 for a fluid connection. The couplers 10338, 10418 of the mixed water line 10330 and faucet outlet tube 10410 are received into the ports 10592, 10594 of the mixed water connector 10500. The recesses 10550, 10560 of the mixed water connector 10500 are adapted to arrange extents of the first and second water inlet lines 10310, 10320 within the faucet housing 10020. The mixed water connector 10500 may be secured within the faucet housing 10020 by an end surface 10812 of a mounting shank 800 used to mount the faucet housing 10020 to a support surface 85 and through which the water inlet lines 10310, 10320 pass to connect to the water supply.

In FIG. 145, the water outlet connections and water flow are shown in a cross-sectional view through outlet tubes 10330, 10410, shown without the inlet lines 10310, 10320. The fluids received and mixed in the mixing cartridge 130 may be delivered through the mixed water discharge tube 10330. A first end portion 10336 of the mixed water discharge tube 10330 may be coupled to an outlet port 10176 of the waterway base portion 10144 and the second end portion 10338 may be received in the mixed water connector 10500 in a first connector port 10592. A first end portion 10412 of the faucet outlet tube 10410 may be coupled to the spout outlet 10052 and the second end portion 10418 received into a second connector port 10594 of the mixed water connector 10500 to complete a fluid connection from the mixing cartridge 130 to the outlet 10052 of the spout 10050 of the faucet housing 10020.

The mounting assembly 10800 may be installed such that the end surface 10812 of the mounting shank 800 is in contact with an extent of the bottom surface 10560 the mixed water connector 10500. The mixed water connector 10500 is secured within the main body 10030 between a lower surface 10039 of the mounting shelf 10038 and the end surface 10812 of the mounting assembly 800. Installation may be completed by installing the mixing cartridge 130 within the valve body housing 10140. The retaining nut 10120 is positioned to secure the mixing cartridge 130 and the handle 10040 is attached to the housing 10020. In this embodiment, the valve body housing 10140 does not include a threaded portion, thus the retaining nut 10120 is not directly coupled to the valve body housing 10140 but retains the mixing cartridge within the hollow interior 10150.

As shown in FIG. 145, the valve body housing 10140 is positioned on the upper step 10032 with the mixing cartridge or valve 130 received therein and secured by the retaining nut 10120. The valve body housing 10140 may include an interior portion 10150 to receive the mixing cartridge 130 and a waterway base portion 10144 that provides an interface for fluid communication between the water inlet and outlet group 10300 and the mixing cartridge 130 via passages 10168. The first water inlet line 10310 and a second water inlet line 10320 are coupled to the valve body housing 10140 for fluid communication with the mixing cartridge 130. The mixed water discharge tube 10330 is coupled to the valve body housing 10140 for fluid communication with the mixing cartridge 130. The first water inlet line 10310, the second water inlet line 10320, and the mixed water discharge tube 10330 are secured to the valve body housing 10140 by a water group coupler 10600. The valve body housing 10140 is positioned on the upper step 10032 within the main body 10030 of the faucet housing 10020 such that the first water inlet line 10310, the second water inlet line 10320, and the mixed water tube 10330 extend into the main body 10030 of the faucet housing 10020 and through the waterway opening 10080 of the lower mounting shelf 10038. A mixed water connector 10500 may be inserted into the main body 10030 from the bottom of the faucet housing 10020 to couple the mixed water discharge tube 10330 and the faucet outlet tube 10410. The mixed water connector 10500 may include recesses 10550, 10560 adapted to arrange extents of the first and second water inlet lines 10310, 10320. The mixed water connector 10500 may be secured within the faucet housing 10020 by an end surface 10812 of the mounting assembly 10800 used to mount the faucet housing 10020 to a support surface 85.

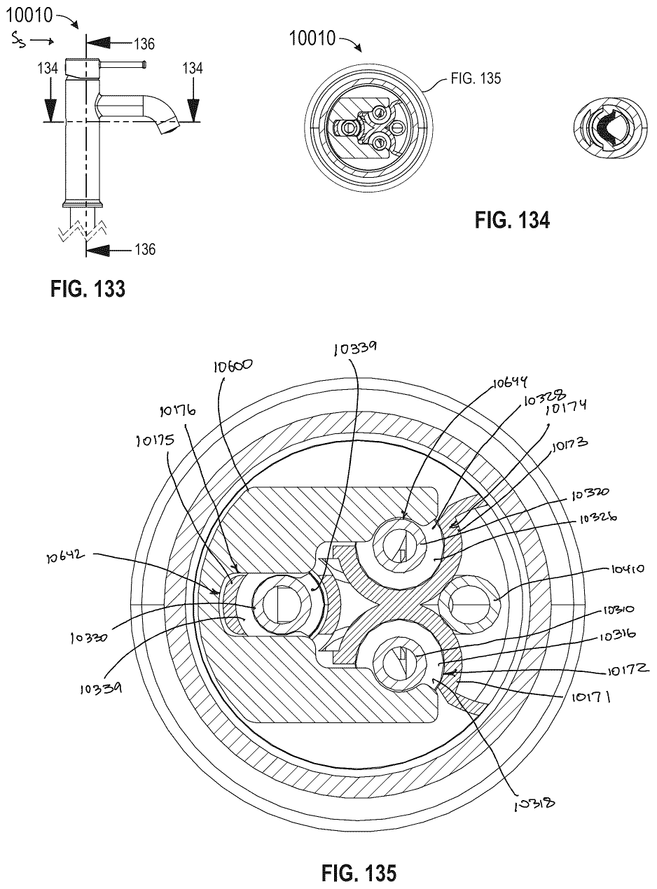

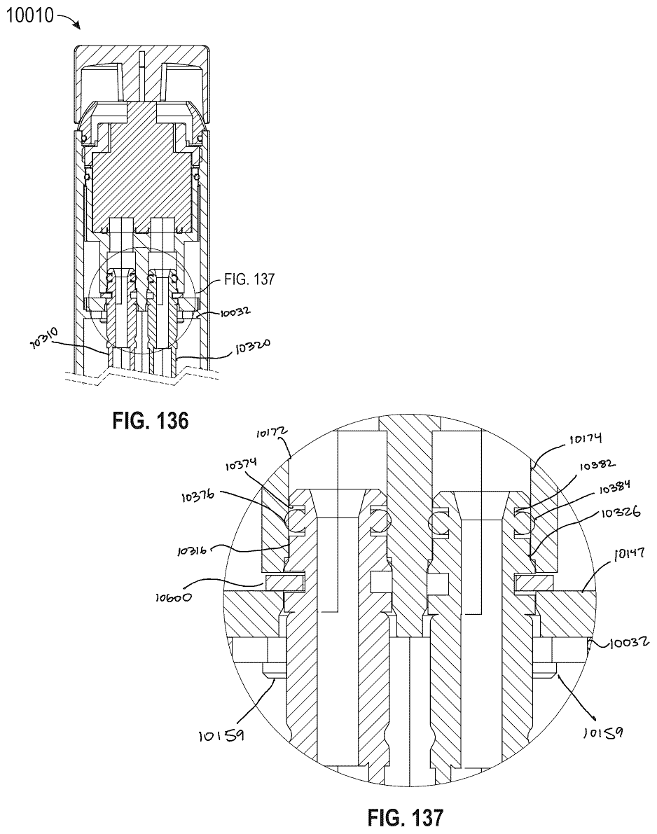

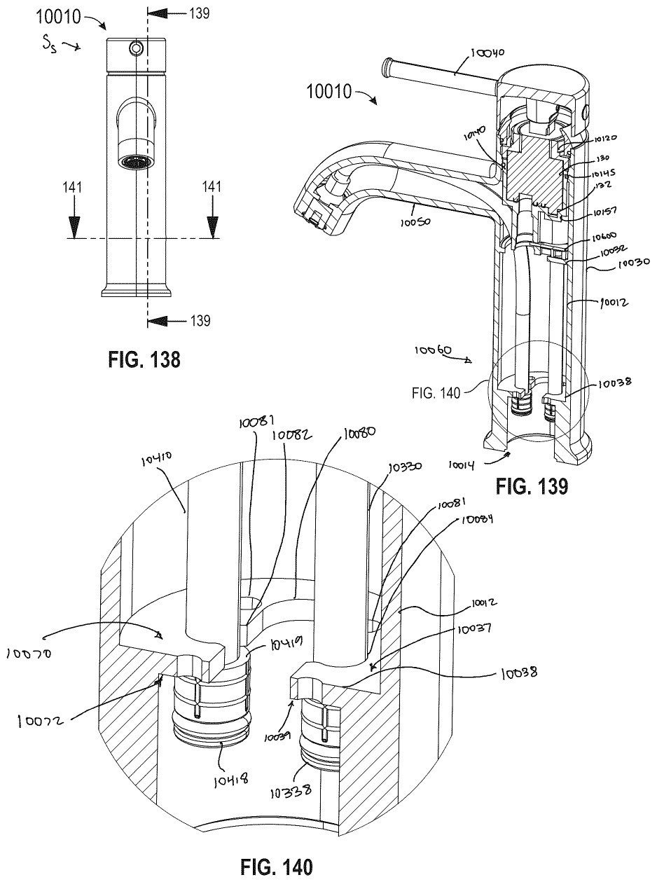

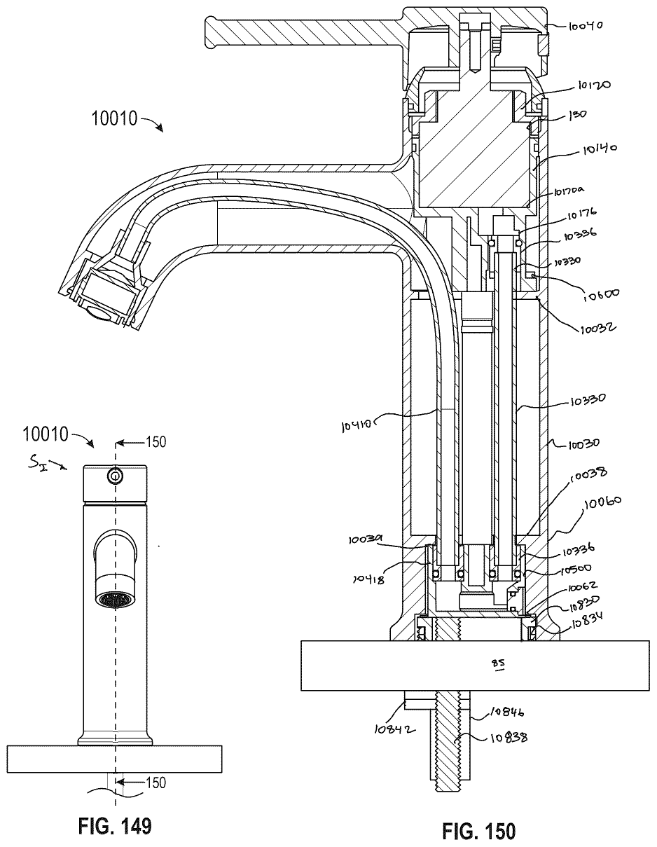

FIGS. 149-150 show an alternative embodiment of a mounting assembly 10800 that may be used with the faucet system 10. In particular, the alternative embodiment of said mounting assembly 10800 is configured to replace the mounting shank 800 shown in FIGS. 133 and 147. The alternative mounting assembly 10800 includes: (i) a base plate 10830, (ii) a locking member 10834, (iii) an elongated mounting bolt 10838, (iv) a locking plate 10842, and (v) a locking nut 10846. The base plate 10830 and the locking member 10834 are configured to be inserted within a lower extent of the faucet housing 10020 and between: (i) the top side of the support surface 85, and (ii) the lower surface of the mixed water connector 10500. The positional arrangement of these components provides a “compression effect” or “sandwiching effect” that helps ensure that the mixed water connector 10500 remains properly coupled with the inlet water lines 10310, 10320 and outlet tube 10330. The base plate 10830 also includes a threaded opening that is configured to receive an extent of the mounting bolt 10838 (as shown in FIG. 150). Said mounting bolt 10838 is configured to be inserted through the support surface 85 and completely through the support surface 85 to enable the opposed end of the mounting bolt 10838 to be inserted into an extent of the locking plate 10842 and the locking nut 10846. As such, the locking nut 10846 is designed to apply pressure on the locking plate 10842, which in turn applies pressure to a lower surface of the support surface 85 in order to properly secure said faucet system 10010 to said support surface 85. It should be understood that other ways of coupling said faucet system 10010 to a support surface 85 is contemplated in this application. For example, other combinations of clips, threaded components, or other mechanical fastener/fastener assemblies may be utilized.

FIG. 150 shows an extent of the SHUP system 10090 installed within the faucet housing 10020. When positioned in the faucet housing 10020, (i) the inlet lines 10310, 10320 are contained within the first and second external recesses 10550, 10560, (ii) the mixed water discharge tube 10330 is seated within the connector inlet port 10592, (iii) the faucet outlet tube 10410 is seated within the connector outlet port 10594, (iv) the alignment pins 10518 if the mixed water connector 10500 are received in the alignment holes 10081 of the lower mounting shelf 10038, and (v) the mounting assembly 10800 is secured to the faucet body with the end face 10812 of the mounting assembly 10800 abutting the second surface 10514 of the mixed water connector 10500.

### G. Alternate Valve Body Housing and Clip Arrangements

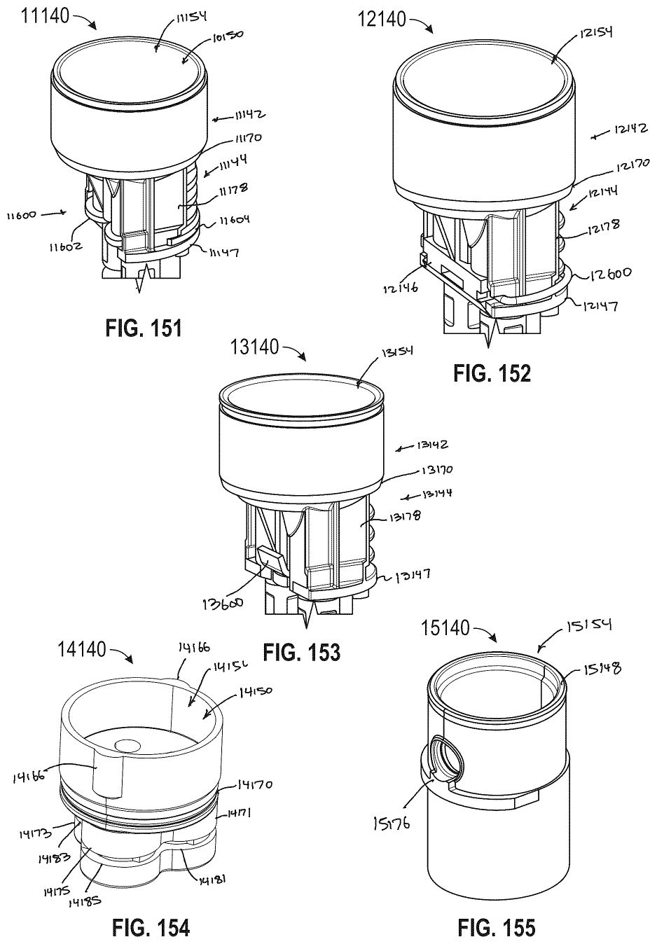

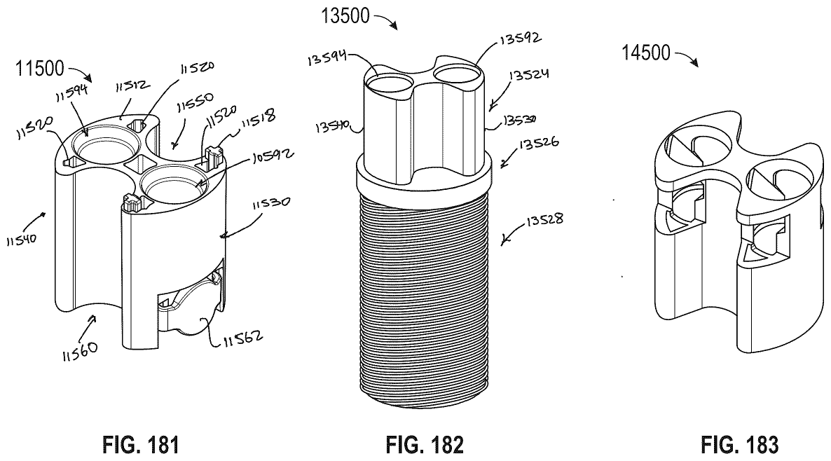

The SHUP system 10090 of FIG. 125 can be configured to include various embodiments of the valve body housing 10140, using the same or alternate embodiments or assemblies of the water inlet and outlet group 10300, the mixed water connector 10500, and faucet outlet tube 10410. For example, as shown in FIGS. 151-154, the valve body housing 10140 can be replaced with alternate valve body housing embodiments 11140, 12140, 13140, or 14140 in various faucet systems. Similarly, the mixed water connector 10500 can be replaced with alternate mixed water connector embodiments 11500, 13500, or 14500, shown in FIGS. 181-183. In some examples, the water inlet and outlet group 10300 with alternate inlet/outlet lines and the mixed water connector 10500 can be replaced with alternate mixed water connector embodiments 500, 1500, 2500, 3500, 4500, 5500, 6500, or 12500 (see FIGS. 58, 105-110, 171). An additional valve body housing embodiment 15140 for a direct mixed water outlet for a slim line faucet. The alternate embodiments of a valve body housing, mixed water connector, and/or water inlet and outlet group may be selected based on the configuration of the faucet housing, customer specifications, or other requirements.

i. Tenth Embodiment of the Valve Body Housing

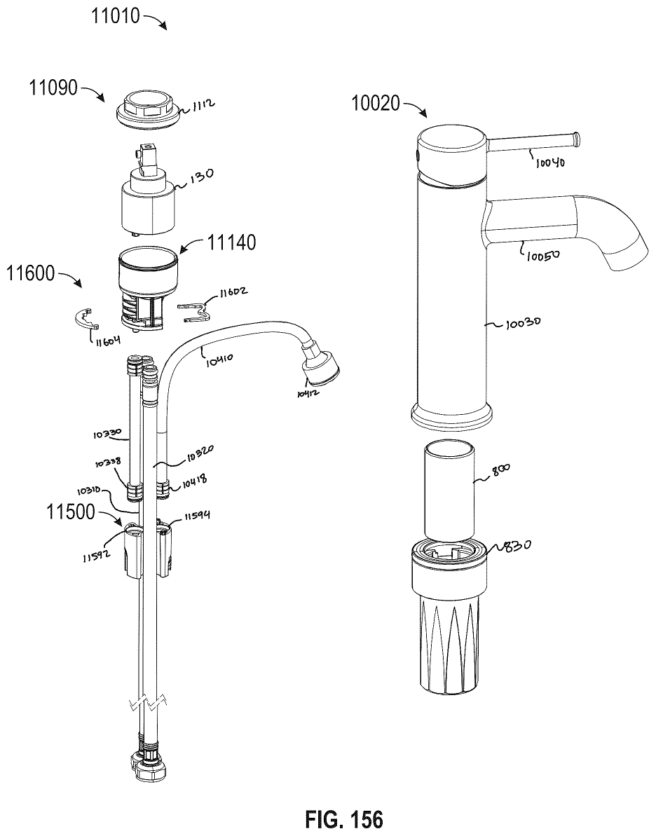

Shown in an exploded view in FIG. 156, faucet system 11010 includes a tenth embodiment of the SHUP system 11090 contained in a faucet housing 10020. The SHUP system 11090 includes a tenth embodiment of a valve body housing 11140, a third type of an inlet and outlet water group 10300, a fourth embodiment of a water group coupler 11600, and a tenth embodiment of the mixed water connector 11500. The mixed water connector 11500 is similar to mixed water connector 10500 (FIG. 125) and will be described in further detail below. The valve body housing 11140 is configured to receive the inlet and outlet water group 10300 in a similar manner as described with respect to valve body housing 10140, substituting water group coupler 11600 which is configured to cooperate with valve body housing 11140.

For sake of brevity, the above disclosure in connection with valve body housing 10140 will not be repeated below, but it should be understood that across embodiments, like numbers represent like structures. For example, the disclosure relating to valve body housing 10140 applies in equal force to valve body housing 11140. The primary difference between the ninth embodiment of the valve body housing 10140 and this tenth embodiment of the valve body housing 11140 are modifications to receive an alternate two-piece water group coupler 11600. In particular, the shape of the waterway base portion 11144 is modified and the arrangement of the clip mounting slots 11181, 11183, 11185 are modified for engagement with a two-piece water group coupler 11600.

As shown in FIG. 159, the tenth embodiment of the valve body housing 11140 is configured to receive a two-piece water group coupler 11600. The waterway base portion 11144 is modified so that the first clip 11602 can be received from the front to interface with the inlet lines 10310, 10320 and the second clip 11604 can be received from the rear to interface with the mixed water line 10330 and couple with the first clip 11602. Similar to valve body housing 10140, each of the first inlet port 11172 and the second inlet port 11174 are formed within the interface base 11170 of the waterway base portion 11144 having port walls 11171, 11173 with interior diameters suitable to receive the couplers 10316, 10326 of the inlet lines 10310, 10320. Similarly, the outlet port 11176 is formed within the waterway base portion 11144 having an outlet port wall 11175 with an interior diameter suitable to receive the coupler 10336 of the mixed water outlet line 10330. However, clip mounting slots 11181, 11183, 11185 are arranged in a different manner to accommodate water group coupler 11600 and the valve body housing 12140 may additionally include one or more shaping wall 11178 formed with or adjacent to the port walls 11171, 11173 configured to provide an aesthetic shape and/or additional structure to the valve body housing 11140. The shaping walls 11178 can be two parallel walls positioned on opposite external sides of the valve body housing 11140 at the port walls 11171, 11173.

As shown in FIG. 159, clip mounting slots 11181, 11183, 11185 are formed through an extent of each port wall 11171, 11173, 11175 and positioned adjacent to a top surface portion 11147a of the base 11147 of the valve body housing 11140. For example, port wall 11171 may include mounting slot 11181 on one side of the valve body housing 11140 and port wall 11173 may include mounting slot 11183 on the opposite side of the valve body housing 11140. The mounting slots 11181, 11183 are covered externally by shaping walls 11178, which together with the base 11147 form coupling slots 11179 configured to receive arms 11640 of the first clip 602. Additionally, port wall 11175 may include mounting slot 11185 at the back side of the valve body housing 11140 configured to receive an extent of the second clip 11604.

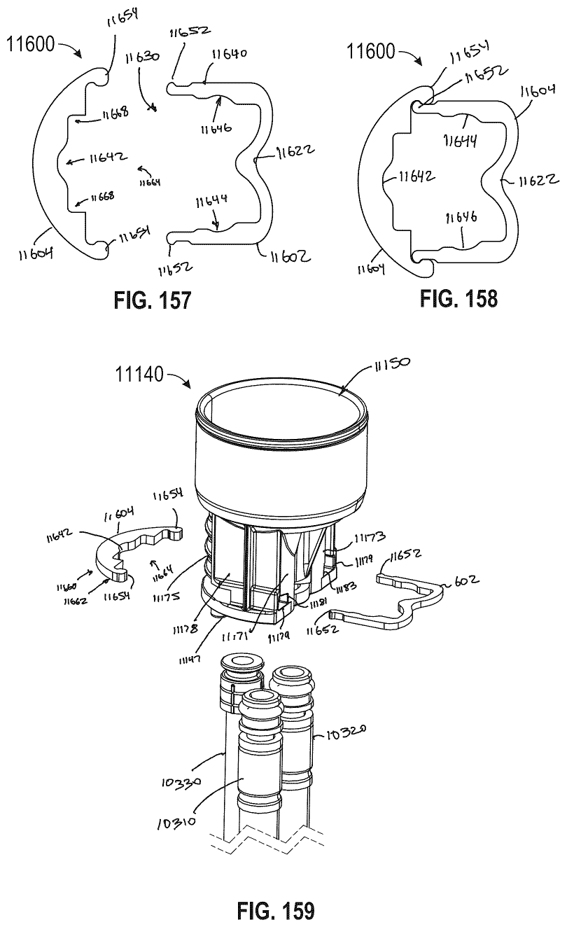

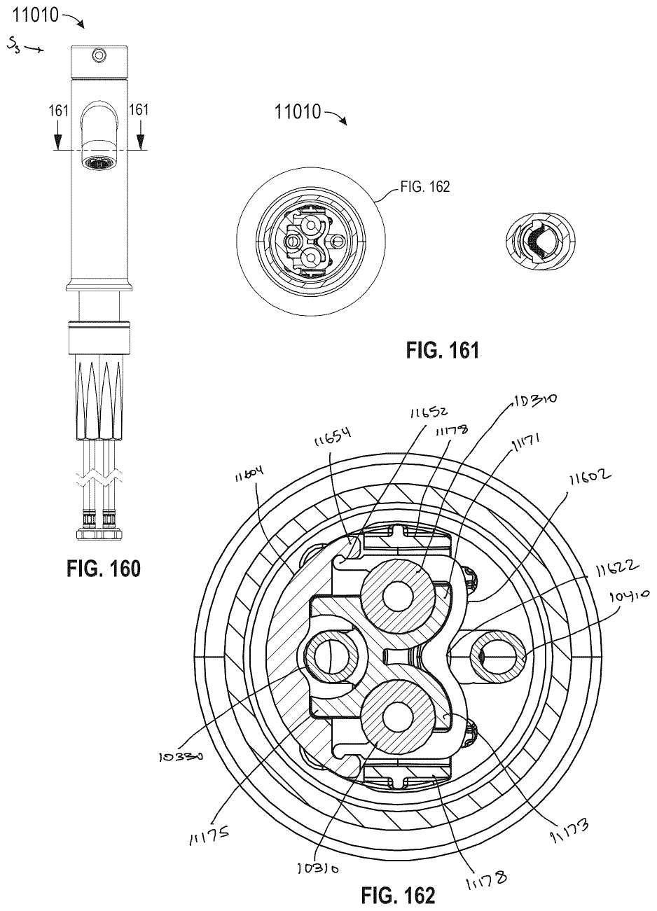

As shown in FIGS. 157-159, the two-piece water group coupler 11600 includes a first and second clip 11602, 11604 that are configured to be received on opposite sides of the valve body housing 11140. The first clip 11602 is substantially planar and includes a handling portion 11620 and two arms 11640 extending from the handling portion 11620 forming an interior curvilinear receiving portion 11630. The two arms 11640 including substantially flat exterior edge portions 11612, substantially parallel, and configured to be guided by the shaping walls 11178 of the coupling slots 11179. The curvilinear receiving portion 11630 includes curved indents 11644, 11646 along the interior of the arms 11640 shaped to secure extents of inlet lines 10310, 10320 within mounting slots 11181, 11183. The curvilinear receiving portion 11630 is further shaped to conform with extents of external surfaces of the port walls 11171, 11173. The handling portion 11620 may also include an exterior edge indent 11622 configured to accommodate passage of the water discharge tube 10410. For example, the first clip 11602 may resemble the shape of a flattened number 3 or a rounded W with substantially parallel edge portions. The tip portion 11614 of each arm 11640 of the first clip 11602 includes an outward facing latch portion 11652 (e.g. hook, nub, rim) formed at least partially by an indention in the substantially flat exterior edge portions 11612. The second clip 11604 includes a curvilinear receiving portion 11631 with curved indent 11642 shaped to secure an extent of mixed water line 10330.

The second clip 11604 is substantially planar and includes a rounded handling portion 11660 that extends symmetrically to blunt tip portions 11662 and a curvilinear receiving portion 11664 opposite the handling portion 11660. The curvilinear receiving portion 11664 includes a centered curved indent 11642 configured to hold an extent of the mixed water outlet line 10330, symmetrical indents 11668 shaped to abut limiting extents of the port wall 11175 within the mounting slot 11185, and an inward facing catch portion 11654 at the tip portions 11662 configured to couple with the outward facing latch portion 11652 of the first clip 602 (FIG. 158).

As shown in FIG. 162, when installed in the valve body housing 11140, the arms 11640 of first clip 11602 are received within the coupling slots 11179 such that the tips 11614 including the catch portion 11652 extend beyond the shaping wall 11178, extents of inlet lines 10310, 10320 within mounting slots 11181, 11183 are in contact with indents 11644, 11646, and extents of the curvilinear receiving portion 11630 abut extents of port walls 11171, 11173. The second clip 11604 is fully inserted within mounting slot 11185 such that indent 11642 is in contact with an extent of mixed water line 10330 and the catch portion 11654 couples with the latch portion 11652 of the first clip 11602.

ii. Eleventh Embodiment of the Valve Body Housing

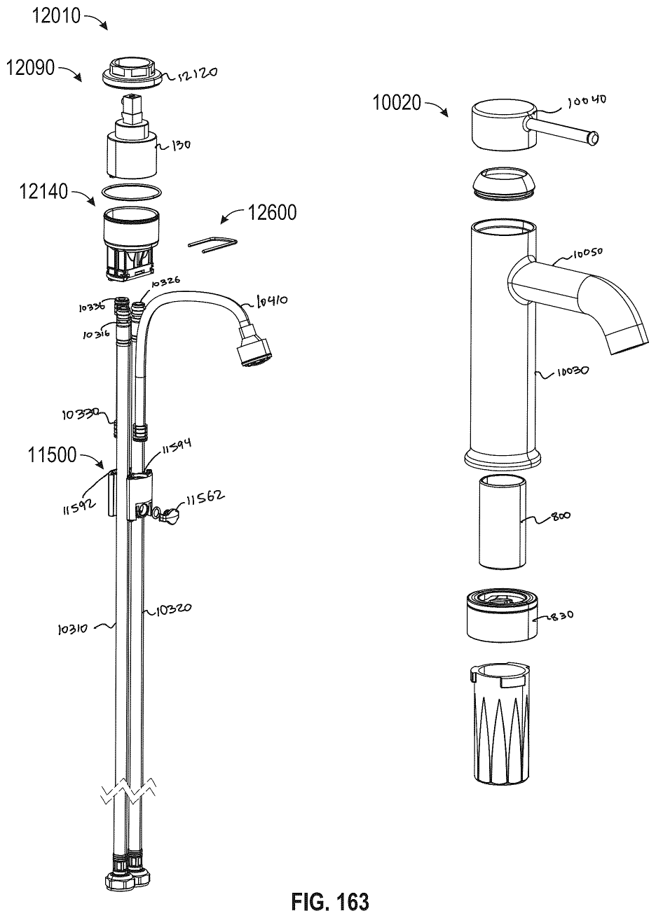

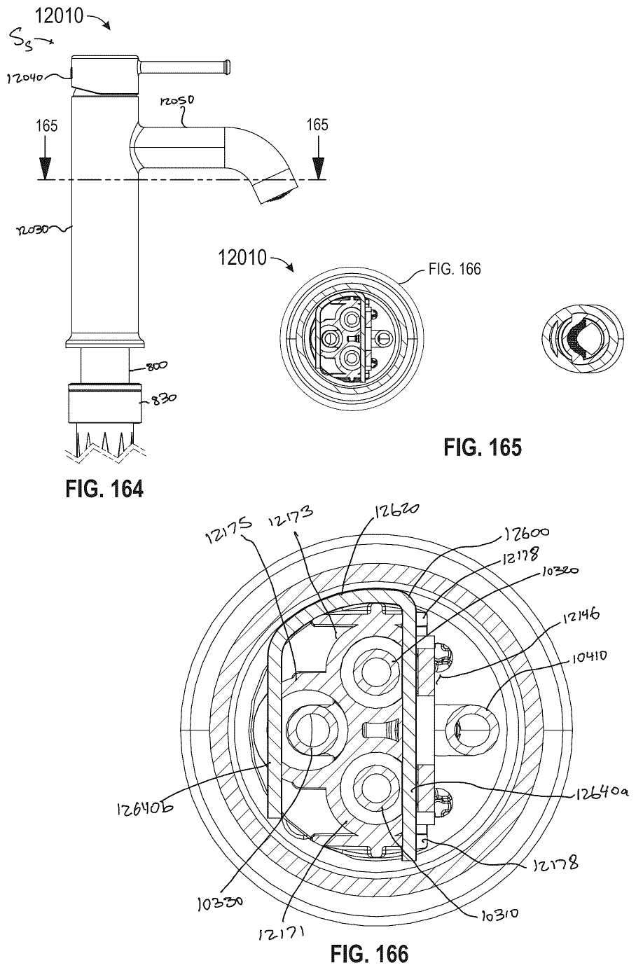

Shown in an exploded view in FIG. 163, faucet system 12010 includes an eleventh embodiment of the SHUP system 12090 contained in a faucet housing 10020. The SHUP system 12090 includes an eleventh embodiment of a valve body housing 12140, a third type of an inlet and outlet water group 10300, a fifth embodiment of a water group coupler 12600, and a tenth embodiment of the mixed water connector 11500. The mixed water connector 11500 is similar to mixed water connector 10500 (FIG. 125) and will be described in further detail below. The valve body housing 12140 is configured to receive the inlet and outlet water group 10300 in a similar manner as described with respect to valve body housing 10140, substituting water group coupler 12600 which is configured to cooperate with valve body housing 12140.

For sake of brevity, the above disclosure in connection with valve body housing 10140 will not be repeated below, but it should be understood that across embodiments, like numbers represent like structures. For example, the disclosure relating to valve body housing 10140 applies in equal force to valve body housing 12140. The primary difference between the ninth embodiment of the valve body housing 10140 and this eleventh embodiment of the valve body housing 12140 are modifications to receive an alternate water group coupler 12600 from a side of valve body housing 12140. In particular, the port walls 12171, 12173, 12175 of the waterway base portion 12144 are modified such that the arrangement of the clip mounting slots 12181, 12183, 12185 are configured for engagement with a water group coupler 12600.

As shown in FIG. 163, the eleventh embodiment of the valve body housing 12140 is configured to receive a water group coupler 12600. The waterway base portion 12144 is modified so that water group coupler 12600 can be received from the side to interface with the inlet lines 10310, 10320 and the mixed water line 10330. Similar to valve body housing 10140, each of the first inlet port 12172 and the second inlet port 12174 are formed within the interface base 12170 of the waterway base portion 12144 having port walls 12171, 12173 with interior diameters suitable to receive the couplers 10316, 10326 of the inlet lines 10310, 10320. Similarly, the outlet port 12176 is formed within the waterway base portion 12144 having an outlet port wall 12175 with an interior diameter suitable to receive the coupler 10336 of the mixed water outlet line 10330. However, clip mounting slots 12181, 12183, 12185 are arranged in a different manner to accommodate water group coupler 12600 and the valve body housing 12140 may additionally include one or more shaping wall 12178 formed with or adjacent to the port walls 12171, 12173 configured to provide an aesthetic shape and/or additional structure to the valve body housing 12140. The shaping walls 12178 can be two parallel walls positioned on opposite external sides of the valve body housing 12140 at the port walls 12171, 12173. An additional front wall 12146 may be arranged between and/or in front of extents of the port walls 12171, 12173.

Clip mounting slots 12181, 12183, 12185 are formed through an extent of each port wall 12171, 12173, 12175 and positioned adjacent to a top surface portion 12147a of the base 12147 of the valve body housing 12140. For example, port walls 12171, 12173 may include mounting slots 12181, 12183 on a front side of the valve body housing 12140 (e.g., side of faucet spout). The mounting slots 12181, 12183 are covered externally by the front wall 12146, which together with the base 12147 form a coupling slot 12179 configured to receive a first arm 12640a of the water group coupler 12600. Port wall 12175 may include mounting slot 12185 at the back side of the valve body housing 12140 configured to receive a second arm 12640b of the water group coupler 12600.

As shown in FIG. 166, the water group coupler 12600 includes a handling portion 12620 and two arms 12640a, 12640b extending from the handling portion 12620 forming a receiving portion 12630 between the two arms 12640a, 12640b. The handling portion 12620 has an asymmetrical shape to conform with the shape of the valve body housing 12140. The first and second arms 12640a, 12640b extend from the handling portion 12620 and are spaced apart, parallel to each other, with the first arm 12640a having a longer length than the second arm 12640b based on the dimensions of the valve body housing 12140. The first arm 12640a (i.e. longer arm) is configured to engage with an extent of both inlet lines 10310, 10320 through mounting slots 12181, 12183 of port walls 12171, 12173. The second arm 12640b (i.e. shorter arm) is configured to engage with an extent of the mixed water line 10330 through mounting slot 12185 of port wall 12175. The first arm 12640a having a substantially flat exterior edge portion 12612 is configured to be guided by the front wall 12146 of the coupling slots 12179. The second arm 12640b is received in the mounting slots 12185 of port wall 12175. As shown in FIG. 166, when installed in the valve body housing 12140, the receiving portion 12630 of the water group coupler 12600 holds the inlet lines 10310, 10320 within mounting slots 12181, 12183 of port walls 12171, 12173 by an interior edge of the substantially straight first arm 12640a and the mixed water line 10330 is held in place by an interior edge of the substantially straight second arm 12640b. The second arm 12640b and an extent of the handling portion 12620 remain on the exterior of the valve body housing 12140 with at least an extent of the first arm 12640a concealed by the front wall 12146.

iii. Twelfth Embodiment of the Valve Body Housing

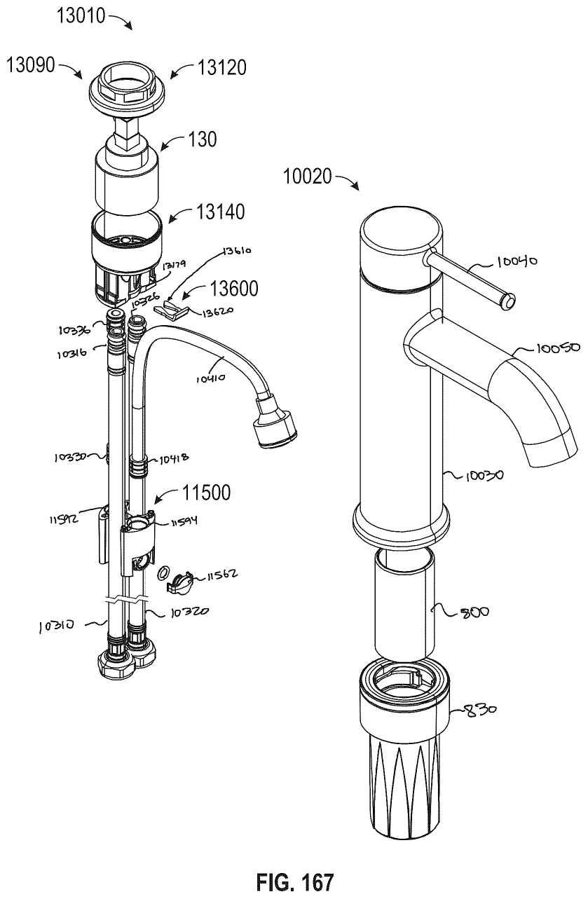

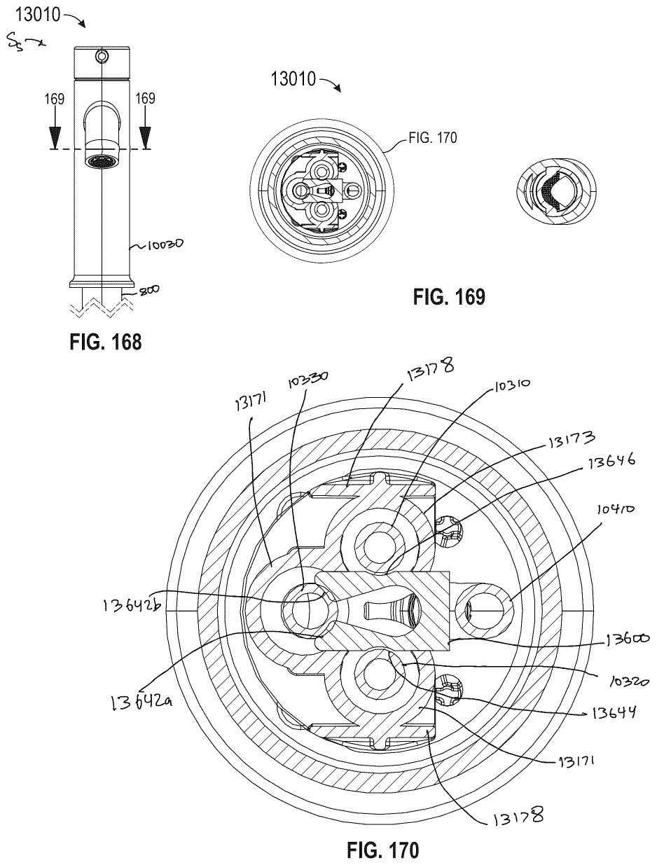

Shown in an exploded view in FIG. 167, faucet system 13010 includes a twelfth embodiment of the SHUP system 13090 contained in a faucet housing 10020. The SHUP system 13090 includes a twelfth embodiment of a valve body housing 13140, a third type of an inlet and outlet water group 10300, a sixth embodiment of a water group coupler 13600, and a tenth embodiment of the mixed water connector 11500. The mixed water connector 11500 is similar to mixed water connector 10500 (FIG. 125) and will be described in further detail below. The valve body housing 13140 is configured to receive the inlet and outlet water group 10300 in a similar manner as described with respect to valve body housing 10140, substituting water group coupler 13600 which is configured to cooperate with valve body housing 13140.

For sake of brevity, the above disclosure in connection with valve body housing 10140 will not be repeated below, but it should be understood that across embodiments, like numbers represent like structures. For example, the disclosure relating to valve body housing 10140 applies in equal force to valve body housing 13140. The primary difference between the ninth embodiment of the valve body housing 10140 and this twelfth embodiment of the valve body housing 13140 are modifications to receive an alternate water group coupler 13600 from the front of valve body housing 13140 and coupling the lines 10310, 10320, 10330 from a central position within the waterway base portion 13144. In particular, the port walls 13171, 13173, 13175 of the waterway base portion 13144 are modified such that the arrangement of the clip mounting slots 13181, 13183, 13185 are configured for engagement with a water group coupler 13600.

As shown in FIG. 167, the twelfth embodiment of the valve body housing 13140 is configured to receive a water group coupler 13600. The waterway base portion 13144 is modified so that water group coupler 13600 can be received from the front to interface with the inlet lines 10310, 10320 and the mixed water line 10330. Similar to valve body housing 10140, each of the first inlet port 13172 and the second inlet port 13174 are formed within the interface base 13170 of the waterway base portion 13144 having port walls 13171, 13173 with interior diameters suitable to receive the couplers 10316, 10326 of the inlet lines 10310, 10320. Similarly, the outlet port 13176 is formed within the waterway base portion 13144 having an outlet port wall 13175 with an interior diameter suitable to receive the coupler 10336 of the mixed water outlet line 10330. However, clip mounting slots 13181, 13183, 13185 are arranged in a different manner to accommodate water group coupler 13600 and the valve body housing 13140 may additionally include one or more shaping wall 13178 formed with or adjacent to the port walls 13171, 13173 configured to provide an aesthetic shape and/or additional structure to the valve body housing 13140. The shaping walls 13178 can be two parallel walls positioned on opposite external sides of the valve body housing 13140 at the port walls 13171, 13173. An additional front wall 13146 may be arranged between /d/ or in front extents of the port walls 13171, 13173.

Clip mounting slots 13181, 13183, 13185 are formed through an extent of each port wall 13171, 13173, 13175 and positioned adjacent to a top surface portion 13147a of the base 13147 of the valve body housing 13140. For example, port walls 13171, 13173 may include mounting slots 13181, 13183 on an internal extent of the valve body housing 13140 facing each other. Port wall 13175 may include mounting slot 13185 an internal extent of the valve body housing 13140. The mounting slots 13181, 13183, 13185 and a top surface portion 13147a of the base 13147 at least partially define the coupling slot 13179 to receive the water group coupler 13600 and is accessed through an aperture in the front wall 13146.

As shown in FIG. 167, the water group coupler 13600 includes a planar portion 13610 and a handling portion 13620. The handling portion 13620 (e.g. angled tab) is formed at an angle to the planar portion 13610 in part to aid in positioning the water group coupler 13600 within the coupling slot 13179 and may be shaped to conform with an exterior extent of the front wall 13146 when in place. The planar portion 13610 includes two arms 13640 having substantially parallel exterior edge portions 13612 extending to tip portions 13614. The exterior edge portions 13612 include indents 13644, 13646 configured to receive extents of lines 13310, 13320 and the tip portions 13614 are symmetrically shaped to include a curvilinear indent 13642 to receive an extent of the mixed water line 13330.

iv. Thirteenth Embodiment of the Valve Body Housing

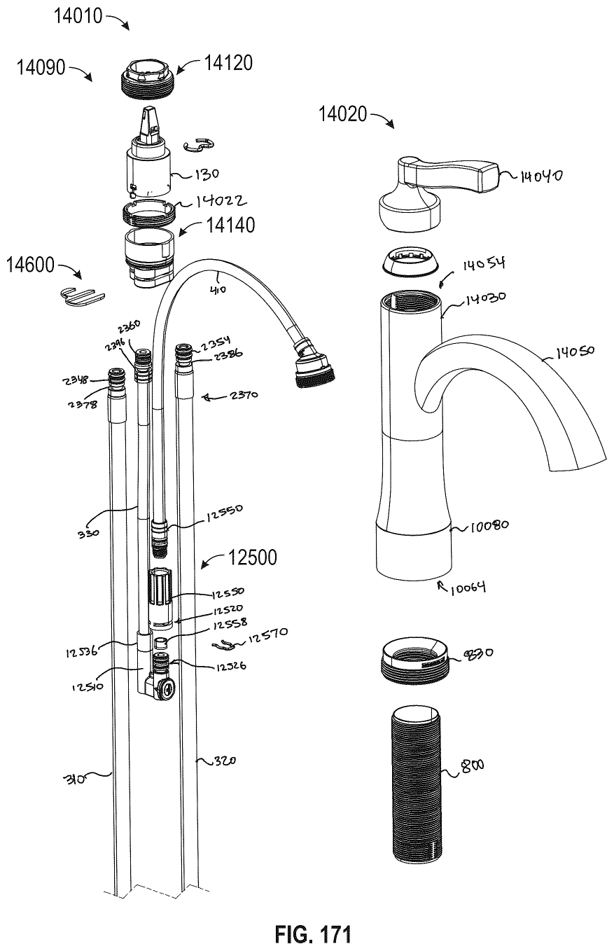

Shown in an exploded view in FIG. 171, faucet system 14010 includes a thirteenth embodiment of the SHUP system 14090 contained in a faucet housing 14020. The SHUP system 14090 includes a thirteenth embodiment of a valve body housing 14140, a third embodiment of a second type of an inlet and outlet water group 2370, a seventh embodiment of a water group coupler 14600, and an eleventh embodiment of the mixed water connector 12500. The valve body housing 14140 is configured to receive the inlet and outlet water group 10300 in a similar manner as described with respect to valve body housing 10140, substituting water group coupler 14600 which is configured to cooperate with valve body housing 14140. The inlet and outlet water group 2370 includes individual first and second water inlet lines 310, 320 and a mixed water outlet line 330. The first and second water inlet lines 310, 320 include couplers 2348, 2354 on a coupling end 2312, 2322 and supply connectors on the opposite end. The mixed water outlet line 330 including coupler 2360 on coupling end 2312 and configured to couple with mixed water connector 12500 on the opposite end. The couplers 2348, 2354, 2360 include annular grooves 2378, 2386, 2396 configured to couple with the water group coupler 14600. Although mixed water connector 12500 is shown as an example, any of the alternate mixed water connector embodiments 500, 1500, 2500, 3500, 4500, 5500, or 6500 can be substituted, for example, based on the faucet shape, dimensions, and/or customer requirements.

For sake of brevity, the above disclosure in connection with valve body housing 10140 will not be repeated below, but it should be understood that across embodiments, like numbers represent like structures. For example, the disclosure relating to valve body housing 10140 applies in equal force to valve body housing 14140. The primary difference between the ninth embodiment of the valve body housing 10140 and this thirteenth embodiment of the valve body housing 14140 are modifications to receive an alternate water group coupler 14600 from a side of valve body housing 14140. In particular, the waterway base portion 14144 including port walls 14171, 14173, 14175 of the are modified such that the arrangement of the clip mounting slots 14181, 14183, 14185 are configured for engagement with a water group coupler 14600. Additionally, similar to valve body housing 3140, the exterior of housing wall 14148 anti-rotation ribs 14166 positioned in the front and back of the valve body housing 14140 for alignment within the faucet housing 14140.

As shown in FIG. 1172, the thirteenth embodiment of the valve body housing 14140 is configured to receive a water group coupler 14600. The waterway base portion 14144 is modified so that water group coupler 14600 can be received from the side to interface with the annular grooves 2378, 2386, 2396 of couplers 2348, 2354, 2360 attached to lines 310, 320, 330. Similar to valve body housing 10140, each of the first inlet port 14172 and the second inlet port 14174 are formed within the interface base 14170 of the waterway base portion 14144 having port walls 14171, 14173 with interior diameters suitable to receive the couplers 2378, 2386 of the inlet lines 310, 320. Similarly, the outlet port 14176 is formed within the waterway base portion 14144 having an outlet port wall 14175 with an interior diameter suitable to receive the coupler 2396 of the mixed water outlet line 330. However, clip mounting slots 14181, 14183, 14185 are arranged in a different manner to accommodate water group coupler 14600. The shape of the base 14147 of the valve body housing 14140 is also modified to correspond with the overall shape of the exterior surface of the port walls 14171, 14173, 14175.

Clip mounting slots 14181, 14183, 14185 are formed through an extent of each port wall 14171, 14173, 14175 and positioned adjacent to a top surface portion 14147a of the base 14147 of the valve body housing 14140. For example, each port wall 14171, 14173, 14175 may include two mounting slots, including mounting slots 14181a, 14183a, 14185a on front facing sides and mounting slots 14181b, 14183b, 14185b rear facing sides. The mounting slots 14181, 14183, 14185 configured to receive the water group coupler 14600 to couple on both sides of each of the lines 310, 320, 330 at the respective annular groove 2378, 2386, 2396 of the waterway couplers 2348, 2354, 2360.

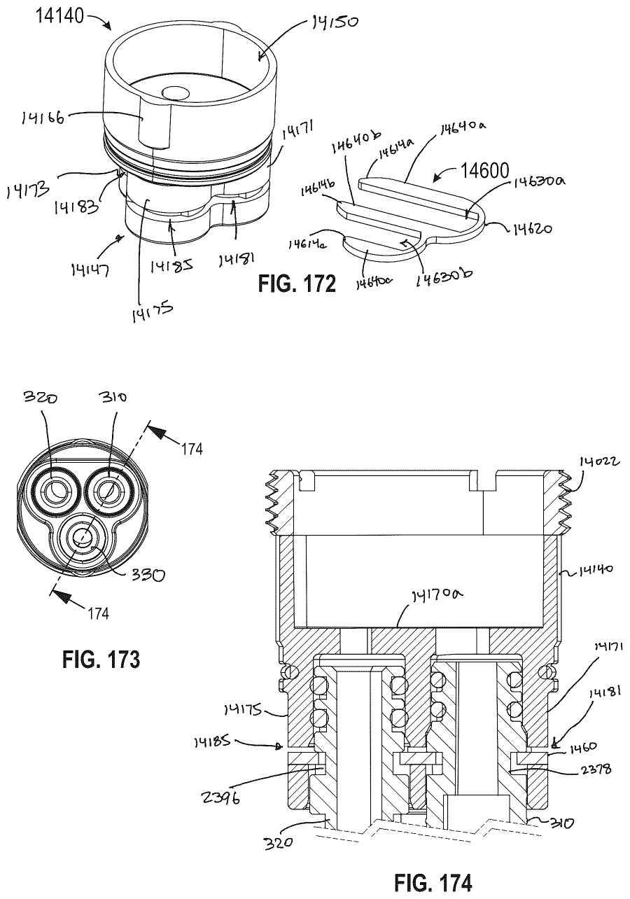

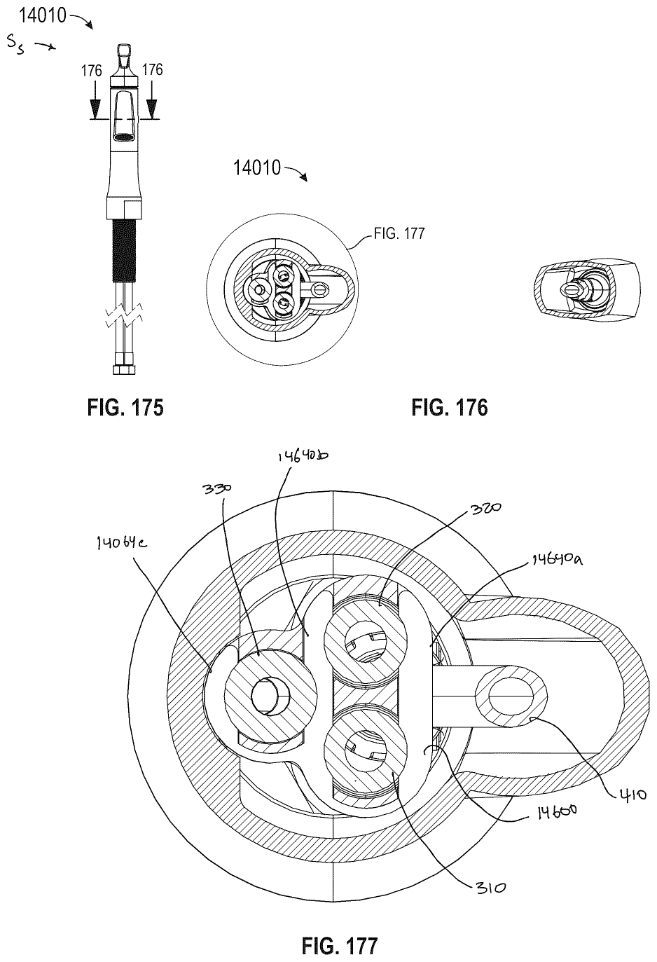

As shown in FIGS. 172 and 177, the water group coupler 14600 is substantially planar and includes a handling portion 14620 and three arms 14640a, 14640b, 14640c extending from the handling portion 14620 forming a first receiving portion 14630a between arms 14640a, 14640b and a second receiving portion 14630b between arms 14640b, 14640c. The handling portion 14620 having an edge with a curvilinear shape to conform with the shape of the valve body housing 14140. The first and second arms 14640a, 14640b extend from an extent of the handling portion 14620 and are spaced apart, parallel to each other, and substantially similar in length and width. The third arm 14640c extends from another extent of the handling portion 14620 and an extent of the second arm 14640b. Although the third arm 14640c is shorter than the second arm 14640b, the facing edges are straight and substantially parallel to each other. The external edges of first and third arms 14640a, 14640c, and the individual tips 14614a, 14614b, 14614c conform with the shape of the waterway base 14144 of the valve body housing 14140.

As shown in FIG. 177, the water group coupler 14600 is received into the valve body housing 14140 from the side and positioned within front and rear mounting slots 14181, 14183, 14185 formed in each of the port walls 14171, 14173, 14175. When assembled, the water group coupler 14600 fits within the profile of the valve body housing 14140 and is dimensioned to engage on both sides of each of the lines 310, 320, 330 at the respective annular groove 2378, 2386, 2396 of the waterway couplers 2348, 2354, 2360.

v. Fourteenth Embodiment of the Valve Body Housing

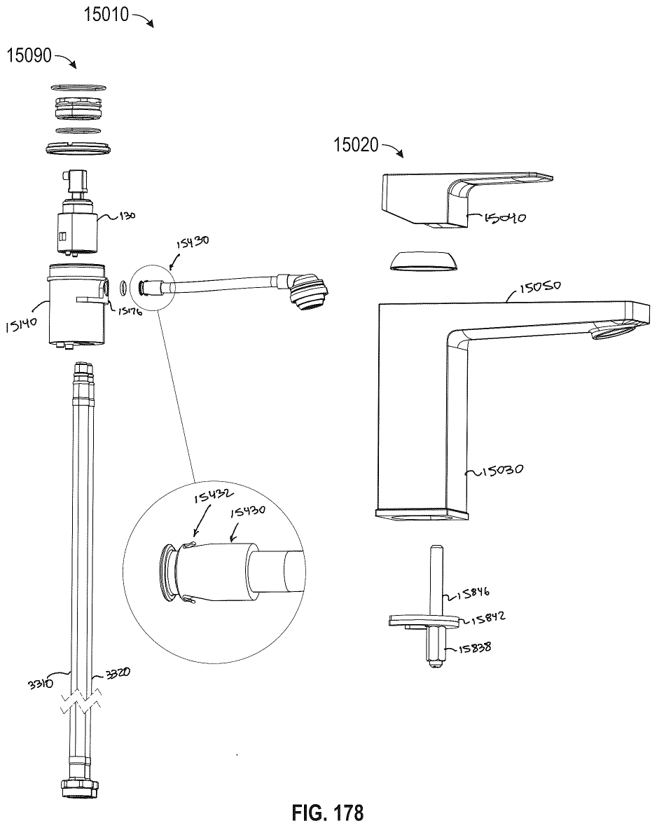

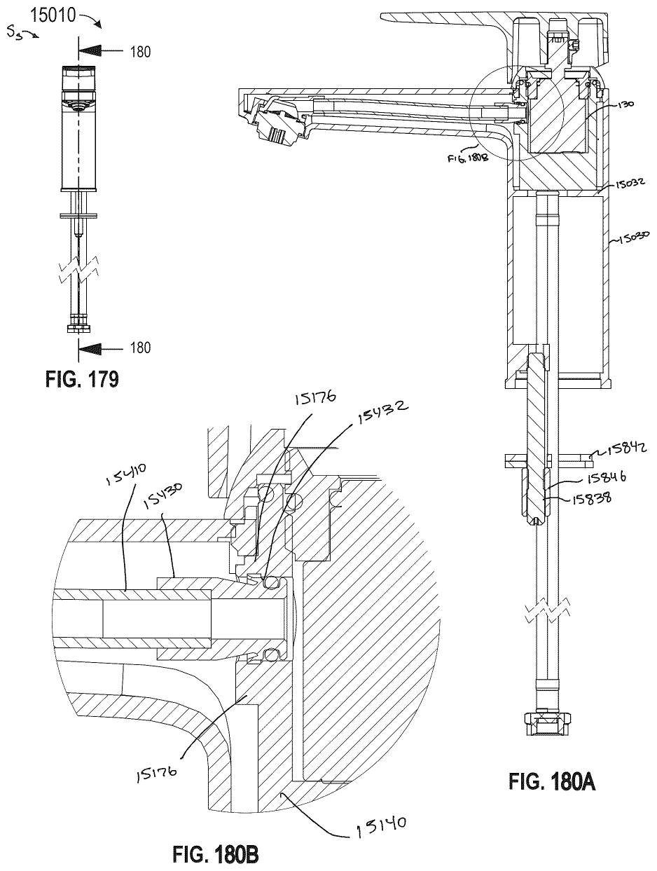

Shown in an exploded view in FIG. 178, faucet system 15010 includes a fourteenth embodiment of the SHUP system 15090 contained in a faucet housing 15020. The SHUP system 15090 includes a fourteenth embodiment of a valve body housing 15140, and a fourth embodiment of the second type of inlet and outlet water group 3370, including only individual inlet lines 3310, 3320. The fourteenth valve body housing embodiment 15140 is configured for a direct mixed water outlet for a slim line faucet, therefore the mixed water line and mixed water connector are omitted from this embodiment.

In this embodiment, the valve body housing 15140 is adapted so that the mixed water are discharged directly into the water discharge tube 15410 coupled to an outlet port 15176 in the sidewall 15148 of the valve body housing 15140. The water discharge tube 15410 includes an inverted buckle coupler 15430 attached at a connector end of the water discharge tube 15410 opposite the outlet adapter 15412. The inverted buckle coupler 15430 includes two tab portions 15432 that extend outward facing the outlet adapter 15412 such that when the inverted buckle coupler 15430 is inserted into the outlet port 15176 of the valve body housing 15140, the inverted buckle coupler 15430 catches an interior portion of the outlet port 15176 and is held in place.

### H. Alternate Mixed Water Connector

i. Tenth Embodiment of the Mixed Water Connector

FIGS. 181 and 184-186 shown a tenth embodiment of the mixed water connector 11500. For sake of brevity, the above disclosure in connection with mixed water connector 10500 will not be repeated below, but it should be understood that across embodiments, like numbers represent like structures. For example, the disclosure relating to mixed water connector 10500 applies in equal force mixed water connector 11500. The primary difference between the tenth mixed water connector embodiment 11500 and the ninth mixed water connector embodiment 10500 are external features for engagement with a faucet housing. In particular, two of the alignment pins 10518 near one port of mixed water connector 10500 are omitted and the shape of the remaining the alignment pins 10518 are modified.

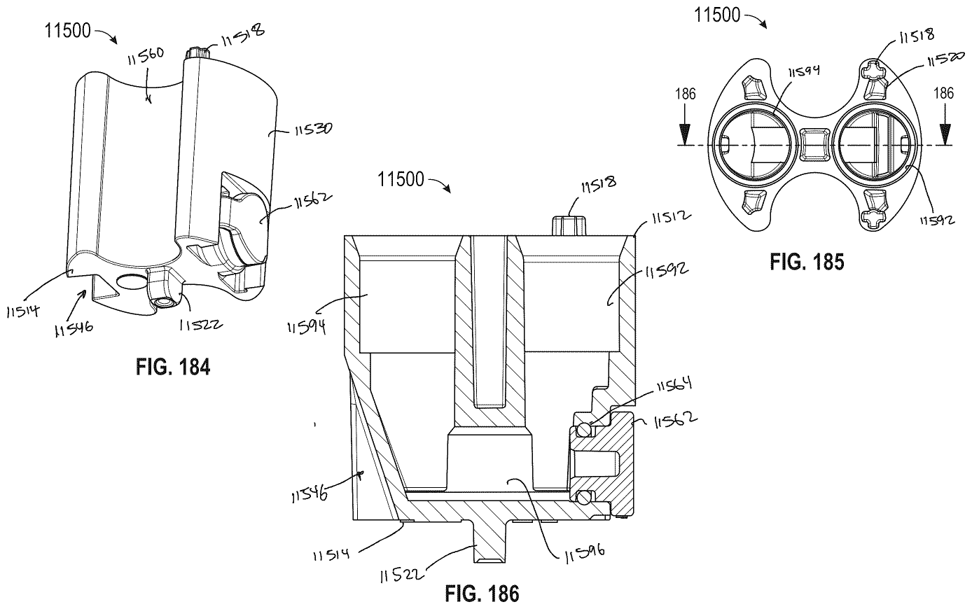

As shown FIG. 181, the mixed water connector 11500 includes first and second surfaces 11512, 11514 and an external surface 11516 therebetween. This embodiment includes two alignment pins 11518 near the input port 11592 of mixed water connector 10500. The alignment pins 11518 can be keyed to have a cross-like profile or other shape to correspond with the alignment holes 10081 of the lower mounting shelf 10038 of a faucet housing. The first surface 11512 of mixed water connector 11500 also includes a plurality of depressions 11520 which may alternately be used for alignment. For example, in an alternate faucet housing, a lower mounting shelf may include pins extending downward from the shelf to help position the mixed water connector 11500. Additionally, as shown in FIGS. 184 and 185, at least one protrusion 11522 may extend from the center of the second surface 11514. The mixed water connector 11500 may also include a front recess 11546 configured to cooperate with the alternate faucet housing, where the front recess 11546 does not significantly interfere with the internal passage 11596.

ii. Eleventh Embodiment of the Mixed Water Connector

FIG. 171 shows an eleventh embodiment of the mixed water connector 12500 is a second embodiment of the mixed water connector 2500 (FIGS. 117-121). For sake of brevity, the above disclosure in connection with mixed water connector 2500 will not be repeated below, but it should be understood that across embodiments, like numbers represent like structures. For example, the disclosure relating to mixed water connector 2500 applies in equal force mixed water connector 12500. The primary difference between the third mixed water connector embodiment 2500 and this eleventh mixed water connector embodiment 12500 are modifications to adapter 12550 are changes to the external surface of adapter 12550 providing a ribbed surface.

As shown, the mixed water connector 12500 includes the water flow connector 12510 attached to the mixed water line 330 of inlet and outlet water group 2370 and a water discharge tube coupler 12590 that secured to the water discharge tube 410. The mixed water connector 12500 is assembled by coupling the adapter 12550 to the water discharge tube coupler 12590, then coupling the adapter 12550 to the outlet portion 12526 of the water flow coupler 2510 by engaging the coupler clip 12570 within the coupling groove 12520 of the adapter 12550.

iii. Twelfth Embodiment of the Mixed Water Connector

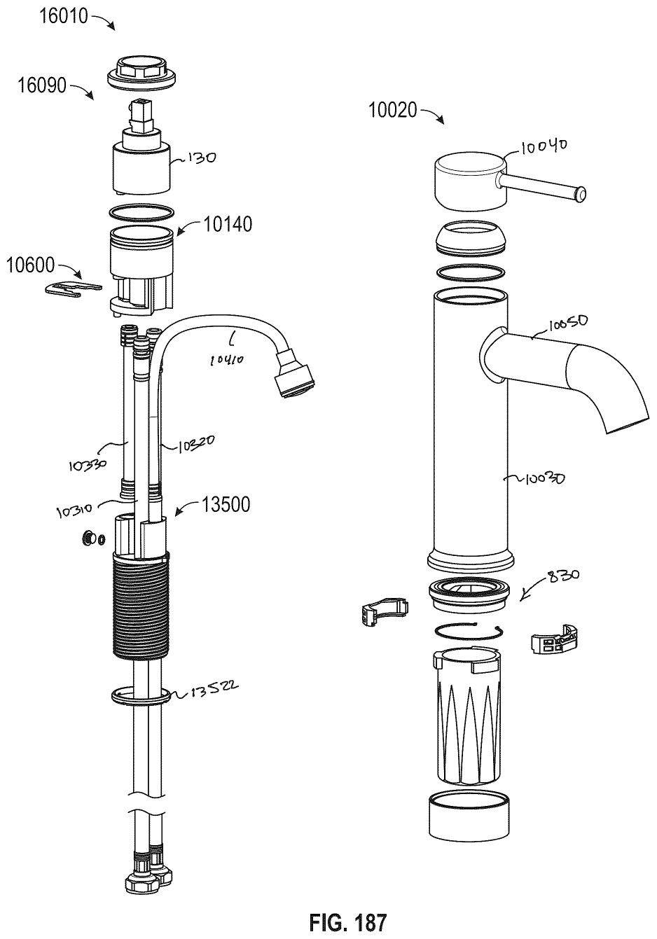

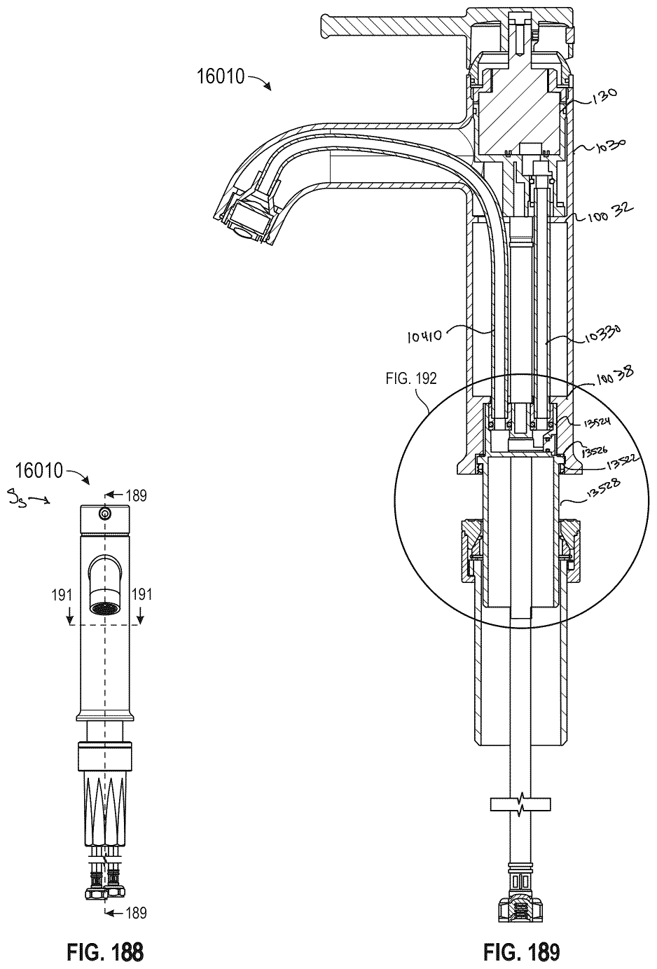

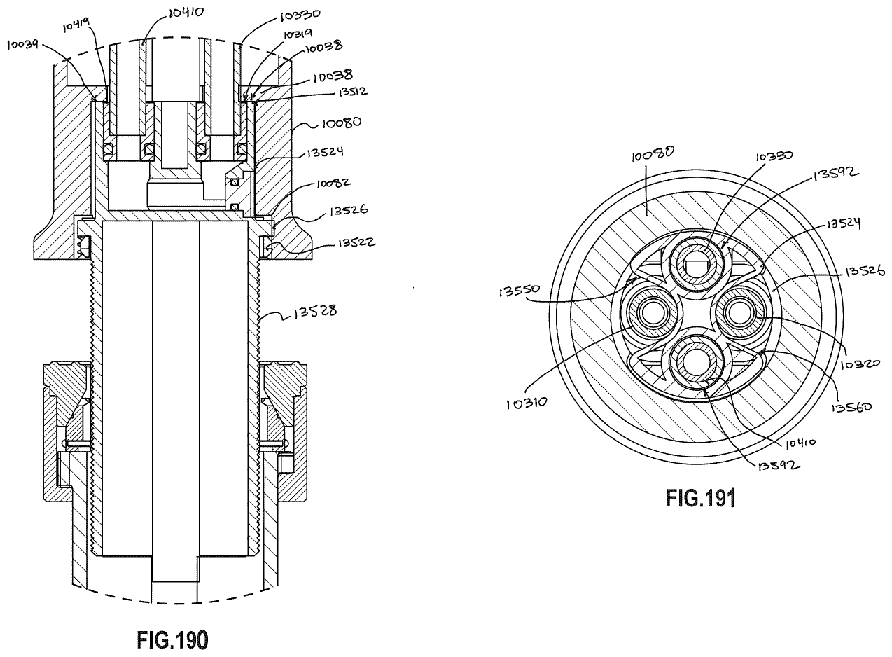

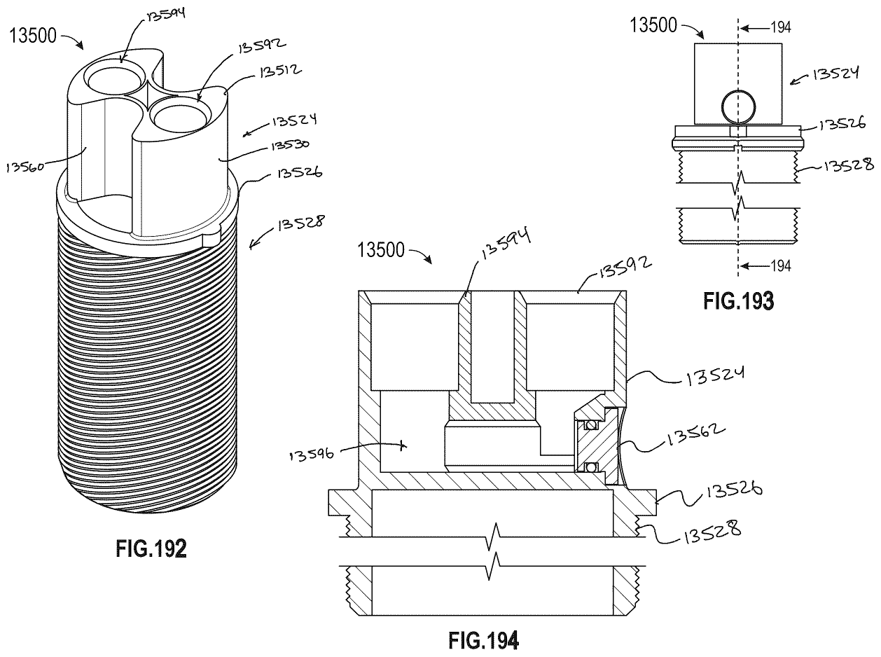

As shown in FIGS. 182 and 187-194, a twelfth embodiment of the mixed water connector 13500. As an example faucet system 16010 in FIG. 187 is shown with the SHUP system 16090 including the ninth embodiment of a valve body housing 10140, a third type of an inlet and outlet water group 10300, a third embodiment of a water group coupler 10600, and a twelfth embodiment of the mixed water connector 13500.

For sake of brevity, the above disclosure in connection with mixed water connector 10500 will not be repeated below, but it should be understood that across embodiments, like numbers represent like structures. For example, the disclosure relating to mixed water connector 10500 applies in equal force mixed water connector 13500. The primary difference between the twelfth mixed water connector embodiment 13500 and the ninth mixed water connector embodiment 10500 is that the mixed water connector 13500 also includes a mounting shank portion. This replaces the need for a separate shank pushing up on the mixed water connector 13500 to hold it in place and provides for alternate configurations of faucet housings.

The mixed water connector 13500 includes connector portion 13524 and a shank portion 13528 that includes a rim 13526 at formed therebetween. The rim 13526 formed between the connector portion 13524 and the shank portion 13528 may have a diameter larger than the diameter of the shank portion 13528. The mounting assembly 13500 provides a one-piece solution, eliminating the separate mounting shank, and allows passage of the inlet lines 310, 320 through the shank portion 13528 and guided by the first and second external recesses 11550, 11560 to extend into the main faucet body. As shown in FIG. 189, when the rim 13526 may contact an extent of the faucet housing 10020 further limiting upward movement of the mixed water connector 13500. The mixed water connector 13500 can be held in place by a lock nut 13522 that is threaded into the base 10060 of the faucet housing 10020 to apply pressure between the nut 13522 and the base ledge 10062 of the faucet housing 10020.

iv. Thirteenth Embodiment of the Mixed Water Connector

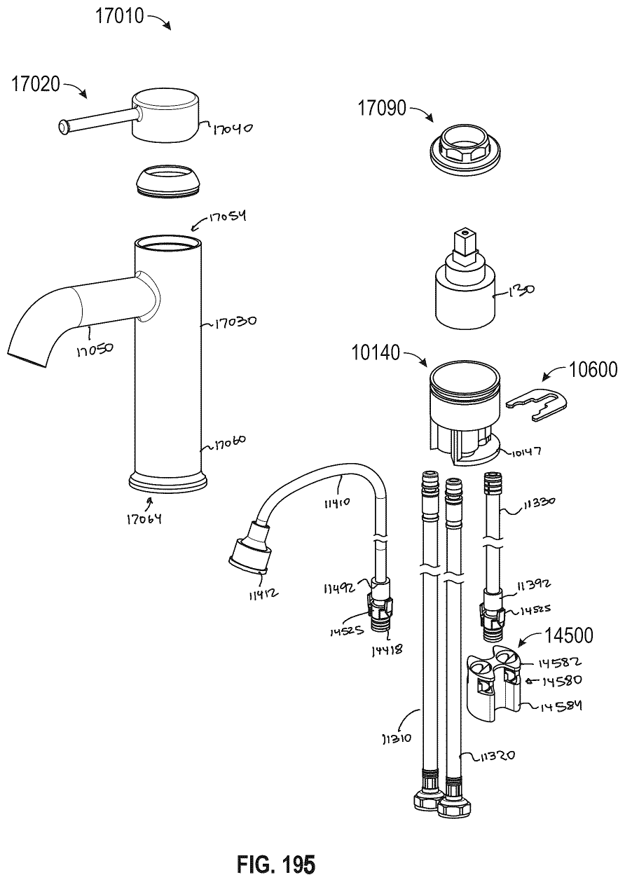

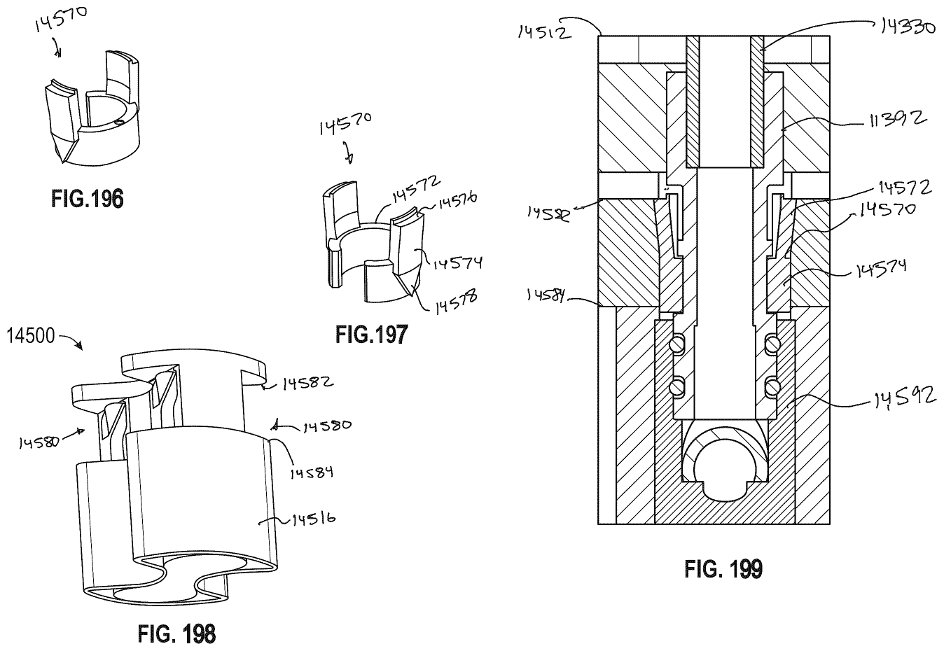

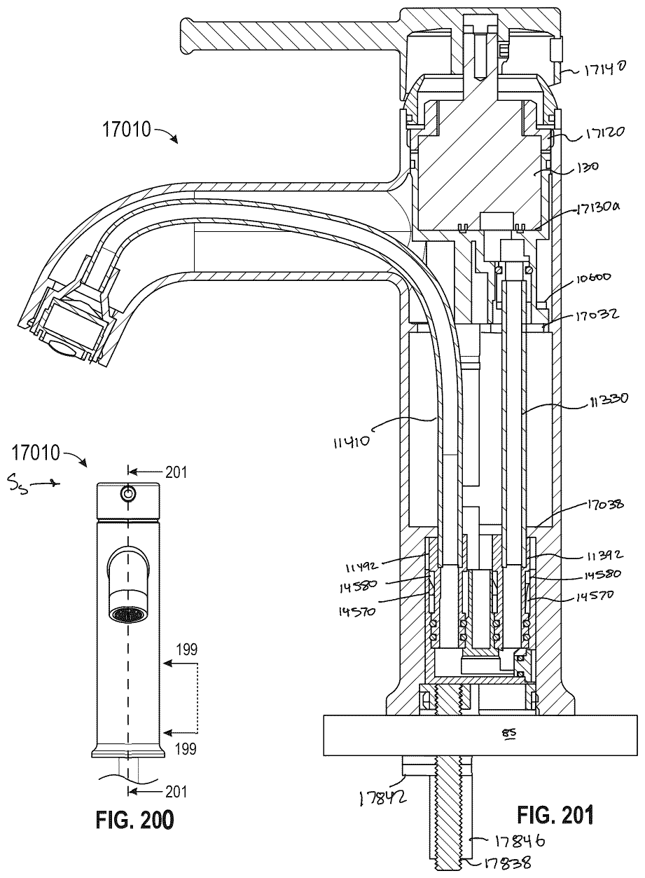

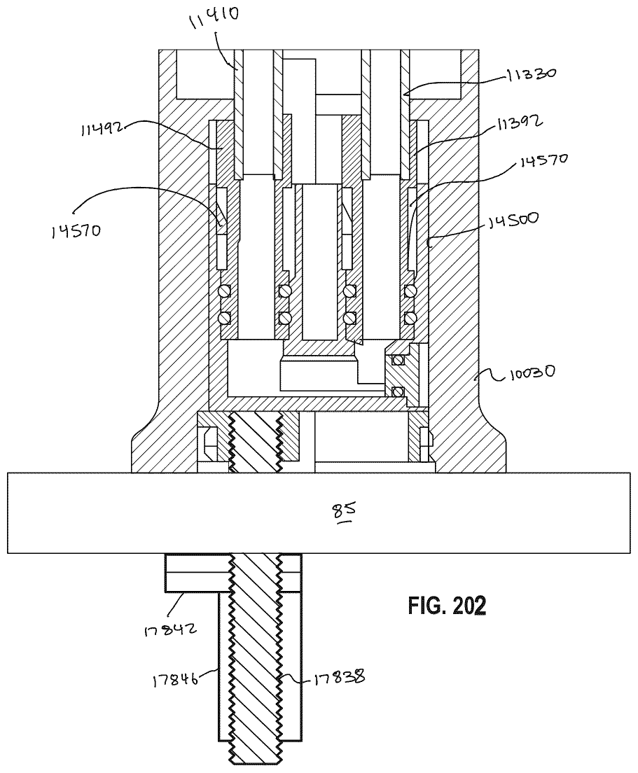

As shown in FIGS. 183 and 195-202, a thirteenth embodiment of the mixed water connector 14500. As an example faucet system 16010 in FIG. 195 is shown with the SHUP system 17090 including the ninth embodiment of a valve body housing 10140, a second embodiment of third type of an inlet and outlet water group 11300, a third embodiment of a water group coupler 10600, and a twelfth embodiment of the mixed water connector 14500. The second embodiment of third type of an inlet and outlet water group 11300 includes a limiting coupler 11392 on the mixed water line 10330 and similarly a limiting coupler 11492 on the faucet outlet tube 10410. The limiting couplers 11392, 11492 configured to limit the axial movement of a clip 14570 moveably coupled thereto.

For sake of brevity, the above disclosure in connection with mixed water connector 10500 will not be repeated below, but it should be understood that across embodiments, like numbers represent like structures. For example, the disclosure relating to mixed water connector 10500 applies in equal force mixed water connector 14500. The primary difference between the thirteenth mixed water connector embodiment 14500 and the ninth mixed water connector embodiment 10500 is that the mixed water connector 14500 also includes additional securement features for connecting the mixed water line 11330 and the faucet outlet tube 11410. The mixed water connector 14500 may be used as an alternative means of connection, for example, when the faucet housing does not have a lower shelf.

As shown in FIGS. 183 and 198, the mixed water connector 14500 includes connector ports 14592, 14594 formed therein with access from a first top surface 14512. The sidewall 14516 is formed therefrom, shaped with the widest portion substantially the same as the interior of the base 17060 of the faucet housing 17020. The sidewall 14516 formed with recesses 14550, 14560 to accommodate passage of the inlet lines 11310, 11320, external to the mixed water connector 14500 and within the interior of the base 17060. The mixed water connector 14500 further includes clip passages 14580 formed in the sidewall 14516 for each of the connector ports 14592, 14594 and configured to allow at least a portion of the coupling clip 14570 to protrude into the respective clip passages 14580. The connector ports 14592, 14594 further including at least one guidance surface 14586 formed within each of the connector ports 14592, 14594 to aid in alignment of the coupling clip 14570 when inserted. The clip passages 14580 formed beneath the first top surface 14512 with upper contact surface 14582 at each clip passage 14580.

The coupling clip 14570 includes a c-shaped ring portion 14572 and a pair of tabs 14574 extending from the ring portion 14570 and are angled outward slightly forming an inverted buckle structure. The tabs 14574 include a contact surface 14576 at one end and a guidance surface 14578 that extends partially onto the external surface of the ring portion 14572. The coupling clip 14570 is moveably coupled each of the limiting couplers 11392, 11492 of lines 11330, 11410. When the limiting couplers 11392, 11492 with the coupling clips 14572 are received into connector ports 14592, 14594, the coupling clips 14570 engage with upper contact surface 14582 at each clip passage 14580 to secure the lines 11330, 11410 within the mixed water connector 14500.

1. A single handle water faucet having a universal waterway platform system, the single handle water faucet comprising:
a faucet housing coupled to a mounting shank that is configured to extend through a support surface to which the faucet housing is mounted;
a valve body assembly, wherein a majority of the valve body assembly is positioned within the faucet housing, the valve body assembly having a mixing cartridge and a valve body housing, the valve body housing including:
a cartridge receiving extent with a cartridge receiver that receives a majority of the mixing cartridge in a secured state, and
a water group receiver having: a first collection of securing structures and a second collection of securing structures;
a water group coupler selectively positioned in one of: (i) the first collection of securing structures to secure a first water inlet and outlet group type to the valve body housing, or (ii) the second collection of securing structures to secure a second water inlet and outlet group type to the valve body housing;
a mixed water connector including: (i) a first coupler secured to a mixed water tube of the first and second water inlet and outlet group types, and (ii) a second coupler secured to a water discharge tube that extends through the faucet housing; and
wherein the mixed water connector has an outer diameter that is greater than 85% of an inner diameter of the mounting shank.

2. The single handle water faucet of claim 1, wherein the cartridge receiving extent includes an annular band that is positioned between an internal step of the faucet housing and a lock nut, and wherein the lock nut is configured to apply a downwardly directed force on an extent of the annular band to secure the valve body housing within the faucet housing.

3. (canceled)

4. The single handle water faucet of claim 2, wherein the annular band has a lower edge that is beveled, and wherein the downwardly directed force that is applied by the lock nut creates a wedging effect based on the interaction between the beveled lower edge and the internal step.

5. (canceled)

6. The single handle water faucet of claim 1, wherein the water group receiver includes an arrangement of ports that are in fluid communication with an arrangement of fluid passages formed in a base wall of the valve body housing.

7. The single handle water faucet of claim 6, wherein the arrangement of ports lacks threads.

8. The single handle water faucet of claim 6, wherein the arrangement of ports are configured to receive a coupling ends of the first and second water inlet and outlet group types.

9. (canceled)

10. The single handle water faucet of claim 8, wherein the coupling ends of the first and second water inlet and outlet group types are inserted into the arrangement of ports using an upwardly directed force, and wherein said upwardly directed force does not require a rotational component.

11. The single handle water faucet of claim 1, wherein the water group coupler is positioned in either the first collection of securing structures or the second collection of securing structures using a lateral force that is oriented perpendicular to a longitudinal axis of the valve body housing.

12. (canceled)

13. (canceled)

14. (canceled)

15. The single handle water faucet of claim 1, wherein the valve body housing includes a plurality of teeth that are received by a plurality of positioning teeth formed in an extent of the faucet housing.

16. The single handle water faucet of claim 1, wherein the valve body housing lacks a plurality of exterior threads.

17. The single handle water faucet of claim 1, wherein the valve body housing is positioned above a vertical center-line of the faucet housing, and wherein the vertical center-line is positioned in the middle of a height of the faucet housing, wherein said height is defined between an upper edge of the faucet housing and a lower edge of the faucet housing.

18. (canceled)

19. (canceled)

20. (canceled)

21. The single handle water faucet of claim 1, wherein the first water inlet and outlet group type includes a connection platform that is not in contact with the faucet housing when the single handle water faucet is in an assembled position.

22. The single handle water faucet of claim 1, wherein the mixed water connector is positioned within the mounting shank when the single handle water faucet is in an installed position.

23. The single handle water faucet of claim 1, wherein the outer diameter of the mixed water connector is between 95% and 99% of the inner diameter of the mounting shank.

24. A single handle water faucet having a universal waterway platform system, the single handle water faucet comprising:
a faucet housing coupled to a mounting shank;
a water discharge tube extending through the faucet housing;
a water inlet and outlet group comprising:
a first water inlet line,
a second water inlet line, and
a mixed water tube;
a mixed water connector positioned within the mounting shank, the mixed water connector having:
a first coupler that is secured to the mixed water tube;
a second coupler that is secured to the water discharge tube;
a first external recess formed in a first side of the mixed water connector;
a second external recess formed in the opposed second side of the mixed water connector;
wherein an extent of the first water inlet line is positioned within the first external recess of the mixed water connector, and an extent of the second water inlet line is positioned within the second external recess of the mixed water connector; and
wherein the arrangement of (i) the first coupler and the second coupler and (ii) the first and second water inlet lines define an outer periphery of the mixed water connector, and wherein said outer periphery is greater than 85% of an inner periphery shank of the mounting shank.

25. (canceled)

26. (canceled)

27. The single handle water faucet of claim 24, wherein an outer diameter of the mixed water connector is between 95% and 99% of an inner diameter of the mounting shank.

28. (canceled)

29. (canceled)

30. The single handle water faucet of claim 24, further comprising a valve body housing that includes a cartridge receiving extent with a cartridge receiver that is configured to receive a majority of a mixing cartridge in a secured state.

31. (canceled)

32. The single handle water faucet of claim 30, further comprising a water group coupler, wherein the valve body housing further includes a first collection of securing structures, and a second collection of securing structures, and
wherein the water group coupler is configured to be positioned in both: (i) the first collection of securing structures to secure a first water inlet and outlet group type to the valve body housing, and (ii) the second collection of securing structures to secure a second water inlet and outlet group type to the valve body housing.

33. (canceled)

34. (canceled)

35. (canceled)

36. The single handle water faucet of claim 32, wherein the first water inlet and outlet group type includes a connection platform, and wherein the connection platform is positioned away from and not in contact with the faucet housing when the single handle water faucet is in an assembled position.

37. (canceled)

38. The single handle water faucet of claim 30, wherein the valve body housing includes an annular band that is configured to be positioned between an internal step of the faucet housing and a lock nut, and wherein the lock nut is configured to apply a downwardly directed force on an extent of the annular band to secure the valve body housing within the faucet housing.

39. (canceled)

40. The single handle water faucet of claim 38, wherein the annular band has a lower edge that is beveled, and wherein the downwardly directed force that is applied by the lock nut creates a wedging effect based on the interaction between the beveled lower edge and the internal step.

41. (canceled)

42. The single handle water faucet of claim 30, wherein the valve body housing further includes a water group receiver with an arrangement of ports and a base wall with an arrangement of fluid passages in fluid communication with the arrangement of ports.

43. (canceled)

44. The single handle water faucet of claim 42, wherein the arrangement of ports lacks a plurality of threads.

45. The single handle water faucet of claim 30, wherein the valve body housing includes a plurality of teeth that are received by a plurality of positioning teeth formed in an extent of the faucet housing.

46. The single handle water faucet of claim 30, wherein the valve body housing lacks exterior threads.

47. The single handle water faucet of claim 30, wherein the valve body housing is positioned above a vertical center-line of the faucet housing, and wherein the vertical center-line is positioned in the middle of a height of the faucet housing, wherein said height is defined between an upper edge of the faucet housing and a lower edge of the faucet housing.

48. (canceled)

49. (canceled)

50. A single handle water faucet having a universal waterway platform system, the single handle water faucet comprising:
a valve body assembly having:
a mixing cartridge, and
a valve body housing with:
a cartridge receiving extent including a cartridge receiver that receives a majority of the mixing cartridge,
a water group receiver with: (i) a first collection of securing structures, and (ii) a second collection of securing structures, and
a base wall positioned between the cartridge receiving extent and the water group receiver; and
a water group coupler designed to secure at least one water inlet line and a mixed water tube to the valve body housing, wherein the water group coupler is selectively positioned in one of either of: (i) the first collection of securing structures, and (ii) the second collection of securing structures.

51. The single handle water faucet of claim 50, wherein the water group receiver includes an arrangement of ports that are in fluid communication with an arrangement of fluid passages formed in the base wall of the valve body housing.

52. The single handle water faucet of claim 51, wherein the arrangement of ports lacks threads.

53. The single handle water faucet of claim 52, wherein the water group coupler selectively positioned in one of: (i) the first collection of securing structures to secure a first water inlet and outlet group type to the valve body housing, or (ii) the second collection of securing structures to secure a second water inlet and outlet group type to the valve body housing.

54. The single handle water faucet of claim 53, wherein the water group coupler is positioned in either the first collection of securing structures or the second collection of securing structures using a lateral force that is oriented perpendicular to a longitudinal axis of the valve body housing.

55. (canceled)

56. (canceled)

57. The single handle water faucet of claim 53, wherein the arrangement of ports are configured to receive a coupling ends of the first and second water inlet and outlet group types.

58. (canceled)

59. The single handle water faucet of claim 57, wherein the coupling ends of the first and second water inlet and outlet group types are inserted into the arrangement of ports using an upwardly directed force, and wherein said upwardly directed force does not require a rotational component.

60. The single handle water faucet of claim 50, wherein the valve body housing lacks exterior threads.

61. (canceled)

62. (canceled)

63. (canceled)

64. (canceled)

65. (canceled)

66. (canceled)

67. (canceled)

68. (canceled)

69. (canceled)

70. (canceled)

71. The single handle water faucet of claim 50, further comprising a mixed water connector including: (i) a first coupler secured to the mixed water tube of the first and second water inlet and outlet group types, and (ii) a second coupler secured a water discharge tube.

72. The single handle water faucet of claim 71, wherein a majority of the valve body assembly is positioned within a faucet housing, and wherein the mixed water connector is positioned within a mounting shank coupled to the faucet housing when the single handle water faucet is in an installed position.

73. (canceled)

74. The single handle water faucet of claim 72, wherein the mixed water connector has an outer diameter that is greater than 85% of an inner diameter of the mounting shank.

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)
